(19) United States
(12) Patent Application Publication
(10) Pub. No.: US 2025/0274971 A1
(43) Pub. Date: Aug. 28, 2025

(54) METHOD AND DEVICE FOR TRANSMITTING AND RECEIVING DATA IN SATELLITE COMMUNICATION SYSTEM

(71) Applicant: SAMSUNG ELECTRONICS CO., LTD., Suwon-si, Gyeonggi-do (KR)

(72) Inventors: Sungjin PARK, Suwon-si (KR); Youngbum KIM, Suwon-si (KR); Hyunseok RYU, Suwon-si (KR); Junyung YI, Suwon-si (KR)

(21) Appl. No.: 18/865,564

(22) PCT Filed: Apr. 25, 2023
(86) PCT No.: PCT/KR2023/005583

§ 371 Date: Nov. 13, 2024

(30) Foreign Application Priority Data
May 13, 2022 (KR) 10-2022-0059049

(51) Int. Cl. H04W 74/00; H04W 72/0446

(52) U.S. Cl. CPC H04W 74/004; H04W 72/0446

(57) ABSTRACT

The present invention relates to a 5G or 6G communication system for supporting a higher data transmission rate. The present invention provides a method by which a terminal performs satellite communication, the method comprising the steps of: receiving time offset information from a base station; calculating a timing advance (TA) value on the basis of the received time offset information; applying the calculated TA value; transmitting information about the applied TA value to the base station; and receiving, from the base station, information for correcting the TA value.

### TECHNICAL FIELD

The disclosure relates to a communication system and, more particularly, to a method for transmitting and receiving data in a satellite communication system.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to optimize non-public networks.

As the costs of launching satellites have been drastically reduced in the late 2010s and 2020s, the number of operators attempting to provide communication services via satellites is increasing. Accordingly, satellite networks have emerged as next-generation network systems that complement existing terrestrial networks. Satellite networks are unable to provide the same level of user experience as that of terrestrial networks yet, but it is advantageous that the satellite networks are able to provide communication services even in areas or disaster situations where it is difficult to establish terrestrial networks. In addition, as described above, the satellite networks have recently secured economic feasibility due to a sharp decrease in the costs of launching satellites. In addition, some companies and 3GPP standard organizations are also promoting direct communication between smartphones and satellites.

### DISCLOSURE OF INVENTION

### Technical Problem

Disclosed embodiments are to provide a device and a method capable of efficiently providing services in a wireless communication system such as a satellite communication system.

### Solution to Problem

A method performed by a terminal according to an embodiment of the disclosure includes: determining a timing advance (TA) value for transmission of an uplink signal; determining whether an overlap occurs between a first slot before applying the TA value and a second slot after applying the TA value; and based on a priority of an interval in which the overlap has occurred, transmitting the uplink signal to a base station according to the TA value.

A terminal according to an embodiment of the disclosure includes: a transceiver; and a controller connected to the transceiver, wherein the controller is configured to determine a timing advance (TA) value for transmission of an uplink signal, determine whether an overlap occurs between a first slot before applying the TA value and a second slot after applying the TA value; and based on a priority of an interval in which the overlap has occurred, transmit the uplink signal to a base station according to the TA value.

A method performed by a base station according to an embodiment of the disclosure includes receiving an uplink signal from a terminal, wherein the uplink signal is received based on a timing advance (TA) value, and the uplink signal is received based on a priority of an interval in which an overlap occurs between a first slot before applying the TA value and a second slot after applying the TA value.

A base station according to an embodiment of the disclosure includes: a transceiver; and a controller connected to the transceiver, wherein the controller is configured to receive an uplink signal from a terminal, wherein the uplink signal is received based on a timing advance (TA) value, and the uplink signal is received based on a priority of an interval in which an overlap occurs between a first slot before applying the TA value and a second slot after applying the TA value.

### Advantageous Effects of Invention

The disclosure provides a device and a method capable of efficiently providing services in a wireless communication system such as a satellite communication system.

### BRIEF DESCRIPTION OF DRAWINGS

FIG. 1 illustrates a basic structure of a time-frequency domain, which is a radio resource domain used to transmit downlink or uplink data or control channels, in an NR system according to an embodiment of the disclosure.

FIG. 2 is a diagram illustrating mapping of a synchronization signal (SS) and a physical broadcast channel (PBCH) of an NR system in the frequency and time domains according to an embodiment of the disclosure;

FIG. 3 is a diagram illustrating symbols on which an SS/PBCH block may be transmitted based on subcarrier spacings according to an embodiment of the disclosure;

FIG. 4 is a diagram illustrating an example of a control area (CORESET) in which a downlink control channel is transmitted in a 5G wireless communication system according to an embodiment of the disclosure;

FIG. 5 is a diagram schematically illustrating an example of a message delivered from a MAC layer to a physical layer in a downlink in the communication system according to an embodiment of the disclosure;

FIG. 6 is a diagram schematically illustrating an example of a message delivered from a MAC layer to a physical layer in an uplink in the communication system according to an embodiment of the disclosure;

FIG. 7 is a diagram illustrating an example of a procedure in which one transport block (TB) is divided into multiple code blocks (CBs) and a CRC is added, according to an embodiment of the disclosure;

FIG. 8 is a diagram illustrating a processing time of a UE according to timing advance when the UE receives a first signal and transmits a second signal in response thereto in the 5G or NR system according to an embodiment of the disclosure;

FIG. 9 is a diagram illustrating an example of scheduling and transmitting data (e.g., transport block (TB)) according to a slot, receiving hybrid automatic repeat request (HARQ)-acknowledgment (ACK) feedback for the data, and performing retransmission based on the feedback, according to an embodiment of the disclosure;

FIG. 10 is a diagram illustrating an example of a communication system using a satellite according to an embodiment of the disclosure;

FIG. 11 is a diagram illustrating a revolution period of a communication satellite revolving around the earth in accordance with an altitude or a height of the satellite according to an embodiment of the disclosure;

FIG. 12 is a diagram illustrating a conceptual diagram of satellite-UE direct communication according to an embodiment of the disclosure;

FIG. 13 is a diagram illustrating a utilization scenario of satellite-UE direct communication according to an embodiment of the disclosure;

FIG. 14 is a diagram illustrating an example of calculating an expected data transmission rate (throughput) in an uplink when a low-earth orbit (LEO) satellite at an altitude of 1200 km and a ground UE perform direct communication according to an embodiment of the disclosure;

FIG. 15 is a diagram illustrating an example of calculating an expected data transmission rate (throughput) in an uplink when a geostationary earth orbit (GEO) satellite at an altitude of 35,786 km and a ground UE perform direct communication according to an embodiment of the disclosure;

FIG. 16 is a diagram illustrating a path loss value based on a path loss model between a UE and a satellite, and a path loss based on a path loss model between a UE and a terrestrial network communication base station according to an embodiment of the disclosure;

FIG. 17 is a diagram illustrating an equation for calculating, based on an altitude and a position of a satellite and a position of a UE user on the ground, an amount of Doppler shift that a signal delivered from the satellite experiences when the signal is received by the user on the ground, and a result of the calculation according to an embodiment of the disclosure;

FIG. 18 is a diagram illustrating a speed of a satellite calculated at an altitude of the satellite according to an embodiment of the disclosure;

FIG. 19 is a diagram illustrating Doppler shifts experienced by different UEs within a single beam transmitted to the ground by a satellite, according to an embodiment of the disclosure;

FIG. 20 is a diagram illustrating a difference in Doppler shifts occurring within a single beam according to a satellite position determined from an elevation angle, according to an embodiment of the disclosure;

FIG. 21 is a diagram illustrating a round-trip delay between a UE, a satellite, and a base station, and a delay from the UE to the satellite according to a satellite position determined based on an elevation angle, according to an embodiment of the disclosure;

FIG. 22 is a diagram illustrating a maximum difference value of a round-trip delay that varies depending on a user position within a single beam according to an embodiment of the disclosure;

FIG. 23 is a diagram illustrating an example of an information structure (i.e., a MAC payload) of an RAR according to an embodiment of the disclosure;

FIG. 24 is a diagram illustrating an example of a relationship between a physical random-access channel (PRACH) preamble configuration resource and an RAR reception time point in an LTE system according to an embodiment of the disclosure;

FIG. 25 is a diagram illustrating an example of a relationship between a PRACH preamble configuration resource and an RAR reception time point in the 5G NR system according to an embodiment of the disclosure;

FIG. 26 is a diagram illustrating an example of downlink frame and uplink frame timings for a UE according to an embodiment of the disclosure;

FIG. 27 is a diagram illustrating an example of continuous movement of a satellite with respect to a UE located on the ground or on the earth as the satellite orbits the earth according to an embodiment of the disclosure;

FIG. 28 is a diagram illustrating an example of a structure of a satellite according to an embodiment of the disclosure;

FIG. 29 is a diagram illustrating an example of a procedure in which a UE determines NTA from initial access according to an embodiment of the disclosure;

FIG. 30 is a diagram illustrating an example of a procedure in which a UE determines N_{TA}, N_{TA,UE-specific}, and N_{TA,common} from initial access according to an embodiment of the disclosure;

FIG. 31 is a diagram schematically illustrating another example of a UE operation procedure according to an embodiment of the disclosure;

FIG. 32 is a diagram schematically illustrating another example of a UE operation procedure in a communication system according to an embodiment of the disclosure;

FIG. 33 is a diagram illustrating an example of a base station operation for reporting a TA value of a UE according to an embodiment of the disclosure;

FIG. 34 is a diagram illustrating an example of a UE operation for reporting a TA value of a UE according to an embodiment of the disclosure;

FIG. 35 is a diagram illustrating an example of a propagation delay difference between a terrestrial network and a satellite network according to an embodiment of the disclosure;

FIG. 36 is a diagram illustrating a method of aligning uplink transmission timing of a UE and a base station when a time interval overlap occurs in a part of a specific uplink slot according to application of TA, according to an embodiment of the disclosure;

FIG. 37 is a diagram illustrating an operation flow of a UE when a time interval overlap occurs in a part of a specific uplink slot according to application of TA, according to an embodiment of the disclosure;

FIG. 38 is a diagram illustrating an example of repetitive physical uplink shared channel (PUSCH) transmission considering a voice over Internet protocol (VOIP) according to an embodiment of the disclosure;

FIG. 39 is a diagram illustrating a situation in which an overlap occurs between repetitive transmissions according to an embodiment of the disclosure;

FIG. 40 is a block diagram illustrating an internal structure of a UE according to an embodiment of the disclosure;

FIG. 41 is a block diagram illustrating an internal structure of a satellite according to an embodiment of the disclosure; and

FIG. 42 is a block diagram illustrating an internal structure of a base station according to an embodiment of the disclosure.

### MODE FOR INVENTION

New radio (NR) which refers to a new 5G communication scheme is designed to enable free multiplexing of various services in time and frequency resources, and accordingly, waveforms/numerologies, reference signals, and the like may be dynamically or freely allocated according to needs of the corresponding services. In order to provide an optimal service to a terminal in communication, it is important to provide optimized data transmission through measurements of a channel quality and an interference amount, and accordingly it is essential to accurately measure a channel state. However, unlike the 4G communication in which channel and interference characteristics do not greatly vary according to frequency resources, a 5G channel has channel and interference characteristics greatly varying according to services, and thus there is a need to support subsets in terms of frequency resource group (FRG) that enable separate measurements of channel and interference characteristics. Service types supported in the NR system may be categorized into enhanced mobile broadband (eMBB), massive machine type communications (mMTC), and ultra-reliable and low-latency communications (URLLC). eMBB may be considered a service that aims at high-speed transmission of high-capacity data, mMTC may be considered a service that aims at minimized power consumption for a terminal and access of multiple terminals, and URLLC may be considered as a service that aims at high reliability and low latency. Different requirements may be applied depending on the type of service applied to a terminal.

As described above, a communication system may provide multiple services to a user, and in order to provide these multiple services to a user, there is a need for a method that can provide each service in the same time interval according to the characteristics thereof and a device using the same.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is evolving from the initial voice-based service to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services. As 5th generation wireless communication systems, 5G or new radio (NR) communication standards are also under discussion.

As a typical example of the broadband wireless communication system, the NR system employs an orthogonal frequency division multiplexing (OFDM) scheme in a downlink (DL) and an uplink (UL). However, more specifically, the NR system employs a cyclic-prefix OFDM (CP-OFDM) scheme in a downlink and employs two schemes, that is, CP-OFDM and discrete Fourier transform spreading OFDM (DFT-S-OFDM) schemes in an uplink. The uplink refers to a radio link via which a user equipment (UE) {or a mobile station (MS)} transmits data or control signals to a base station (BS) (or gNode B), and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

The NR system employs a hybrid automatic repeat request (HARQ) scheme in which, when decoding is unsuccessful at the initial transmission, the corresponding data is retransmitted in a physical layer. In the HARQ scheme, when a receiver fails to accurately decode data, the receiver transmits information (negative acknowledgement: NACK) informing a transmitter of the unsuccessful decoding and thus the transmitter may retransmit the corresponding data in the physical layer. The receiver increases data reception performance by combining the data retransmitted by the transmitter with the data the decoding of which has previously failed. Also, when the receiver accurately decodes data, the receiver transmits information (acknowledgement: ACK) informing the transmitter of the successful decoding and thus the transmitter may transmit new data.

According to an embodiment of the disclosure, when a UE attempts to connect to a base station via a satellite, a large propagation delay occurs in arrival of radio waves due to a long distance of hundreds of kilometers, thousands of kilometers, or greater between the UE and the satellite and between the satellite and the base station on the ground. A delay between a UE, a satellite, and a base station is much longer than a delay occurring in a situation where a UE and a base station directly communicate in a terrestrial network. In addition, a delay between a UE, a satellite, and a base station changes over time because the satellite continuously moves.

Therefore, the disclosure provides a method and a device in which, when a UE transmits a signal to and receives a signal from a base station via a satellite, the base station indicates a time offset and the UE performs compensation based on the time offset in order to compensate for a time-varying delay that occurs due to a long distance to the satellite and the movement of the satellite. In addition, the disclosure provides the method and the device in which the UE may calculate a part of the time offset based on time information and positions of the satellite and the UE itself, apply the same, and transmit a report to the base station.

That is, according to an embodiment of the disclosure, when a UE transmits a signal to and receives a signal from a base station via a satellite, a compensation for a time offset may be required due to a long distance between the UE and the satellite. Accordingly, the disclosure provides a method and a device in which a base station indicates time offset information to a UE, the UE calculates and applies a part of timing advance, and reports timing advance information to the base station, and the UE compensates for the time offset by using the information indicated from the base station.

As described above, by using the disclosure, a UE may connect to a base station via a satellite, the base station indicates a time offset to the UE, and the UE calculates and compensates for the time offset, thereby enabling effective exchange of a signal between the base station and the UE.

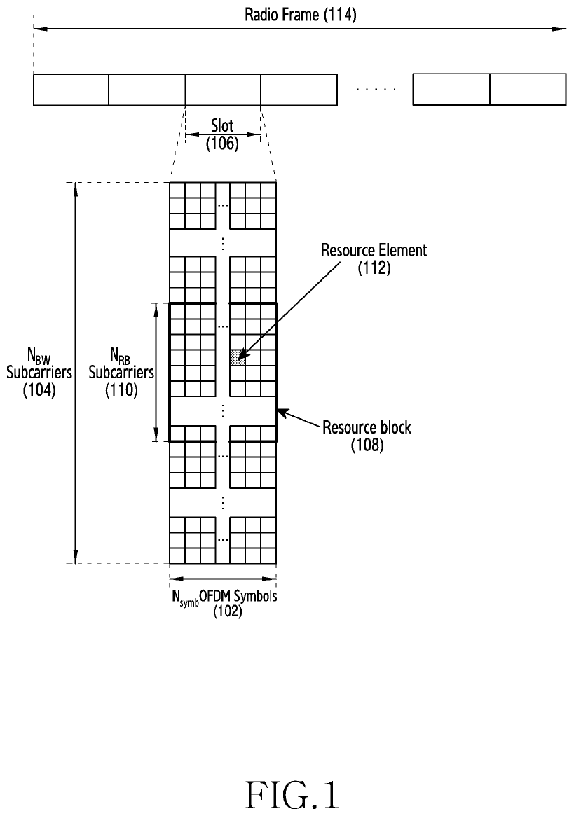

FIG. 1 illustrates a basic structure of a time-frequency domain, which is a radio resource domain used to transmit downlink or uplink data or control channels, in an NR system according to an embodiment of the disclosure.

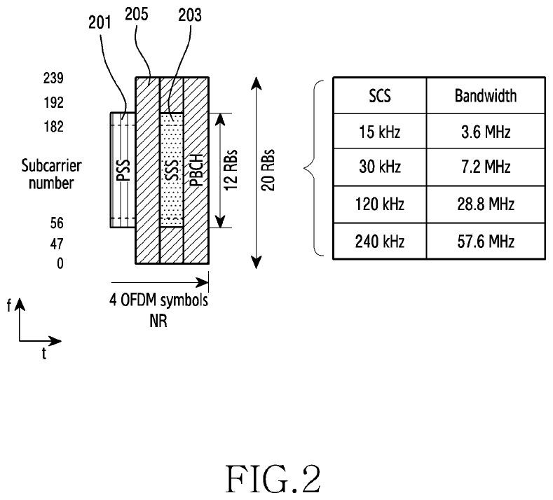

In FIG. 1, the horizontal axis denotes a time domain, and the vertical axis denotes a frequency domain. A minimum transmission unit in the time domain is an OFDM symbol, and Nsymb OFDM symbols 102 together constitute one slot 106. The length of a subframe may be defined as 1.0 ms, and a radio frame 114 may be defined as 10 ms. The smallest unit of transmission in the frequency domain is a subcarrier, and a total of NBW subcarriers 104 may constitute the entire system transmission bandwidth. One frame may be defined as 10 ms. One subframe may be defined as 1 ms, and thus one frame may include a total of ten subframes. One slot may be defined as 14 OFDM symbols (i.e., the number N_{symb}^{slot} of symbols per one slot=14). One subframe may include one or multiple slots, and the number of slots per one subframe may vary depending on configuration values μ for the subcarrier spacing. The example of FIG. 2 shows the case of μ=0 and the case of μ=1 as a configuration value for the subcarrier spacing. In the case of μ=0, one subframe may include one slot, and in the case of μ=1, one subframe may include two slots. That is, the number Nₛₗₒₜ^{sunframe,μ} of slots per one subframe may change according to a configuration value μ for a subcarrier spacing, and the number Nₛₗₒₜ^{frame,μ} of slots per one frame may change accordingly. Nₛₗₒₜ^{sunframe,μ} and Nₛₗₒₜ^{frame,μ} may be defined according to each subcarrier spacing configuration μ as in slot Table 1 below.

TABLE 1

| μ | N_{symb}^{slot} | Nₛₗₒₜ^{frame, μ} | Nₛₗₒₜ^{sunframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The UE before radio resource control (RRC) connection may be configured with an initial bandwidth part (BWP) for initial access from the base station via a master information block (MIB). More specifically, during initial access, the UE may receive configuration information for a search space and a control area (control resource set (CORESET)) in which a physical downlink control channel (PDCCH) for receiving system information (which may correspond to remaining system information (RMSI) or system information block 1 (1)) required for the initial access may be transmitted via the MIB. Each of the control resource set and the search space configured via the MIB may be considered to be identifier (identity (ID)) 0. The base station may notify the UE of configuration information, such as frequency allocation information, time allocation information, and numerology for control resource set #0, via the MIB. In addition, the base station may notify, via the MIB, the UE of configuration information on an occasion and a monitoring period for control resource set #0, that is, configuration information on search space #0. The UE may consider, as an initial bandwidth part for initial access, a frequency domain configured as control resource set #0 acquired from the MIB. In this case, an identity (ID) of the initial bandwidth part may be considered to be 0.

The MIB may include the following information as shown in Table 2 below. However, the MIB is not limited to the following example.

TABLE 2
-- ASN1START
-- TAG-MIB-START

| | |
|---|---|
| MIB::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}
-- TAG-MIB-STOP
-- ASN1STOP

An MIB field is described as follows.
cellBarred

Value barred means that the cell is barred, as defined in TS 38.304 [20].
dmrs-TypeA-Position

Position of (first) DM-RS for downlink (see TS 38.211 [16], clause 7.4.1.1.2) and uplink (see TS 38.211 [16], clause 6.4.1.1.3).
intraFreqReselection

Controls cell selection/reselection to intra-frequency cells when the highest ranked cell is barred, or treated as barred by the UE, as specified in TS 38.304 [20].
pdcch-ConfigSIB1

Determines a common ControlResourceSet (CORESET), a common search space and necessary PDCCH parameters. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1 (see TS 38.213 [13], clause 13).
ssb-SubcarrierOffset

Corresponds to kSSB (see TS 38.213 [13]), which is the frequency domain offset between SSB and the overall resource block grid in number of subcarriers. (See TS 38.211 [16], clause 7.4.3.1).

The value range of this field may be extended by an additional most significant bit encoded within PBCH as specified in TS 38.213 [13].

This field may indicate that this cell does not provide SIB1 and that there is hence no CORESET #0 configured in MIB (see TS 38.213 [13], clause 13). In this case, the field pdcch-ConfigSIB1 may indicate the frequency positions where the UE may (not) find a SS/PBCH with a control resource set and search space for SIB1 (see TS 38.213 [13], clause 13).
subCarrierSpacingCommon

Subcarrier spacing for SIB1, Msg.2/4 for initial access, paging and broadcast SI-messages. If the UE acquires this MIB on an FR1 carrier frequency, the value scs15or60 corresponds to 15 kHz and the value scs30or120 corresponds to 30 kHz. If the UE acquires this MIB on an FR2 carrier frequency, the value scs15or60 corresponds to 60 kHz and the value scs30or120 corresponds to 120 KHz.
systemFrameNumber

The 6 most significant bits (MSB) of the 10-bit System Frame Number (SFN). The 4 LSB of the SFN are conveyed in the PBCH transport block as part of channel coding (i.e., outside the MIB encoding), as defined in clause 7.1 in TS 38.212 [17].

In the method of bandwidth part configuration, UEs before an RRC connection may receive configuration information for an initial bandwidth part via an MIB during initial access. More specifically, a UE may be configured with a control resource set (CORESET) for a downlink control channel on which downlink control information (DCI) for scheduling of an SIB may be transmitted from an MIB of a physical broadcast channel (PBCH). In this case, a bandwidth of the control resource set, which is configured via the MIB, may be considered to be the initial bandwidth part, and the UE may receive a physical downlink shared channel (PDSCH), on which the SIB is transmitted, via the configured initial bandwidth part. In addition to reception of the SIB, the initial bandwidth part may be used for other system information (OSI), paging, and random access.

When one or more bandwidth parts are configured for the UE, the base station may indicate the UE to perform bandwidth part switching, by using a bandwidth part indicator field in the DCI.

A basic resource unit in the time-frequency domain is a resource element (RE) 112, which may be represented by an OFDM symbol index and a subcarrier index. A resource block (RB or a physical resource block (PRB)) 108 may be defined to be N_{RB} consecutive subcarriers 110 in the frequency domain. In general, a minimum transmission unit of data may be an RB unit. In the NR system, in general, N_{symb}=14, N_{RB}=12, and N_{BW} may be proportional to a bandwidth of a system transmission band. A data rate may increase in proportion to the number of RBs scheduled for a UE.

In the NR system, a downlink transmission bandwidth and an uplink transmission bandwidth may be different for an FDD system that operates by dividing a downlink and an uplink by frequency. A channel bandwidth represents an RF bandwidth corresponding to a system transmission bandwidth. Table 3 and Table 4 show some of correspondence relationships between channel bandwidths, subcarrier spacings (SCSs), and system transmission bandwidths defined in the NR system in a frequency band (frequency range 1 (FR1)) lower than 6 GHz and a frequency band (FR2) higher than 6 GHz, respectively. For example, the NR system having a channel bandwidth of 100 MHz with a subcarrier spacing of 30 kHz includes 273 RBs. In the following, N/A may be a bandwidth-subcarrier combination that is not supported by the NR system.

TABLE 3

| | 5 | 10 | 15 | 20 | 25 | 30 | 40 | 50 | 60 | 80 | 90 | 100 |
|---|---|---|---|---|---|---|---|---|---|---|---|---|
| SCS | MHz | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

TABLE 4

| | Channel bandwidth BW_{Channel} [MHz] | | | | | |
|---|---|---|---|---|---|---|
| | Subcarrier | | | | | |
| | Spacing | | 50 MHz | 100 MHz | 200 MHz | 400 MHz |
| Transmission | 60 | kHz | 66 | 132 | 264 | N/A |
| bandwidth | 120 | kHz | 32 | 66 | 132 | 264 |

configuration
N_{RB}

In the NR system, the frequency domain (frequency range) may be divided into FR1 and FR2 and defined as shown in Table 5 below.

TABLE 5

| Frequency range | |
|---|---|
| designation | Corresponding frequency range |
| FR1 | 450 MHz-7125 MHz |
| FR2 | 24250 MHz-52600 MHz |

Of course, FR1 and FR2 may be differently changed and applied. For example, FR1 may be changed from 450 MHz to 6000 MHz and applied.

In the following, a synchronization signal (SS)/PBCH block in 5G will be described.

The SS/PBCH block may refer to a physical layer channel block including a primary SS (PSS, primary synchronization signal), a secondary SS (SSS, secondary synchronization signal), and a PBCH. Detailed descriptions are as follows.
PSS: A PSS is a signal that serves as a reference for downlink time/frequency synchronization, and may provide some information of a cell ID.
SSS: An SSS serves as a reference for downlink time/frequency synchronization and may provide the remaining cell ID information that is not provided by the PSS. Additionally, the SSS may serve as a reference signal for PBCH demodulation.
PBCH: A PBCH may provide essential system information required for transmission and reception of a data channel and a control channel of the UE. The essential system information may include search space-related control information indicating radio resource mapping information of a control channel, scheduling control information on a separate data channel for transmitting system information, and the like.
SS/PBCH block: An SS/PBCH block may include a combination of a PSS, an SSS, and a PBCH. One or multiple SS/PBCH blocks may be transmitted within 5 ms, and each transmitted SS/PBCH block may be distinguished by an index.

The UE may decode a PBCH and may detect a PSS and an SSS during initial access. The UE may acquire an MIB from the PBCH, and may be configured with control resource set #0 (which may correspond to a control resource set having a control resource set index of 0). The UE may perform monitoring on control resource set #0 while assuming that demodulation reference signals (DMRSs) transmitted in control resource set #0 and a selected SS/PBCH block are quasi-co-located (QCLed). The UE may receive system information as downlink control information transmitted in control resource set #0. The UE may acquire, from the received system information, random-access channel (RACH)-related configuration information required for initial access. The UE may transmit a physical RACH (PRACH) to the base station in consideration of a selected SS/PBCH index, and the base station having received the PRACH may acquire information on the SS/PBCH block index selected by the UE. Via these procedures, the base station may identify a block that the UE has selected from among respective SS/PBCH blocks and may identify that control resource set #0 associated with the selected block is monitored.

FIG. 2 is a diagram illustrating mapping of a synchronization signal (SS) and a physical broadcast channel (PBCH) of the NR system in the frequency and time domains according to an embodiment of the disclosure.

A primary synchronization signal (PSS) 201, a secondary synchronization signal (SSS) 203, and a PBCH are mapped over four OFDM symbols, the PSS and the SSS are mapped to 12 RBs, and the PBCH is mapped to 20 RBs. How the frequency band of 20 RBs changes according to subcarrier spacing (SCS) is shown in a table of FIG. 2. A resource area in which the PSS, the SSS, and the PBCH are transmitted may be referred to as an SS/PBCH block. In addition, the SS/PBCH block may be referred to as a synchronization signal block (SSB).

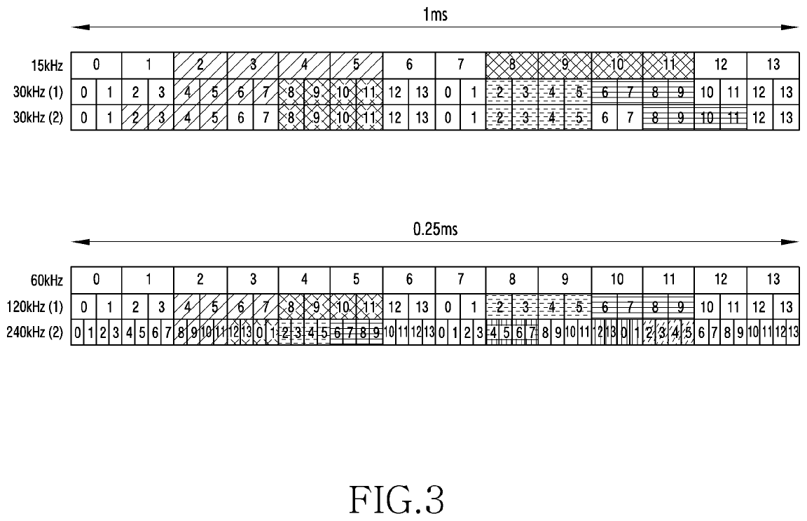

FIG. 3 is a diagram illustrating symbols on which an SS/PBCH block may be transmitted based on subcarrier spacings according to an embodiment of the disclosure.

Referring to FIG. 3, subcarrier spacings may be configured be to 15 kHz, 30 kHz, 120 kHz, 240 kHz, etc., and symbol positions at which an SS/PBCH block (or SSB) may be located may be determined according to each SCS. FIG. 3 illustrates symbol positions at which an SSB may be transmitted according to SCSs in symbols within 1 ms, and the SSB does not always have to be transmitted in the area illustrated in FIG. 3. The positions at which the SSB block is transmitted may be configured for a UE via system information or dedicated signaling.

Hereinafter, a downlink control channel in the 5G communication system will be described in more detail with reference to the drawings.

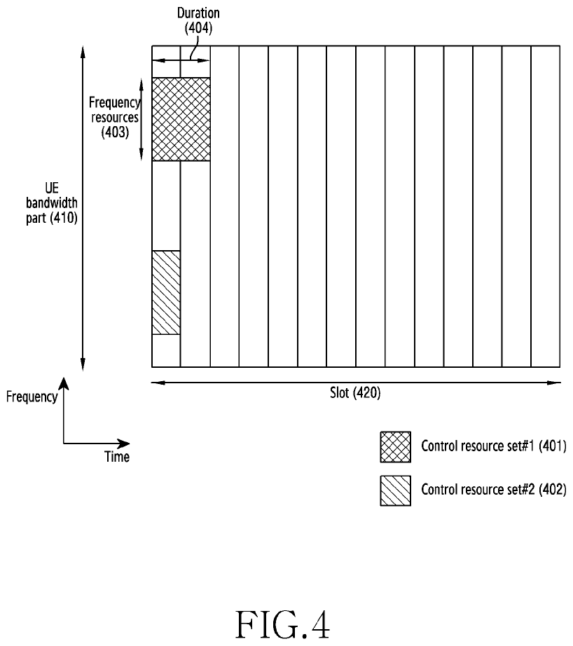

FIG. 4 is a diagram illustrating an example of a control resource set (CORESET) in which a downlink control channel is transmitted in the 5G wireless communication system according to an embodiment of the disclosure. FIG. 4 illustrates an example in which a UE bandwidth part 210 is configured on the frequency axis, and two control resource sets (control resource set #1 401 and control resource set #2 402) are configured within one slot 420 on the time axis. The control resource sets 401 and 402 may be configured in a specific frequency resource 403 within the entire UE bandwidth part 410 on the frequency axis. One or multiple OFDM symbols may be configured on the time axis and may be defined as a control resource set duration 404. Referring to the example illustrated in FIG. 4, control resource set #1 401 is configured to have a control resource set duration of 2 symbols, and control resource set #2 402 is configured to have a control resource set duration of 1 symbol.

The control resource sets in the 5G system described above may be configured for a UE by a base station via higher-layer signaling (e.g., system information, MIB, and RRC signaling). Configuring the control resource sets for the UE may refer to providing information, such as identifiers (identities) of the control resource sets, frequency positions of the control resource sets, and symbol lengths of the control resource sets. For example, higher-layer signaling may include information of Table 6 below. Of course, the method is not limited to the examples below.

TABLE 6

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| precoderGranularity | ENUMERATED {sameAsREG-bundle, |

allContiguousRBs},

| | |
|---|---|
| interleaverSize | ENUMERATED {n2, n3, n6} |

```
      shiftIndex
  INTEGER(0..maxNrofPhysicalResourceBlocks-1)
  OPTIONAL
}
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-Stateld | OPTIONAL, |
| tci-PresentInDCI | ENUMERATED {enabled} |
| | OPTIONAL, -- Need S |

}

In Table 6, tci-StatesPDCCH (simply, referred to as a transmission configuration indication (TCI) state) configuration information may include information on one or multiple SS/PBCH block indexes or CSI-RS (channel state information reference signal) indexes that are in a QCL relationship with a DMRS transmitted in the corresponding control resource set.

In the following, downlink control information (DCI) in the 5G system will be described in detail.

In the 5G system, scheduling information for uplink data (or physical uplink data channel (physical uplink shared channel (PUSCH)) or downlink data (or physical downlink data channel (physical downlink shared channel (PDSCH)) is delivered from the base station to the UE via DCI. The UE may monitor a fallback DCI format and a non-fallback DCI format for the PUSCH or PDSCH. The fallback DCI format may include a fixed field predefined between the base station and the UE, and the non-fallback DCI format may include a configurable field. In addition, there are various DCI formats, and each format may indicate whether DCI is for power control, DCI is for notifying of a slot format indicator (set forth in), or the like.

The DCI may be transmitted on a PDCCH that is physical downlink control channel via channel coding and modulation. A cyclic redundancy check (CRC) is attached to a DCI message payload, and the CRC may be scrambled by a radio network temporary identifier (RNTI) corresponding to the identity of the UE. Different RNTIs may be used according to the purpose of the DCI message, for example, UE-specific data transmission, a power control command, a random-access response, or the like. In other words, the RNTI is not transmitted explicitly, but is included in CRC calculation and transmitted. When the DCI message transmitted on the PDCCH is received, the UE may identify the CRC by using the assigned RNTI, and if a CRC identification result is correct, the UE may determine that the received DCI message has been transmitted to the UE. The PDCCH may be transmitted by being mapped in a control resource set (CORESET) configured for the UE.

For example, DCI for scheduling of a PDSCH for system information (SI) may be scrambled by an SI-RNTI. DCI for scheduling of a PDSCH for a random-access response (RAR) message may be scrambled by an RA-RNTI. DCI for scheduling of a PDSCH for a paging message may be scrambled by a P-RNTI. DCI for notification of a slot format indicator (SFI) may be scrambled by an SFI-RNTI. DCI for notification of a transmit power control (TPC) may be scrambled by a TPC-RNTI. DCI for scheduling of a UE-specific PDSCH or PUSCH may be scrambled by a cell RNTI (C-RNTI). Of course, the types of RNTI are not limited to the example above.

DCI format 0_0 may be used as fallback DCI for PUSCH scheduling, wherein a CRC is scrambled by a C-RNTI. DCI format 0_0 in which the CRC is scrambled by the C-RNTI may include, for example, the following information. Of course, the information is not limited to the following examples.

TABLE 7

Identifier for DCI formats - [1] bit
Frequency domain resource assignment -
[┌log₂(N_{RB}^{UL, BWP}(N_{RB}^{UL, BWP} + 1)/2)┐] bits
Time domain resource assignment - X bits
Frequency hopping flag - 1 bit
Modulation and coding scheme - 5 bits
New data indicator - 1 bit
Redundancy version - 2 bits
HARQ process number - 4 bits
TPC command for scheduled PUSCH - 2 bits
UL/SUL indicator - 0 or 1 bit

DCI format 0_1 may be used as non-fallback DCI for PUSCH scheduling, wherein a CRC is scrambled by a C-RNTI. DCI format 0_1 in which the CRC is scrambled by the C-RNTI may include, for example, the following information. Of course, the information is not limited to the following examples.

```
TABLE 8
- Carrier indicator - 0 or 3 bits
- UL/SUL indicator - 0 or 1 bit
- Identifier for DCI formats - 1 bit
- Bandwidth part indicator - 0, 1, or 2 bits
- Frequency domain resource assignment
  • For resource allocation type 0, ┌N_{RB}^{UL,BWP}/P┐ bits
  • For resource allocation type 1, ┌log₂ (N_{RB}^{UL,BWP}(N_{RB}^{UL,BWP} + 1) / 2)┐ bits
-  Time domain resource assignment - 1, 2, 3 or 4 bits
-  VRB-to-PRB mapping - 0 or 1 bit, only for resource allocation type 1
  • 0 bit if only resource allocation type 0 is configured;
  • 1 bit otherwise.
- Frequency hopping flag - 0 or 1 bit, only for resource allocation type 1
  • 0 bit if only resource allocation type 0 is configured;
  • 1 bit otherwise.
- Modulation and coding scheme - 5 bits
- New data indicator - 1 bit
- Redundancy version - 2 bits
- HARQ process number - 4 bits
- 1^{st} downlink assignment index - 1 or 2 bits
  • 1 bit for semi-static HARQ-ACK codebook;
  • 2 bits for dynamic HARQ-ACK codebook with single HARQ-ACK codebook
- 2^{nd} downlink assignment index - 0 or 2 bits
  • 2 bits for dynamic HARQ-ACK codebook with two HARQ-ACK sub-codebooks;
  • 0 bit otherwise.
- TPC command for scheduled PUSCH - 2 bits
$- SRS resource indicator - ⌈ {log}_{2} ( {\sum }_{k = 1}^{L \text{?}} ( {{N}_{SRS} \atop k} ) ) ⌉ or ⌈ {log}_{2} ( {N}_{SRS} ) ⌉ bits$
$⌈ {log}_{2} ( {\sum }_{k = 1}^{L \text{?}} ( {{N}_{SRS} \atop k} ) ) ⌉ bits for non - codebook based PUSCH transmission$
  • ┌log₂ (NSRS)┐ bits for codebook based PUSCH transmission
- Precoding information and number of layers - up to 6 bits
- Antenna ports - up to 5 bits
- SRS request - 2 bits
- CSI request - 0, 1, 2, 3, 4, 5, or 6 bits
- CBG transmission information - 0, 2, 4, 6, or 8 bits
- PTRS-DMRS association - 0 or 2 bits
- beta_offset indicator - 0 or 2 bits
- DMRS sequence initialization - 0 or 1 bit
$\text{?} \text{indicates text missing or illegible when filed}$
```

DCI format 1_0 may be used as fallback DCI for PDSCH scheduling, wherein a CRC is scrambled by a C-RNTI. DCI format 1_0 in which a CRC is scrambled by a C-RNTI may include, for example, the following information. Of course, the disclosure is not limited to the following examples.

TABLE 9
Identifier for DCI formats - [1] bit
Frequency domain resource assignment −[┌log₃(N_{RB}^{DL, BWP} (N_{RB}^{DL, BWP} + 1)/2)┐] bits
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
PUCCH resource indicator - 3 bits
PDSCH-to-HARQ feedback timing indicator - [3] bits

DCI format 1_1 may be used as non-fallback DCI for PDSCH scheduling, wherein a CRC is scrambled by a C-RNTI. DCI format 1_1 in which the CRC is scrambled by the C-RNTI may include, for example, the following information. Of course, the information is not limited to the following examples.

```
TABLE 10
  Carrier indicator - 0 or 3 bits
  Identifier for DCI formats - [1] bits
  Bandwidth part indicator - 0, 1 or 2 bits
  Frequency domain resource assignment
    For resource allocation type 0, ┌N_{RB}^{DL, BWP}/P┐ bits
    For resource allocation type 1, ┌log₂(N_{RB}^{DL, BWP}(N_{RB}^{DL, BWP}+ 1)/2)┐ bits
  Time domain resource assignment −1, 2, 3, or 4 bits
  VRB-10-PRB mapping - 0 or 1 bit, only for resource allocation type 1.
    0 bit if only resource allocation type 0 is configured;
    1 bit otherwise.
  PRB bundling size indicator - 0 or 1 bit
  Rate matching indicator - 0, 1, or 2 bits
  ZP CSI-RS trigger - 0. 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

For example, each piece of control information included in DCI format 1_1, which is scheduling control information (DL grant) for downlink data, may include the following information. Of course, the information is not limited to the following examples.
Carrier indicator: Indicating a carrier on which data scheduled by DCI is transmitted-0 or 3 bits
Identifier for DCI formats: Indicating a DCI format. Specifically, this identifier for DCI formats is an indicator for identifying whether corresponding DCI is for downlink or is for uplink.—[1] bits
Bandwidth part indicator: Indicating a change in a bandwidth part, if any exists—0, 1, or 2 bits
Frequency domain resource assignment: Resource allocation information indicating frequency domain resource allocation. A resource expressed varies depending on whether a resource allocation type is 0 or 1.
Time domain resource assignment: Resource allocation information indicating time domain resource allocation. This may indicate one configuration of a predefined PDSCH time domain resource allocation list or higher-layer signaling-1, 2, 3, or 4 bits
VRB-to-PRB mapping: Indicating a mapping relationship between a virtual resource block (VRB) and a physical resource block (PRB)—0 or 1 bit
PRB bundling size indicator: Indicating a size of physical resource block bundling assuming that the same precoding is applied—0 or 1 bit
Rate matching indicator: Indicating a rate match group to be applied among rate match groups configured via a higher layer applied to PDSCH—0, 1, or 2 bits
ZP CSI-RS trigger: Triggering a zero-power channel state information (CSI) reference signal (RS)—0, 1, or 2 bits
Transport block (TB)-related configuration information: Indicating modulation and coding scheme (MCS), new data indicator (NDI), and redundancy version (RV) for one or two TBs.
Modulation and coding scheme (MCS): Indicating a coding rate and a modulation scheme used for data transmission. That is, MCS may indicate a coding rate value enables informing of a transport block size (TBS) and channel coding information, in addition to information indicating whether a modulation scheme is quadrature phase shift keying (QPSK), quadrature amplitude modulation (16QAM), 64QAM, or 256QAM.
New data indicator: Indicating whether transmission is HARQ initial transmission or retransmission.
Redundancy version: Indicating a redundancy version of HARQ

HARQ process number: Indicating an HARQ process number applied to PDSCH—4 bits
Downlink assignment index: An index for generating a dynamic HARQ-ACK codebook when reporting HARQ-ACK for PDSCH—0, 2, or 4 bits
TPC command for scheduled physical uplink control channel (PUCCH): Power control information applied to PUCCH for HARQ-ACK report for PDSCH—2 bits
PUCCH resource indicator: Information indicating a resource of PUCCH for HARQ-ACK report for PDSCH—3 bits
PDSCH-to-HARQ_feedback timing indicator: Configuration information for a slot on which PUCCH for HARQ-ACK report for PDSCH is transmitted—3 bits
Antenna ports: Information indicating an antenna port of a PDSCH DMRS and a DMRS code division multiplexing (CDM) group in which PDSCH is not transmitted—4, 5, or 6 bits
Transmission configuration indication: Information indicating beam-related information for PDSCH—0 or 3 bits
SRS request: Information requesting sounding reference signal (SRS) transmission-2 bits
Code block group (CBG) transmission information: Information indicating data corresponding to which code block group (CBG) is transmitted via PDSCH when code block group-based retransmission is configured—0, 2, 4, 6, or 8 bits
CBG flushing out information: Information indicating whether a code block group previously received by the UE may be used for HARQ combining—0 or 1 bit
DMRS sequence initialization: Indicating DMRS sequence initialization parameter—1 bit

Hereinafter, a time domain resource allocation method for a data channel in the 5G communication system will be described.

Downlink data may be transmitted on a PDSCH that is a physical channel for downlink data transmission. Uplink data may be transmitted on a PUSCH that is a physical channel for uplink data transmission. A PDSCH may be transmitted after a control channel transmission interval, and scheduling information, such as a specific mapping position, a modulation scheme, etc. in the frequency domain, is determined based on DCI transmitted via the PDCCH.

The base station may configure, for the UE via higher-layer signaling (e.g., RRC signaling), a table for time domain resource allocation information on a downlink data channel (PDSCH) and an uplink data channel (PUSCH). A table including up to maxNrofDL−Allocations=16 entries may be configured for the PDSCH, and a table including up to maxNrofUL−Allocations=16 entries may be configured for the PUSCH. The time domain resource allocation information may include, for example, PDCCH-to-PDSCH slot timing (denoted as K0, and corresponding to a time interval in units of slots between a time point at which a PDCCH is received and a time point at which a PDSCH scheduled by the received PDCCH is transmitted), PDCCH-to-PUSCH slot timing (denoted as K2, and corresponding to a time interval in units of slots between a time point at which a PDCCH is received and a time point at which a PUSCH scheduled by the received PDCCH is transmitted), information on a position and length of a start symbol in which the PDSCH or PUSCH is scheduled within a slot, a mapping type of the PDSCH or PUSCH, or the like. For example, information as shown in [Table 11] and [Table 12] below may be notified to the UE from the base station. Of course, the information is not limited to the following examples.

TABLE 11
PDSCH-TimeDomainResourceAllocationList information element

PDSCH-TimeDomainResourceAllocationList ::= SEQUENCE (SIZE(1..maxNrofDL-
Allocations)) OF PDSCH-TimeDomainResourceAllocation
PDSCH-TimeDomain ResourceAllocation ::= SEQUENCE {

| | |
|---|---|
| k0 | INTEGER(0..32) |

OPTIONAL, -- Need S

| | |
|---|---|
| mappingType | ENUMERATED {typeA, typeB}, |
| startSymbolAndLength | INTEGER (0..127) |

}

TABLE 12
PUSCH-TimeDomainResourceAllocation information element

PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {

| | |
|---|---|
| k2 | INTEGER(0..32) OPTIONAL, -- |

Need S

| | |
|---|---|
| mappingType | ENUMERATED {typeA, typeB}, |
| startSymbolAndLength | INTEGER (0..127) |

}

The base station may provide the UE with a notification of one of entries in the table for time domain resource allocation information via L1 signaling (e.g., DCI) (e.g., the entry may be indicated using a “time domain resource allocation” field in the DCI). The UE may acquire the time domain resource allocation information for the PDSCH or PUSCH, based on the DCI received from the base station.

According to an embodiment of the disclosure, time domain resource assignment may be delivered by information on a slot in which the PDSCH/PUSCH is transmitted, a start symbol position S in the slot, and the number L of symbols to which the PDSCH/PUSCH is mapped. Here, S may be a relative position from the start of the slot, L may be the number of contiguous symbols, and S and L may be determined from a start and length indicator value (SLIV) defined as in Equation 1 below.

$$if ( L - 1 ) \leq 7 then \\ SLIV = 14 * ( L - 1 ) + S \\ else \\ SLIV = 14 * ( 14 - L + 1 ) + ( 14 - 1 - S ) \\ where 0 < L \leq 14 - S \qquad [ Equation 1 ]$$

In the NR system, type A and type B are defined for PDSCH mapping types. In PDSCH mapping type A, the first symbol of DMRS OFDM symbols is located at the second or third OFDM symbol of the slot. In PDSCH mapping type B, the first symbol of DMRS symbols is located in the first OFDM symbol in the time domain resource allocated for PUSCH transmission.

Via the modulation coding scheme (MCS) in the control information constituting the DCI, the base station notifies the UE of the modulation scheme that has been applied to the PDSCH to be transmitted and the size (transport block size (TBS)) of data to be transmitted. According to an embodiment of the disclosure, the MCS may include 5 bits or include more or fewer than 5 bits. The TBS may correspond to a size before applying channel coding for error correction to the data (TB) to be transmitted by the base station.

In the disclosure, a transport block (TB) may include a MAC header, a MAC control element, one or more MAC service data units (SDUs), and padding bits. Alternatively, a TB may indicate a unit of data delivered from a MAC layer to a physical layer or a MAC protocol data unit (PDU).

Modulation schemes supported by the NR system are QPSK, 16 QAM, 64 QAM, and 256 QAM, and modulation orders (Qₘ) correspond to 2, 4, 6, and 8, respectively. That is, 2 bits per symbol may be transmitted for QPSK modulation, 4 bits per symbol may be transmitted for 16 QAM modulation, 6 bits per symbol may be transmitted for 64 QAM modulation, and 8 bits per symbol may be transmitted for 256 QAM modulation.

The terms “physical channel” and “signal” in the NR system may be used to describe the method and device proposed in an embodiment of the disclosure. However, the descriptions of the disclosure may be applied to a wireless communication system other than the NR system.

In the disclosure, a downlink (DL) is a wireless transmission path of a signal transmitted from a base station to a UE, and an uplink (UL) indicates a wireless transmission path of a signal transmitted from a UE to a base station.

In the disclosure, the existing terms of “physical channel” and “signal” may be used interchangeably with “data” or “control signal”. For example, a PDSCH is a physical channel on which data is transmitted, but a PDSCH may also be referred to as data.

Hereinafter, in the disclosure, higher signaling is a signal delivering method in which a signal is transmitted from a base station to a UE by using a physical layer downlink data channel or a signal is transmitted from a UE to a base station by using a physical layer uplink data channel, wherein the higher signaling may be referred to as RRC signaling or MAC control element (MAC CE).

According to an embodiment of the disclosure, timing advance (TA) may be transmitted via an MAC control element (CE), for example, a timing advance command MAC CE or an absolute timing advance command MAC CE.

A message from an MAC layer, which is delivered to a physical layer, for example, a MAC PDU, may include one or more MAC sub-PDUs. Each MAC sub-PDU may include one of the following. Of course, each MAC sub-PDU is not limited to the following examples.
MAC subheader only (including padding)
MAC subheader and MAC SDU
MAC subheader and MAC CE
MAC subheader and padding

MAC SDUs may have variable sizes, and each MAC subheader may correspond to MAC SDU, MAC CE, or padding.

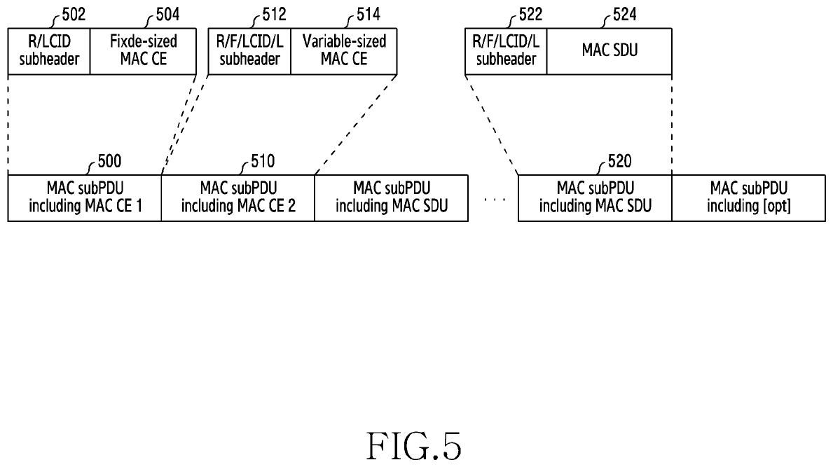

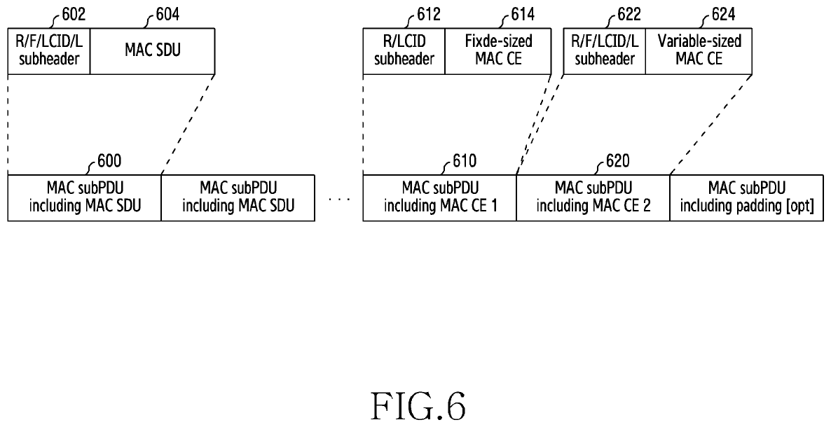

A message from an MAC layer, which is delivered to a physical layer, for example, a MAC PDU, may be configured as shown in FIG. 5 and FIG. 6 for a downlink and an uplink, respectively.

First, an example of a message delivered from a MAC layer to a physical layer in a downlink in the communication system according to various embodiments of the disclosure will be described with reference to FIG. 5.

FIG. 5 is a diagram schematically illustrating an example of a message delivered from a MAC layer to a physical layer in a downlink in the communication system according to an embodiment of the disclosure.

Referring to FIG. 5, an example of a message delivered from an MAC layer to a physical layer in a downlink may be a downlink MAC PDU (DL MAC PDU). In FIG. 5, a MAC subPDU 500 including MAC CE 1 may include an R/logical channel identity (LCID) subheader 502 and a fixed-sized MAC CE 504, and a MAC subPDU 510 including MAC CE 2 may include an R/F/LCID/L subheader 512 and a variable-sized MAC CE 514. In addition, a MAC subPDU 520 including a MAC SDU may include an R/F/LCID/L subheader 522 and a MAC SDU 524.

In FIG. 5, an LCID indicates a logical channel ID field, an LCID field indicates an instance of the corresponding MAC SDU, a type of the corresponding MAC CE, or padding. This will be described in detail in Tables 13 and 14 below. Here, Table 13 below shows LCID values for DL-SCH, and Table 14 shows LCID values for UL-SCH.

TABLE 13

| Codepoint/Index | LCID values |
|---|---|
| 0 | CCCH |
| 1-32 | Identity of the logical channel |
| 33 | Extended logical channel ID field (two-octet eLCID |
| | field) |
| 34 | Extended logical channel ID field (one-octet eLCID |
| | field) |
| 35-46 | Reserved |
| 47 | Recommended bit rate |
| 48 | SP ZP CSI-RS Resource Set |
| | Activation/Deactivation |
| 49 | PUCCH spatial relation Activation/Deactivation |
| 50 | SP SRS Activation/Deactivation |
| 51 | SP CSI reporting on PUCCH |
| | Activation/Deactivation |
| 52 | TCI State Indication for UE-specific PDCCH |
| 53 | TCI States Activation/Deactivation for UE-specific |
| | PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 14

| Codepoint | Index | LCID values |
|---|---|---|
| 0 to 244 | 64 to 308 | Reserved |
| 245 | 309 | Serving Cell Set based SRS |
| | | Spatial Relation Indication |
| 246 | 310 | PUSCH Pathloss Reference RS |
| | | Update |
| 247 | 311 | SRS Pathloss Reference RS |
| | | Update |
| 248 | 312 | Enhanced SP/AP SRS Spatial |
| | | Relation Indication |
| 249 | 313 | Enhanced PUCCH Spatial Relation |
| | | Activation/Deactivation |
| 250 | 314 | Enhanced TCI States |
| | | Activation/Deactivation for UE- |
| | | specific PDSCH |
| 251 | 315 | Duplication RLC |
| | | Activation/Deactivation |
| 252 | 316 | Absolute Timing Advance |
| | | Command |
| 253 | 317 | SP Positioning SRS |
| | | Activation/Deactivation |
| 254 | 318 | Provided Guard Symbols |
| 255 | 319 | Timing Delta |

There is one LCID field per MAC subheader, and a size of the LCID field is 6 bits. When the LCID field is configured to be, for example, “34”, one additional octet exists in a MAC subheader including an extended LCID (eLCID) field, and follows an octet including the LCID field. When the LCID field is configured to be, for example, “33,” two additional octets exist in the MAC subheader including the eLCID field and follow the octet including the LCID field.

In addition, an eLCID indicates an extended logical channel ID field and indicates a logical channel instance of the corresponding MAC SDU or a type of the corresponding MAC CE. The eLCID field has a size of 8 bits or 16 bits.

In addition, L denotes a length field, and the length field indicates a length of the corresponding MAC SDU or a length of the variable-sized MAC CE. One length field exists for each MAC subheader excluding subheaders corresponding to MAC SDUs including the fixed-sized MAC CEs, padding, or a UL common control channel (CCCH). The size of the length field is indicated by an F field.

In addition, F denotes a format field and indicates a size of the length field. One F field exists for each MAC subheader excluding MAC SDUs including the fixed-sized MAC CEs, padding, and UL CCCH. The size of the F field is 1 bit, and for example, a value of 0 indicates 8 bits of the length field, and for another example, a value of 1 indicates 16 bits of the length field.

In addition, R is a reserved bit and is configured to be, for example, “0.”

As illustrated in FIG. 5, MAC CEs, for example, MAC CE 1 and MAC CE 2 are disposed together, and the MAC subPDU(s) including MAC CE(s) are disposed before a MAC subPDU including MAC SDU and a MAC subPDU including padding. Here, the padding may have a size of 0.

In the following, referring to FIG. 6, a description will be provided for an example of a message delivered from a MAC layer to a physical layer in an uplink in the communication system according to various embodiments of the disclosure.

FIG. 6 is a diagram schematically illustrating an example of a message delivered from a MAC layer to a physical layer in an uplink in the communication system according to an embodiment of the disclosure.

Referring to FIG. 6, an example of a message delivered from a MAC layer to a physical layer in an uplink may be an uplink MAC PDU (UL MAC PDU). In FIG. 6, a MAC subPDU 610 including MAC CE 1 includes an R/LCID subheader 612 and a fixed-sized MAC CE 614, and a MAC subPDU 620 including MAC CE 2 includes an R/F/LCID/L subheader 622 and a variable-sized MAC CE 624. In addition, a MAC subPDU 600 including a MAC SDU includes an R/F/LCID/L subheader 602 and a MAC SDU 604.

As illustrated in FIG. 6, MAC CEs, for example, MAC CE 1 and MAC CE 2 are disposed together, and the MAC subPDU(s) including MAC CE(s) are disposed after a MAC subPDU including MAC SDU and disposed before a MAC sub-PDU including padding. Here, the padding may have a size of 0.

In FIG. 5 and FIG. 6, the LCID included in the subheader of the MAC layer, i.e., the logical channel ID (LCID) or the extended logical channel ID (eLCID), may indicate a type of the MAC SDU, MAC CE, or the like to be transmitted. Mapping between an index of the LCID and the type of the MAC SDU or MAC CE may be shown as in Table 13 below, and mapping between an index of the eLCID and the type of the MAC SDU or MAC CE may be shown in Table 14 below. In various embodiments of the disclosure, the LCID may indicate an instance of a logical channel of MAC SDU, a type of MAC CE, or padding information of a downlink shared channel (DL-SCH) and an uplink shared channel (UL-SCH). One LCID may be mapped to each MAC subheader, and the LCID may be implemented by, for example, 6 bits.

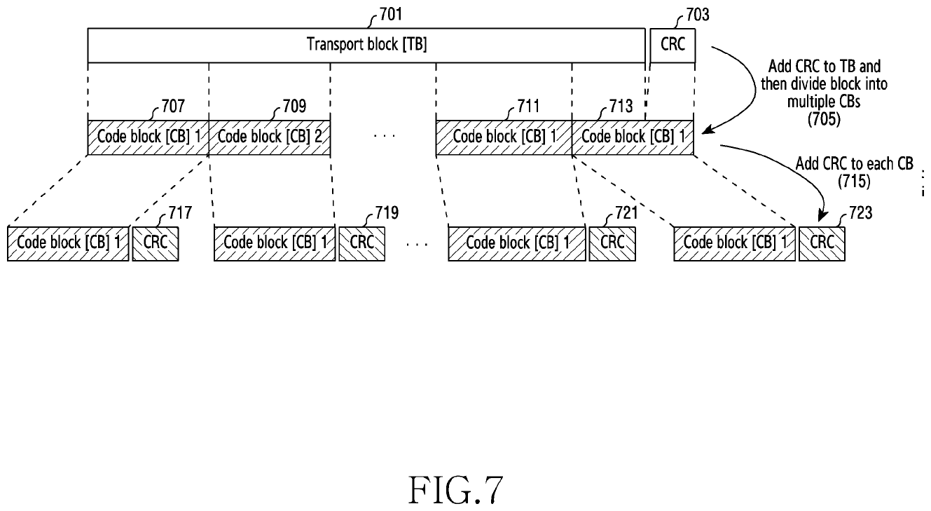

FIG. 7 is a diagram illustrating an example of a procedure in which one transport block (TB) is divided into multiple code blocks (CBs) and a CRC is added, according to an embodiment of the disclosure.

Referring to FIG. 7, a CRC 703 may be added to the last or front part of one transport block (TB) 701 to be transmitted in an uplink or a downlink. The CRC 703 may have 16 bits, 25 bits, or a pre-fixed number of bits, or may have a variable number of bits according to a channel situation, and may be used to determine the success or failure of channel coding. A block obtained by adding the CRC 703 to the TB 701 may be divided into multiple code blocks (CBs) 707, 709, 711, and 713 (in 705). According to an embodiment of the disclosure, maximum sizes of the code blocks may be pre-determined before division and, in this case, a size of the last code block 713 may be smaller than sizes of the other code blocks 707, 709, and 711. However, the disclosure is not limited to the description above, and 0, a random value, or 1 may be inserted into the last code block 713, so that the last code block 713 and the other code blocks 707, 709, and 711 may have the same length.

In addition, CRCs 717, 719, 721, and 723 may be added to the code blocks 707, 709, 711, and 713, respectively (in 715). The CRCs may have 16 bits, 24 bits, or a pre-fixed number of bits, and may be used to determine the success or failure of channel coding.

The TB 701 and a cyclic generator polynomial may be used to generate the CRC 703, and the cyclic generator polynomial may be defined in various ways. For example, assuming that a cyclic generator polynomial for a 24-bit CRC is gCRC24A(D)=D²⁴+D²³+D¹⁸+D¹⁷+D¹⁴+D¹¹+D¹⁰+D⁷+D⁶+D⁵+D⁴+D³+D+1, and when L=24, CRC p₀, p₁, p₂, p₃, . . . , p_{L-1}, with respect to a₀, a₁, a₂, a₃, . . . , a_{A-1}, may be determined to be a value whose remainder is 0 when a₀D^{A+23}+a₁D^{A+22}+ . . . +a_{A-1}D²⁴+p₀D²³+p₁D²²+ . . . +p₂₂D¹+p₂₃ is divided by gCRC24A(D). The aforementioned example has been described on the assumption that CRC length L is 24, but CRC length L may be variously determined to be, for example, 12, 16, 24, 32, 40, 48, 64, etc.

After the CRC is added to the TB via this procedure, TB+CRC may be divided into N CBs 707, 709, 711, and 713. The CRCs 717, 719, 721, and 723 may be added to the divided CBs 707, 709, 711, and 713, respectively (in 715). The CRCs added to the CBs may have different lengths from the length when the CRC added to the TB is generated, or another cyclic generator polynomial may be used for CRC generation. In addition, the CRC 703 added to the TB and the CRCs 717, 719, 721, and 723 added to the code blocks may be omitted according to the type of channel code to be applied to the code blocks. For example, when a low-density parity check (LDPC) code, other than a turbo code, is applied to the code blocks, the CRCs 717, 719, 721, and 723 to be inserted for the respective code blocks may be omitted.

However, even when the LDPC is applied, the CRCs 717, 719, 721, and 723 may be added to the code blocks as they are. In addition, even when a polar code is used, a CRC may be added or omitted.

As described above with reference to FIG. 7, for the TB to be transmitted, the maximum length of one code block may be determined depending on the type of channel coding to be applied, and the TB and the CRC added to the TB may be divided into code blocks depending on the maximum length of the code block.

In a legacy LTE system, a CRC for a CB is added to a divided CB, the CRC and data bits of the CB are encoded with a channel code so that coded bits are determined, and the number of bits to be rate-matched is determined as previously agreed on coded bits.

In the NR system, a TB size (TBS) may be calculated via the following operations.

Operation 1: N′_{RE}, which is the number of REs allocated to PDSCH mapping in one PRB within an allocated resource, is calculated. N′_{RE} may be calculated as N′_{RE}=N_{SC}^{RB}·N_{symb}^{sh}−N_{DMBS}^{PRB}−Nₒₕ^{PRB}. Here, N_{SC}^{RB} is 12, and V_{symb}^{sh} may indicate the number of OFDM symbols allocated to a PDSCH. N_{DMRS}^{PRB} is the number of REs in one physical resource block (PRB) occupied by DMRSs of the same code division multiplexing (CDM) group. Nₒₕ^{PRB} is the number of REs occupied by overhead in one PRB configured by higher-layer signaling, and may be configured to be one of 0, 6, 12, and 18. Then, the total number N_{RE} of REs allocated to the PDSCH may be calculated. N_{RE} is calculated as min(156, N′_{RE})*n_{PRB}, and n_{PRB} indicates the number of PRBs allocated to the UE.

Operation 2: The number N_{info} of temporary information bits may be calculated as N_{RE}*R*Qₘ*v. Here, R is a code rate, Qₘ is a modulation order, and information on this value may be delivered using an MCS bit field of DCI and a pre-arranged table. In addition, v is the number of allocated layers. If N_{info}≤3824, TBS may be calculated via operation 3 below. Otherwise, TBS may be calculated via operation 4.

Operation 3: N′_{info} may be calculated via equations

$${N}_{info}^{′} = max ( 24 , {2}^{n} \cdot ⌊ \frac{{N}_{info}}{{2}^{n}} ⌋ ) and n = max ( 3 , ⌊ {log}_{2} ( {N}_{info} ) - 6 ⌋ .$$

TBS may be determined to be a value closest to N′_{info} among values not smaller than N′_{info} in Table 15 below.

TABLE 15

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

Operation 4: N′_{info} may be calculated via equations

$${N}_{info}^{′} = max ( 3840 , {2}^{n} \times round ( \frac{{N}_{info} - 24}{{2}^{n}} ) ) and n = ⌊ {log}_{2} ( {N}_{info} - 24 ) ⌋ - 5.$$

TBS may be determined via a value of N′_{info} and [pseudo-code 1] below. In the following, C corresponds to the number of code blocks included in one TB.

```
[Beginning of Pseudo-code 1]
if R ≤ 1/4
  $TBS = 8 * C * ⌈ \frac{{N}_{info}^{′} + 24}{8 * C} ⌉ - 24 , where$
  $C = [ \frac{{N}_{info}^{′} + 24}{3816} ]$
  else
if N_{info}′ > 8424
  $TBS = 8 * C * ⌈ \frac{{N}_{info}^{′} + 24}{8 * C} ⌉ - 24 , where$
  $C = [ \frac{{N}_{info}^{′} + 24}{8424} ]$
  else
    $TBS = 8 * ⌈ \frac{{N}_{info}^{′} + 24}{8} ⌉ - 24$
  end if
end if
[End of pseudo-code 1]
```

In the NR system, when one CB is input to an LDPC encoder, parity bits may be added and output. In this case, the number of parity bits may vary depending on an LDPC base graph. A method of transmitting all parity bits generated by LDPC coding with respect to a specific input may be referred to as full buffer rate matching (FBRM), and a method of limiting the number of transmittable parity bits may be referred to as limited buffer rate matching (LBRM). When resources are allocated for data transmission, an LDPC encoder output is generated to a circular buffer, and bits of the generated buffer are repeatedly transmitted as many times as the number of the allocated resources, and a length of the circular buffer in this case may be referred to as N_{cb}.

If the number of all the parity bits generated by LDPC coding is N, N_{cb}=N in the FBRM method. In the LBRM method, N_{cb} is min(N,N_{ref}), N_{ref} is given as

$$⌊ \frac{{TBS}_{LBRM}}{C \cdot {R}_{LBRM}} ⌋ ,$$

and R_{LBRM} may be determined to be ⅔. In order to obtain TBS_{LBRM}, the method of obtaining TBS is used, wherein the maximum number of layers and maximum modulation order supported by the UE in a corresponding cell are assumed, and if an MCS table supporting 256 QAM is configured to be used for at least one BWP in the cell, the maximum modulation order Qₘ is assumed to be 8, or otherwise, Qₘ is assumed to be 6 (64 QAM). The code rate is assumed to be the maximum code rate, i.e., 948/1024, and calculation is performed by assuming that N_{RE} is 156*n_{PRB}, and n_{PRB} is n_{PRB,LBRM}. n_{PRB,LBRM} may be given as shown in Table 16 below.

TABLE 16

| Maximum number of PRBs across all | |
|---|---|
| configured BWPs of a carrier | n_{PRB, LBRM} |
| Less than 33 | 32 |
| 33 to 66 | 66 |
| 67 to 107 | 107 |
| 108 to 135 | 135 |
| 136 to 162 | 162 |
| 163 to 217 | 217 |
| Larger than 217 | 273 |

In the NR system, the maximum data rate supported by the UE may be determined via Equation 2 below.

$$data range ( in Mbps ) = \qquad [ Equation 2 ]$$

$${10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{PRB}^{BW ( j ) , μ} \cdot 12}{{T}_{s}^{μ}} \cdot ( 1 - {OH}^{( j )} ) )$$

In Equation 2, J may indicate the number of carriers bound by frequency aggregation, Rₘₐₓ=948/1024, v_{Layers}^{(j)} may indicate the maximum number of layers, Qₘ^{(j)} may indicate a maximum modulation order, f^{( )} may indicate a scaling index, and μ may indicate a subcarrier spacing. The UE may report f^{( )} as one value among 1, 0.8, 0.75, and 0.4, and μ may be given as shown in Table 17 below.

TABLE 17

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

In addition, Tₛ^{μ} is an average OFDM symbol length, Tₛ^{μ} may be calculated based on

$$\frac{{10}^{- 3}}{14 \cdot {2}^{μ}} ,$$

and N_{PRB}^{BW(j),μ} is the maximum number of RBs in BW(j). OH^{(j)} is an overhead value, and may be given as 0.14 in a downlink of FR1 (a band equal to or lower than 6 GHz) and 0.18 in an uplink of FR1, and may be given as 0.08 in a downlink of FR2 (a band higher than 6 GHZ) and 0.10 in an uplink of FR2. Via Equation 2, the maximum data rate in a downlink in a cell having a frequency bandwidth of 100 MHz at a subcarrier spacing of 30 kHz may be calculated as shown in Table 18 below.

TABLE 18

| [symbol] | [symbol] | [symbol] | Rmax | [symbol] | Tₛ^{μ} | OH^{(j)} | data rate |
|---|---|---|---|---|---|---|---|
| 1 | 4 | 8 | 0.92578125 | 273 | 3.57143E−05 | 0.14 | 2337.0 |
| 0.8 | 4 | 8 | 0.92578125 | 273 | 3.57143E−05 | 0.14 | 1869.6 |
| 0.75 | 4 | 8 | 0.92578125 | 273 | 3.57143E−05 | 0.14 | 1752.8 |
| 0.4 | 4 | 8 | 0.92578125 | 273 | 3.57143E−05 | 0.14 | 934.8 |

[symbol]

indicates data missing or illegible when filed

On the other hand, an actual data rate that may be measured by the UE in actual data transmission may be a value obtained by dividing a data amount by a data transmission time. This may be a value obtained by dividing TBS by a TTI length for 1 TB transmission or dividing the sum of TBSs by the TTI length for 2 TB transmission. For example, as in the assumption of obtaining Table 15, the maximum actual data rate in the downlink in the cell having the frequency band of 100 MHz in the subcarrier spacing of 30 kHz may be determined as shown in Table 19 below according to the number of allocated PDSCH symbols.

TABLE 19

| | | | | | | | | | TTI | |
|---|---|---|---|---|---|---|---|---|---|---|
| | | | | | | | | | length | data rate |
| N [symbol] | N_{DMRS}^{PRB} | N_{RE} | N_{RE} | N_{info} | n | N_{info} | C | TBS | (ms) | (Mbps) |
| 3 | 8 | 28 | 7644 | 226453.5 | 12 | 225.280 | 27 | 225.480 | 0.107143 | 2,104.48 |
| 4 | 8 | 40 | 10920 | 323505.0 | 13 | 319.188 | 38 | 319.784 | 0.112857 | 2,238.49 |
| 5 | 8 | 52 | 14196 | 420556.5 | 13 | 417.792 | 50 | 417.976 | 0.178571 | 2,340.67 |
| 6 | 8 | 64 | 17472 | 517608.0 | 13 | 516.096 | 62 | 516.312 | 0.214286 | 2,409.46 |
| 7 | 8 | 76 | 20748 | 614659.5 | 14 | 622.592 | 74 | 622.760 | 0.250000 | 2,491.04 |
| 8 | 8 | 88 | 24024 | 711711.0 | 14 | 704.512 | 84 | 704.904 | 0.285714 | 2,467.16 |
| 9 | 8 | 100 | 27300 | 808762.5 | 14 | 802.816 | 96 | 803.304 | 0.321429 | 2,499.17 |
| 10 | 8 | 112 | 30576 | 905814.0 | 14 | 901.120 | 107 | 901.344 | 0.357143 | 2,523.76 |
| 11 | 8 | 124 | 33852 | 1002865.5 | 14 | 999.424 | 119 | 999.576 | 0.392857 | 2,544.38 |
| 12 | 8 | 136 | 37128 | 1099917.0 | 15 | 1,114,112 | 133 | 1,115,048 | 0.428571 | 2,601.78 |
| 13 | 8 | 148 | 40404 | 1196968.5 | 15 | 1,212,416 | 144 | 1,213,032 | 0.464286 | 2,612.68 |
| 14 | 8 | 160 | 43680 | 1294020.0 | 15 | 1,277,952 | 152 | 1,277,992 | 0.500000 | 2,555.98 |

[symbol]

indicates data missing or illegible when filed

The maximum data rate supported by the UE may be identified via Table 18, and the actual data rate following the allocated TBS may be identified via Table 16. In this case, the actual data rate may be larger than the maximum data rate depending on scheduling information.

In the wireless communication system, particularly, in the new radio (NR) system, a data rate supportable by a UE may be mutually agreed between a base station and the UE. This may be calculated using a maximum number of layers, a maximum modulation order, a maximum frequency band supported by the UE, etc. However, the calculated data rate may be different from a value calculated from a length of a transmission time interval (TTI) and a transport block size (TBS) of a transport block (TB) used for actual data transmission.

Accordingly, the UE may be allocated with a TBS greater than a value corresponding to the data rate supported by the UE, and in order to prevent this, there may be a limitation on the TBS that can be scheduled according to the data rate supported by the UE.

Since the UE is generally far from the base station, a signal transmitted from the UE is received by the base station after a propagation delay. The propagation delay is a value obtained by dividing a path, through which a radio wave is transmitted from the UE to the base station, by the speed of light, and may typically be a value obtained by dividing the distance between the UE and the base station by the speed of light. In an embodiment, if the UE is located 100 km away from the base station, a signal transmitted from the UE is received by the base station after about 0.34 msec. In contrast, a signal transmitted by the base station is also received by the UE after about 0.34 msec. As described above, an arrival time of a signal transmitted from the UE to the base station may vary depending on a distance between the UE and the base station. Therefore, when multiple UEs in different positions transmit signals simultaneously, times at which the signals arrive at the base station may differ from each other. In order to solve this problem so that the signals transmitted by the UEs arrive simultaneously at the base station, the UEs may transmit the uplink signals at different times according to the positions thereof. In the 5G, NR, and LTE systems, this is referred to as timing advance.

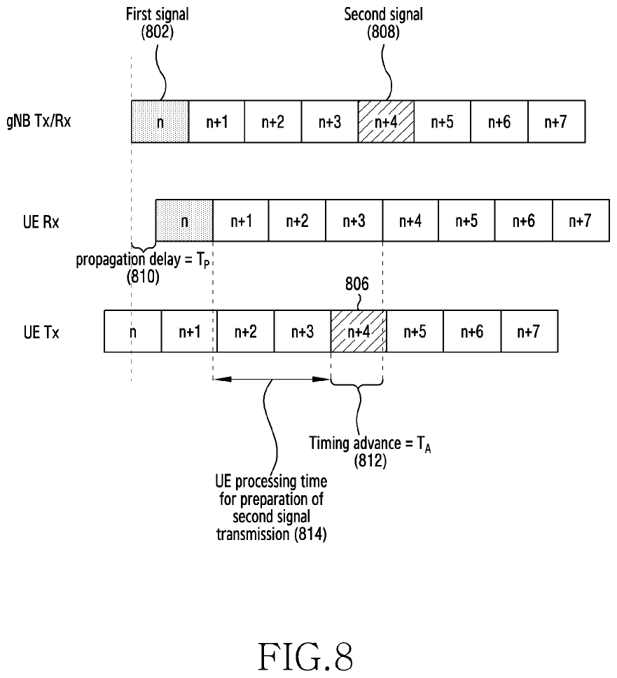

FIG. 8 is a diagram illustrating a processing time of a UE according to timing advance when the UE receives a first signal and transmits a second signal in response thereto in the 5G or NR system according to an embodiment of the disclosure.

When a base station transmits a first signal (an uplink scheduling grant (UL grant) or a downlink control signal and data (DL grant and DL data)) to the UE at slot n 802, the UE may receive the first signal at slot n 804. In this case, the UE may receive the signal after a propagation delay (Tₚ) 810 from a time at which the base station transmits the signal. According to an embodiment, when the UE receives the first signal in slot n 804, the UE transmits a corresponding second signal (HARQ-ACK/NACK for uplink data or downlink data) in slot n+4 806. Even when the UE transmits a signal to the base station, in order for the signal to arrive at the base station at a specific time, the UE may transmit the second signal at a timing 806 that is advanced by timing advance (TA) 812 from slot n+4 according to criteria of the received signal. Therefore, in the embodiment of the disclosure, the time 814 during which the UE may prepare to transmit uplink data after being granted with uplink scheduling or prepare to deliver HARQ ACK or NACK after receiving downlink data may be a time corresponding to 3 slots excluding TA.

In order to determine the timing described above, the base station may calculate an absolute value of the TA of the UE. When the UE initially accesses the base station, the base station may calculate the absolute value of TA while adding or subtracting variations in subsequent TA values delivered via higher-layer signaling to or from a TA value first delivered to the UE during random access. In the disclosure, the absolute value of the TA may be a value obtained by subtracting a start time of an n-th TTI received by the UE from a start time of an n-th TTI transmitted by the UE.

One of important criteria for performance of a cellular wireless communication system is packet data latency. To this end, in the LTE system, signal transmission and reception are performed in units of subframes which have a transmission time interval (TTI) of 1 ms. The LTE system operating as described above may support a UE (short-TTI UE) having a transmission time interval shorter than 1 ms. In the 5G or NR system, a TTI may be shorter than 1 ms. A short-TTI UE is suitable for a service, such as a voice over LTE (VOLTE) service and a remote-control service where a delay time (latency) is important. In addition, the short-TTI UE becomes a means capable of realizing mission-critical Internet of things (IoT) on a cellular basis.

In the 5G or NR system, when the base station transmits a PDSCH including downlink data, DCI for scheduling of the PDSCH may indicate a K1 value that is a value corresponding to timing information for the UE to transmit HARQ-ACK information of the PDSCH. When transmission with timing advance is not indicated to be performed before symbol L1, the HARQ-ACK information may be transmitted to the base station by the UE. That is, the HARQ-ACK information may be transmitted with timing advance from the UE to the base station at the same time point as symbol L1 or at a time point later than symbol L1. When the HARQ-ACK information is indicated to be transmitted with timing advance before symbol L1, the HARQ-ACK information may not be valid HARQ-ACK information in HARQ-ACK transmission from the UE to the base station.

Symbol L1 may be a first symbol at which a cyclic prefix (CP) starts after T_{proc,1} from the last time point of the PDSCH. T_{proc,1} may be calculated as shown in Equation 3 below.

$${T}_{proc , 1} = ( {N}_{1} + {d}_{1 , 1} ) ( 2048 + 144 ) \cdot k {2}^{- μ} \cdot {T}_{c} \qquad [ Equation 3 ]$$

In Equation 3 described above, N₁, d_{1,1}, d_{1,2}, k, μ, and T_{C} may be defined as follows.

When HARQ-ACK information is transmitted via an uplink control channel (PUCCH), d_{1,1}=0, and when HARQ-ACK information is transmitted via an uplink shared channel, data channel (PUSCH), d_{1,1}=1.

When the UE is configured with carriers or multiple activated configuration carriers, a maximum timing difference between carriers may be reflected in second signal transmission.

For PDSCH mapping type A, i.e., when a first DMRS OFDM symbol position is a third or fourth symbol in a slot, if position index i of the last symbol of the PDSCH is smaller than 7, d_{1,2}=7−i.

For PDSCH mapping type B, i.e., when the first DMRS symbol position is the first symbol of the PDSCH, d_{1,2}=3 if the PDSCH has a length of 4 symbols, and d_{1,2}=3+d if the PDSCH has a length of 2 symbols, where d is the number of symbols in which the PDSCH and the PDCCH including a control signal for scheduling of the PDSCH overlap.

N₁ is defined according to u as in Table 20 below. μ=0, 1, 2, and 3 refer to subcarrier spacings of 15 kHz, 30 kHz, 60 kHz, and 120 kHz, respectively.

TABLE 20

PDSCH decoding time N₁[symbols]

| | No additional PDSCH | Additional PDSCH |
|---|---|---|
| μ | DMRS configured | DMRS configured |
| 0 | 8 | 13 |
| 1 | 10 | 13 |
| 2 | 17 | 20 |
| 3 | 20 | 24 |

For the N₁ values provided in Table 20 above, different values may be used according to UE capability.

T_{c}=1/(Δfₘₐₓ·N_{f})Δfₘₐₓ=480·10³ Hz, N_{f}=4096, k=Tₛ/T_{c}=64, Tₛ=1/(Δf_{ref}·N_{f,ref}), Δf_{ref}=15·10³ Hz, and N_{f,ref}=2048 are defined respectively.

In the 5G or NR system, when the base station transmits control information including an uplink scheduling grant, the UE may indicate a K2 value corresponding to timing information for transmission of a PUSCH or uplink data.

When transmission with timing advance is not indicated to be performed before symbol L2, the PUSCH may be transmitted to the base station by the UE. That is, the PUSCH may be transmitted with timing advance from the UE to the base station at the same time point as symbol L2 or at a time point later than symbol L2. When the PUSCH is indicated to be transmitted with timing advance before symbol L2, the UE may disregard uplink scheduling grant control information from the base station.

Symbol L2 may be a first symbol at which a CP of a PUSCH symbol required be transmitted starts after T_{proc,2} from the last time point of the PDCCH including a scheduling grant. T_{proc,2} may be calculated as in Equation 4 below.

$${T}_{proc , 2} = max ( ( {N}_{2} + {d}_{2 , 1} ) ( 2048 + 144 ) \cdot k {2}^{- μ} \cdot {T}_{c} , {d}_{2 , 2} ) \qquad [ Equation 4 ]$$

In the aforementioned [Equation 4], N₂, d_{2,1}, k, μ, and T_{C} may be defined as follows.

If a first symbol among symbols allocated to the PUSCH includes only a DMRS, d_{2,1}=0, otherwise, d_{2,1}=1.

When the UE is configured with carriers or multiple activated configuration carriers, a maximum timing difference between carriers may be reflected in the second signal transmission.

N₂ is defined according to u as in Table 21 below. μ=0, 1, 2, and 3 refer to subcarrier spacings of 15 kHz, 30 kHz, 60 kHz, and 120 kHz, respectively.

TABLE 21

| μ | PUSCH preparation time (N₂ [symbols]) |
|---|---|
| 0 | 10 |
| 1 | 12 |
| 2 | 23 |
| 3 | 36 |

For N₂ values provided in Table 21 described above, different values may be used according to UE capability.

T_{c}=1/(Δfₘₐₓ·N_{f}), Δfₘₐₓ=480·10³ Hz, N_{f}=4096, k=Tₛ/T_{c}=64, Tₛ=1/(Δf_{ref}·N_{f,ref}), Δf_{ref}=15·10³ Hz, and N_{f,ref}=2048 are be defined, respectively.

The 5G or NR system may configure a frequency band part (BWP) within one carrier so as to designate a specific UE to perform transmission and reception within the configured BWP. This may be aimed at reducing power consumption of the UE. The base station may configure multiple BWPs and change an activated BWP in control information. A time available for the UE to change the BWPs may be defined as shown in Table 22 below.

TABLE 22

| Frequency Range | Scenario | Type 1 delay (μs) | Type 1 delay (μs) |
|---|---|---|---|
| 1 | 1 | 600 | 2000 |
| | 2 | 600 | 2000 |
| | 3 | 600 | 2000 |
| | 4 | 400 | 950 |
| 2 | 1 | 600 | 2000 |
| | 2 | 600 | 2000 |
| | 3 | 600 | 2000 |
| | 4 | 400 | 950 |

In Table 22, frequency range FR1 may indicate a frequency band equal to lower than 6 GHz, and frequency range FR2 may indicate a frequency band higher than or equal to 6 GHZ, and FR1 and FR2 may be distinguished as shown in Table 4 described above. In general, FR2 may refer a high-frequency band close to a mmWave band, and FR1 refers to a frequency band relatively lower than FR2. In the embodiment disclosed above, type 1 and type 2 may be determined according to UE capability. In the embodiment disclosed above, scenarios 1, 2, 3, and 4 are given as shown in Table 23 below.

TABLE 23

| | Change in center | No change in center |
|---|---|---|
| | frequency | frequency |
| Change in frequency | Scenario 3 | Scenario 2 |
| bandwidth | | |
| No change in frequency | Scenario 1 | Scenario 4 when |
| bandwidth | | subcarrier spacing |
| | | is changed |

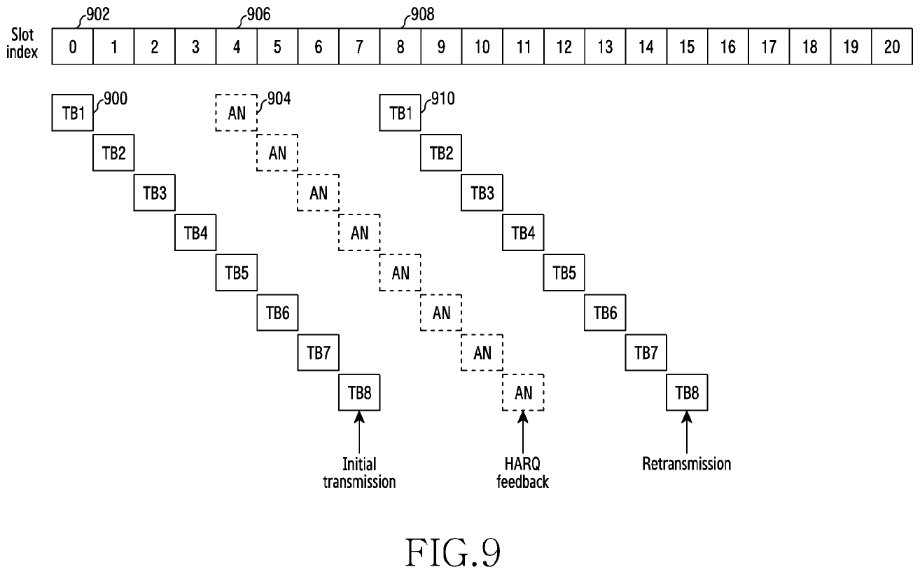

FIG. 9 is a diagram illustrating an example of scheduling and transmitting data (e.g., TB) according to a slot, receiving HARQ-ACK feedback for the data, and performing retransmission based on the feedback. In FIG. 9, TB1 900 is initially transmitted in slot 0 902, and ACK/NACK feedback 904 in response thereto is transmitted in slot 4 906. When the initial transmission of TB1 900 fails and NACK is received, retransmission 910 for TB1 may be performed in slot 8 908. A time point at which the ACK/NACK feedback is transmitted and a time point at which the retransmission is performed may be determined in advance, or may be determined according to control information and/or a value indicated via higher-layer signaling.

FIG. 9 illustrates an example of sequentially scheduling and transmitting TB1 to TB8 in slots starting from slot 0. This may be, for example, TB1 to TB8 may be assigned with HARQ process IDs 0 to 7 and then transmitted, respectively. If the number of HARQ process IDs available for the base station and the UE is only four, eight different TBs may not be continuously transmitted.

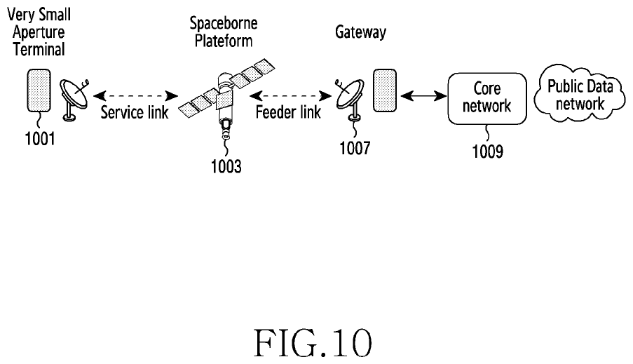

FIG. 10 is a diagram illustrating an example of a communication system using a satellite according to an embodiment of the disclosure. For example, when a UE 1001 transmits a signal to a satellite 1003 via a service link, the satellite 1003 may deliver the signal to a base station 1005 via a feeder link, the base station 1005 may process the received signal and transmit, to the UE 1001, a signal including a request for a subsequent operation therefor, and the signal including the request may be transmitted again via the satellite 1003. A distance between the UE 1001 and the satellite 1003 is long, and a distance between the satellite 1003 and the base station 1005 is also long, and therefore a time required for data transmission and reception from the UE 1001 to the base station 1005 may increase.

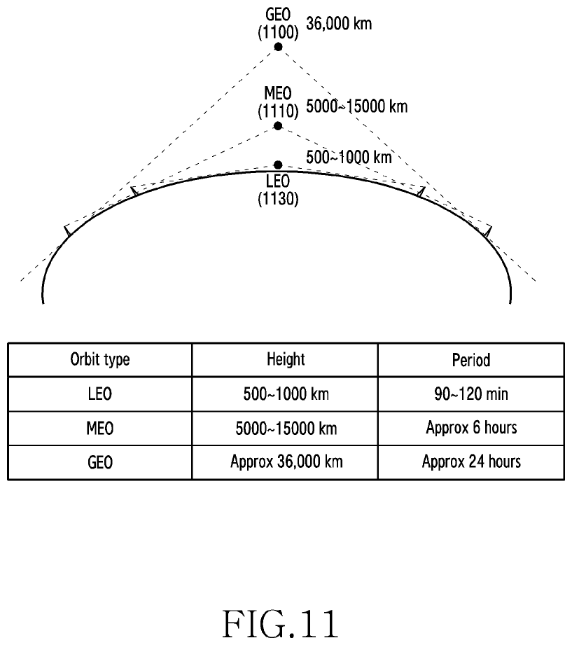

FIG. 11 is a diagram illustrating a revolution period of a communication satellite revolving around the earth in accordance with an altitude or a height of the satellite according to an embodiment of the disclosure. Satellites for communication may be divided into a low earth orbit (LEO), a middle earth orbit (MEO), a geostationary earth orbit (GEO), and the like according to orbits of the satellites. In general, a GEO satellite 1100 may refer to a satellite with an altitude of approximately 36,000 km, an MEO satellite 1110 may refer to a satellite with an altitude of 5,000 km to 15,000 km, and an LEO satellite may refer to a satellite with an altitude of 500 km to 1,000 km. Of course, the disclosure is not limited to the example above.

According to an embodiment of the disclosure, a revolution period around the earth varies according to each altitude, wherein the GEO satellite 1100 has a revolution period around the earth of approximately 24 hours, the MEO satellite 1110 has a revolution period around the earth of approximately 6 hours, and the LEO satellite 1130 has a revolution period around the earth of approximately 90 minutes to 120 minutes. The low-earth orbit (up to 2,000 km) satellite has a relatively low altitude and may have an advantage over the geostationary orbit (about 36,000 km) satellite in terms of a loss and a propagation delay (which may be understood as time it takes for a signal transmitted from a transmitter to reach a receiver).

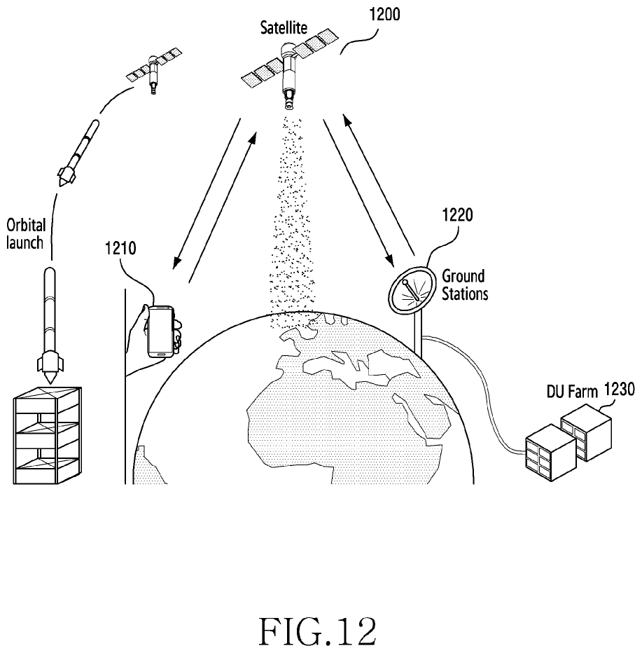

FIG. 12 is a diagram illustrating a conceptual diagram of satellite-UE direct communication according to an embodiment of the disclosure. A satellite 1200, which is located at an altitude of 100 km or higher by a rocket, transmits a signal to and receives a signal from a ground UE 1210, and also transmits a signal to and receives a signal from a ground station 1220 connected to a ground base station (DU farm) 1230.

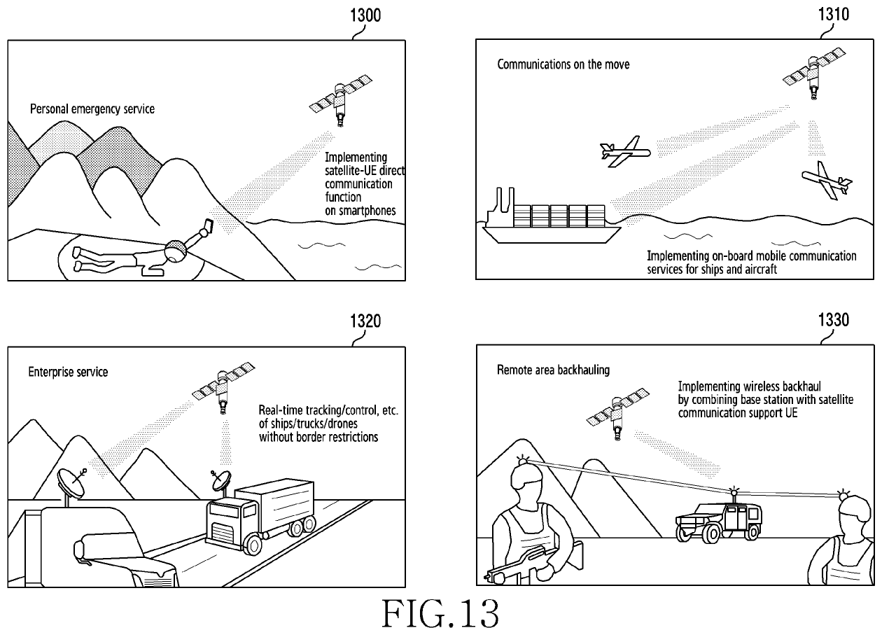

FIG. 13 is a diagram illustrating a utilization scenario of satellite-UE direct communication according to an embodiment of the disclosure. Direct satellite-UE communication is able to support a communication service with a specialized purpose, in a form of supplementing a coverage limit of a terrestrial network. For example, by implementing a satellite-UE direct communication function in a UE, it is possible to transmit and receive 1300 an emergency rescue of a user and/or a disaster signal at a place other than a terrestrial network coverage, a mobile communication service may be provided 1310 to the user at an area where terrestrial network communication is impossible, such as a ship and/or an air plane, tracking and controlling 1320 positions of a ship, a freight car, a drone, and/or the like in real time are possible without border restrictions, and by supporting a satellite communication function in a base station and enabling functioning as a backhaul of the base station, it is also possible to use satellite communication to perform 1330 a backhaul function when physically distant.

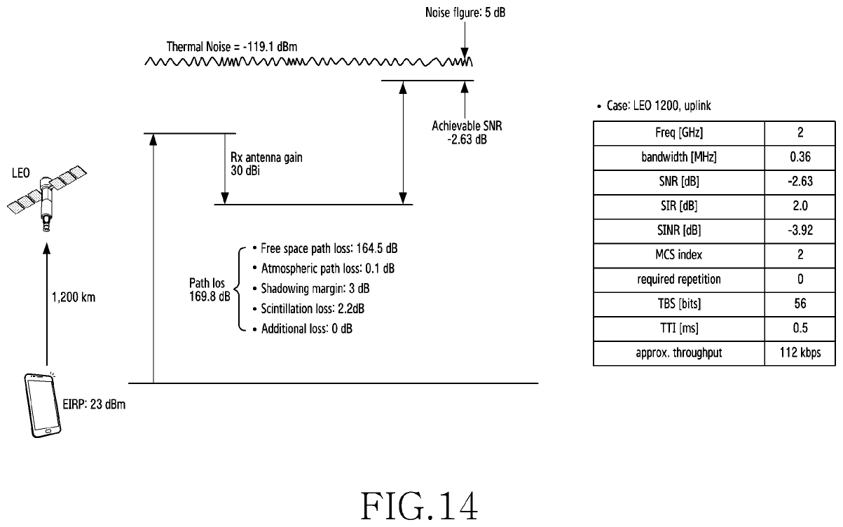

FIG. 14 is a diagram illustrating an example of calculating an expected data transmission rate (throughput) in an uplink when an LEO satellite at an altitude of 1200 km and a ground UE perform direct communication according to an embodiment of the disclosure. In an uplink, when transmission power (effective isotropic radiated power (EIRP)) of a ground UE in the uplink is 23 dBm, a path loss of a wireless channel to a satellite is 169.8 dB, and a satellite reception antenna gain is 30 dBi, an achievable signal-to-noise ratio (SNR) is estimated to be −2.63 dB. In this case, the path loss may include a path loss in the space, a path loss in the atmosphere, and the like. When it is assumed that a signal-to-interference ratio (SIR) is 2 dB, a signal-to-interference and noise ratio (SINR) is calculated to be −3.92 dB, in which case, if a subcarrier spacing of 30 kHz and a frequency resource of one PRB are used, it may be possible to achieve a data rate of 112 kbps.

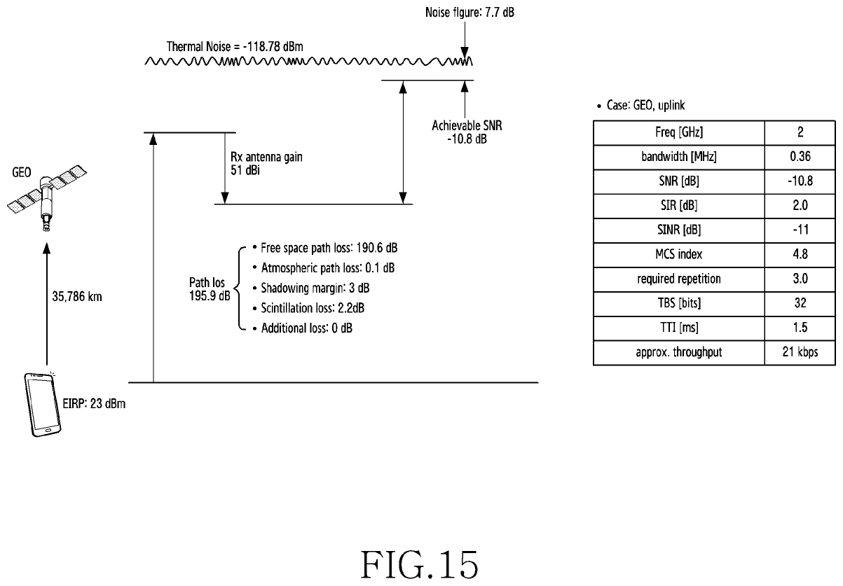

FIG. 15 is a diagram illustrating an example of calculating an expected data transmission rate (throughput) in an uplink when a GEO satellite at an altitude of 35,786 km and a ground UE perform direct communication according to an embodiment of the disclosure. In an uplink, when transmission power (EIRP) of a ground UE in the uplink is 23 dBm, a path loss of a wireless channel to a satellite is 195.9 dB, and a satellite reception antenna gain is 51 dBi, an achievable signal-to-noise ratio (SNR) is estimated to be −10.8 dB. In this case, the path loss may include a path loss in the space, a path loss in the atmosphere, and the like. When it is assumed that an SIR is 2 dB, an SINR is calculated to be −11 dB, in which case, a transmission rate of 21 kbps may be achievable when a subcarrier spacing of 30 kHz and a frequency resource of 1 PRB are used, and these may be a result of 3 times of repeated transmission.

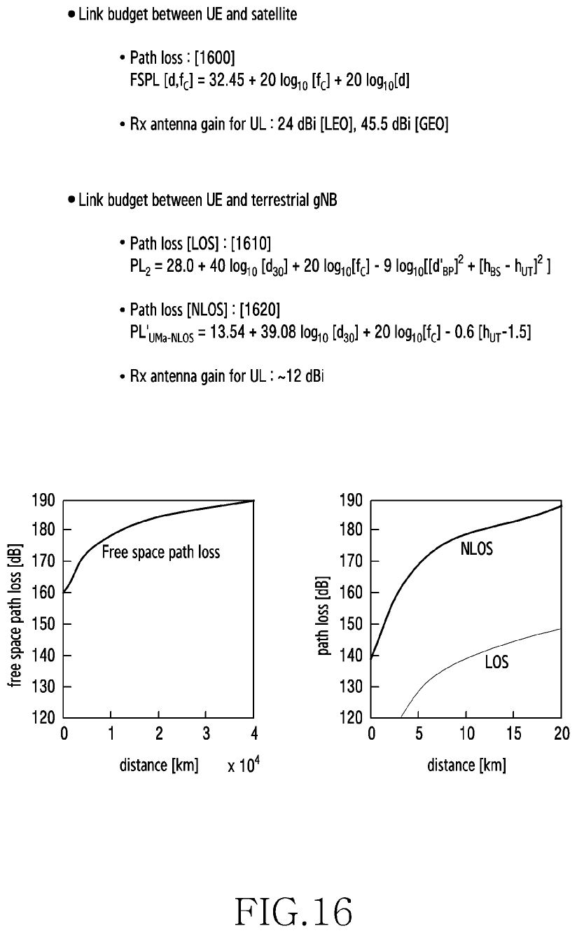

FIG. 16 is a diagram illustrating a path loss value based on a path loss model between a UE and a satellite, and a path loss based on a path loss model between a UE and a terrestrial network communication base station according to an embodiment of the disclosure. In FIG. 16, d denotes a distance and fc denotes a frequency of a signal. A path loss (free space propagation loss (FSPL)) 1600 in a free space in which communication between a UE and a satellite is performed is inversely proportional to the square of the distance, but path losses (PL2 and PL′Uma-NLOS) 1610 and 1620 on the ground on which air exists and communication between the UE and a terrestrial network communication base station (terrestrial gNB) is performed may be inversely proportional to almost 4th power of the distance. d3D denotes a straight-line distance between the UE and the base station, hBS denotes a height of the base station, and hUT denotes a height of the UE. d′BP=4*hBS*hUT*fc/c is calculated. fc denotes a central frequency in units of Hz and c denotes a speed of light in units of m/s.

In satellite communication (or non-terrestrial network (NTN)), Doppler shift, i.e., frequency movement (offset) of a transmission signal, occurs due to continuous fast movement of the satellite.

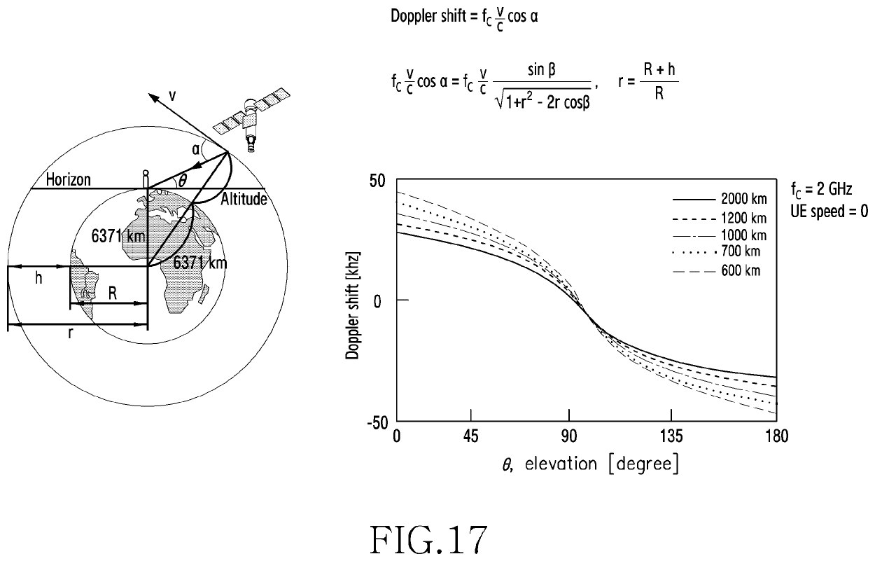

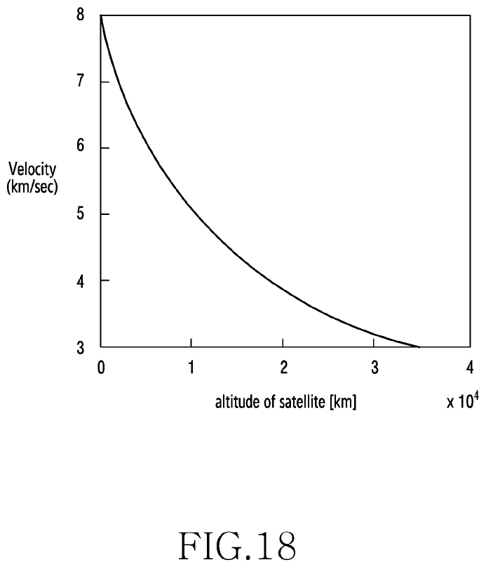

FIG. 17 is a diagram illustrating an equation for calculating, based on an altitude and a position of a satellite and a position of a UE user on the ground, an amount of Doppler shift that a signal delivered from the satellite experiences when the signal is received by the user on the ground, and a result of the calculation according to an embodiment of the disclosure. R denotes an earth radius, h denotes an altitude of a satellite, v denotes a speed at which the satellite revolves around the earth, and fc denotes a frequency of a signal. The speed of the satellite may be calculated from the altitude of the satellite, which corresponds to a speed at which the gravity that is the force of the earth pulling the satellite is the same as the centripetal force generated according to the revolution of the satellite, and may be calculated as shown in FIG. 18. FIG. 18 is a diagram illustrating a speed of a satellite calculated at an altitude of the satellite. As identified in FIG. 17, an angle α is determined by an elevation angle θ, and thus a value of Doppler shift is determined according to the elevation angle θ.

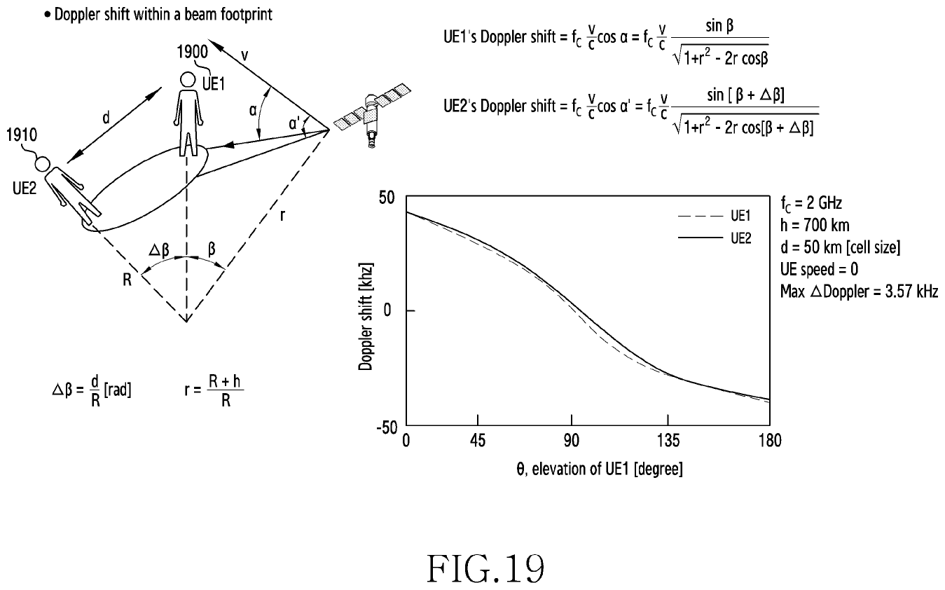

FIG. 19 is a diagram illustrating Doppler shifts experienced by different UEs within a single beam transmitted to the ground by a satellite, according to an embodiment of the disclosure. In FIG. 19, Doppler shifts experienced by UE 1 1900 and UE 2 1910 according to an elevation angle θ are calculated, respectively. The Doppler shifts are results of an assumption that a center frequency is 2 GHz, a satellite altitude is 700 km, a diameter of one beam is 50 km on the ground, and a speed of a UE is 0. In addition, the Doppler shifts calculated in the disclosure ignore effects of the rotation speed of the earth, which are considered to be small, and this is because the rotation speed of the earth is slow compared to the speed of the satellite.

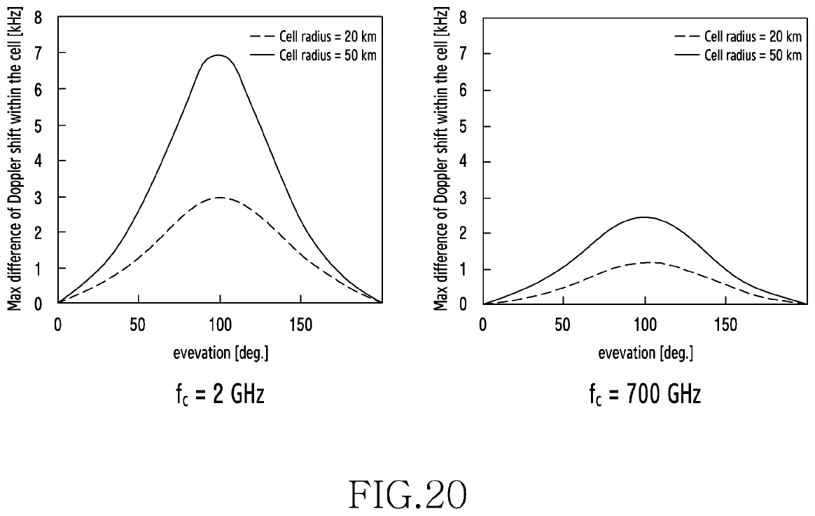

FIG. 20 is a diagram illustrating a difference in Doppler shifts occurring within a single beam according to a satellite position determined from an elevation angle, according to an embodiment of the disclosure. When a satellite is located directly above a beam, that is, when an elevation angle is 90 degrees, it may be identified that a difference in Doppler shifts within the beam (or cell) is the greatest. This may be because, when the satellite is above the center, Doppler shift values at one end of the beam and at the other end of the beam have positive and negative values, respectively.

In a satellite communication, a satellite is far from a user on the ground, so that a large delay occurs compared to terrestrial network communication.

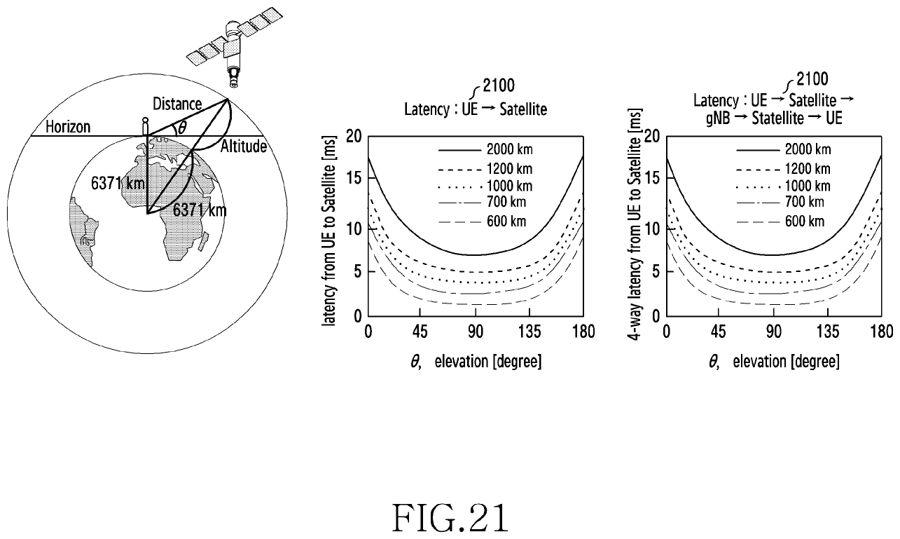

FIG. 21 is a diagram illustrating a round-trip delay between a UE, a satellite, and a base station, and a delay from the UE to the satellite according to a satellite position determined based on an elevation angle, according to an embodiment of the disclosure. A first graph 2100 illustrates a delay from a UE to a satellite, and a second graph 2110 illustrates a round-trip delay between the UE, the satellite, and a base station. In this case, it has been assumed that a delay between the satellite and the base station is equal to the delay between the UE and the satellite.

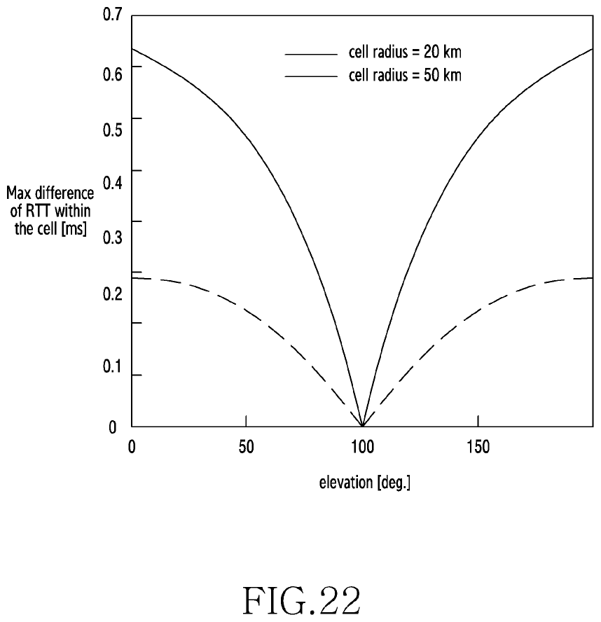

FIG. 22 is a diagram illustrating a maximum difference value of a round-trip delay that varies depending on a user position within a single beam according to an embodiment of the disclosure. For example, if a beam radius (or a cell radius) is 20 km, it may be considered that a difference in round-trip delays to a satellite, which UEs at different positions within a beam differently experience, may be equal to or less than about 0.28 ms.

In satellite communication, a UE transmitting and receiving a signal to and from a base station may indicate that the signal is delivered via a satellite. That is, the satellite may serve to receive a signal having been transmitted by the base station to the satellite, and then deliver the signal to the UE in a downlink, and may serve to receive a signal having been transmitted by the UE to the satellite, and then deliver the signal to the base station in an uplink. The satellite may receive the signal and then deliver the signal after performing only frequency shift, or may perform signal processing, such as decoding and re-encoding, etc., based on the received signal and then deliver the signal.

For LTE or NR, the UE may access the base station according to the following procedure.
Operation 1: The UE receives a synchronization signal (or synchronization signal block (SSB) which may include a broadcast signal) from the base station. The synchronization signal may include a PSS, an SSS, and a PBCH. The synchronization signal may include information, such as a slot boundary of a signal transmitted by the base station, a frame number, downlink and uplink configurations, and the like. In addition, the UE may acquire a subcarrier offset, scheduling information for transmission of system information, etc. via the synchronization signal.
Operation 2: The UE receives system information (system information block (SIB)) from the base station. The SIB may include information for performing initial access and random access. The information for performing random access may include resource information for transmission of a random-access preamble.
Operation 3: The random-access preamble (or message 1 (msg1)) is transmitted on a random-access resource configured in operation 2. The preamble may be a signal determined based on the information configured in operation 2 by using a predetermined sequence. The base station receives the preamble transmitted by the UE. The base station attempts to receive the preamble configured in the resource configured by the base station itself without knowing which UE has transmitted the preamble, and when the reception is successful, the base station may identify that at least one UE has transmitted the preamble.
Operation 4: When the preamble is received in operation 3, the base station transmits a random-access response (RAR) (or a message 2 (msg2)) in response to the preamble. The UE which has transmitted the random-access preamble in operation 3 may attempt to receive the RAR transmitted by the base station in operation 4. The RAR is transmitted on a PDSCH, and a PDCCH for scheduling of the PDSCH is transmitted together or in advance. A CRC scrambled by an RA-RNTI value is added to DCI for scheduling of the RAR, and the DCI (and CRC) is channel-coded and then mapped to the PDCCH and transmitted. The RA-RNTI may be determined based on time and frequency resources via which the preamble in operation 3 is transmitted.

A maximum time limit until the UE which has transmitted the random-access preamble in operation 3 receives the RAR in operation 4 may be configured in the SIB transmitted in operation 2. The maximum limit time may be configured limitedly, for example, up to 10 ms, 40 ms, or the like. That is, when the UE having transmitted the preamble in operation 3 does not receive the RAR within a time determined based on, for example, the configured maximum time limit of 10 ms, the UE may transmit the preamble again. The RAR may include scheduling information for allocation of a resource for a signal to be transmitted by the UE in subsequent operation 5.

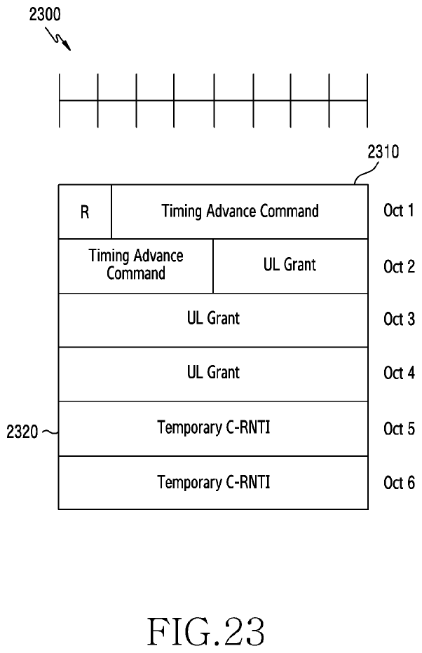

FIG. 23 is a diagram illustrating an example of an information structure (a MAC payload) of an RAR according to an embodiment of the disclosure. This may be a MAC payload format (fallback RAR) of Msg B. An RAR 2300 may be, for example, a MAC PDU, and may include information 2310 on timing advance (TA) to be applied by a UE and a temporary C-RNTI value 2320 to be used in the following operation.
R field: Reserved bit which may be configured to be, for example, “0.”
Timing advance command field 2310: Indicating an index value TA used to control an amount of timing adjustment which should be applied by a MAC entity. A size of the timing advance command field is, for example, 12 bits.
UL grant field: Indicating resources to be used in an uplink, wherein a size of the UL grant field is, for example, 27 bits.
Temporary C-RNTI field 2320: A temporary C-RNTI field indicates a temporary identifier used by the MAC entity during random access, and a size of the temporary C-RNTI field is, for example, 16 bits.
Operation 5: The UE having received the RAR in operation 4 transmits message 3 (msg3) to the base station according to the scheduling information included in the RAR. The UE may transmit msg3 by including a unique ID value of the UE in msg3. The base station may attempt to receive msg3 according to the scheduling information transmitted by the base station in operation 4.
Operation 6: The base station receives msg3, identifies ID information of the UE, generates message 4 (msg4) including the ID information of the UE, and transmits msg4 to the UE. The UE having transmitted msg3 in operation 5 may then attempt to receive msg4 that is to be transmitted in operation 6. The UE having received msg4 may, after decoding, compare the ID value included in msg4 with the ID value transmitted by the UE itself in operation 5 so as to identify whether the base station has received msg3 transmitted by the UE. There may also be a time limit from a time at which the UE transmits msg3 in operation 5 to a time at which the UE receives msg4 in operation 6, and a maximum time may also be configured from the SIB in operation 2.

When initial access using the aforementioned operations is applied to satellite communication, a propagation delay in the satellite communication may cause a problem. For example, an interval (random-access window) from transmission of the random-access preamble (or PRACH preamble) by the UE in operation 3 to reception of the RAR in operation 4, that is, a maximum time it takes to the reception may be configured via ra-Response Window, and the maximum time in the conventional LTE or 5G NR system may be configured up to about 10 ms.

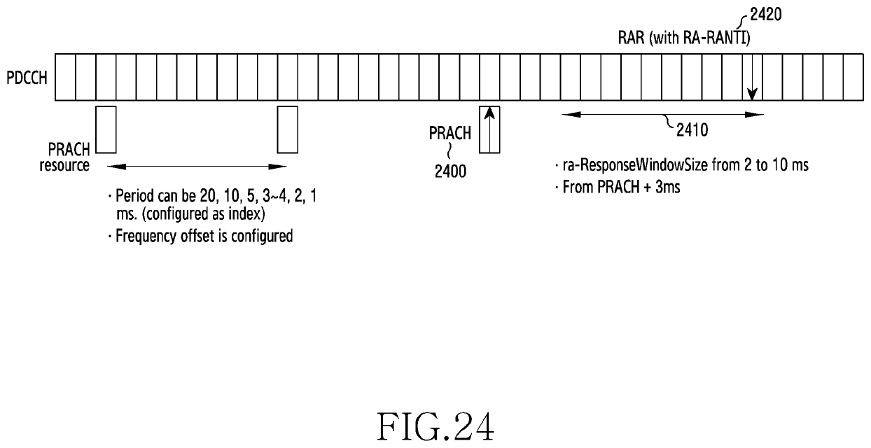

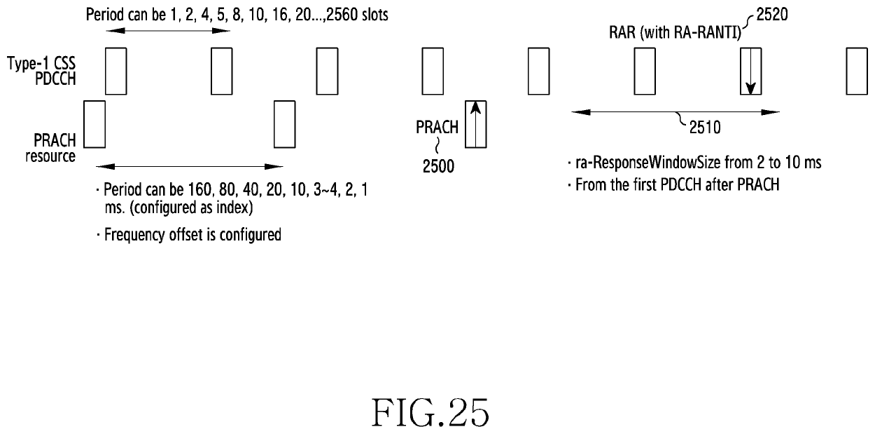

FIG. 24 is a diagram illustrating an example of a relationship between a PRACH preamble configuration resource and an RAR reception time point in the LTE system according to an embodiment of the disclosure, and FIG. 25 is a diagram illustrating an example of a relationship between a PRACH preamble configuration resource and an RAR reception time point in the 5G NR system according to an embodiment of the disclosure. Referring to FIG. 24, for LTE, a random-access window 2410 starts 3 ms after the PRACH (random-access preamble) is transmitted 2400. When a UE receives a RAR within the random-access window 2420, it may be determined that transmission of a PRACH preamble is successful. Referring to FIG. 25, for NR, a random-access window 2510 starts from a control information area for RAR scheduling that appears first after a PRACH (random-access preamble) is transmitted 2500. When a UE receives 2520 an RAR within the random-access window, it may be determined that PRACH preamble transmission has been successful.

As an example, a TA for uplink transmission timing in the 5G NR system may be determined as follows. First, T_{c}=1/(Δfₘₐₓ*N_{f}) is determined, where Δfₘₐₓ=480*10³ Hz and N_{f}=4096. In addition, k=Tₛ/T_{c}=64, and Tₛ=1/(Δf_{ref}*N_{f,ref}), Ts=1/(Δf_{ref}*N_{f,ref}), Δf_{ref}=15*10³ Hz, and N_{f,ref}=2048 may be determined, respectively.

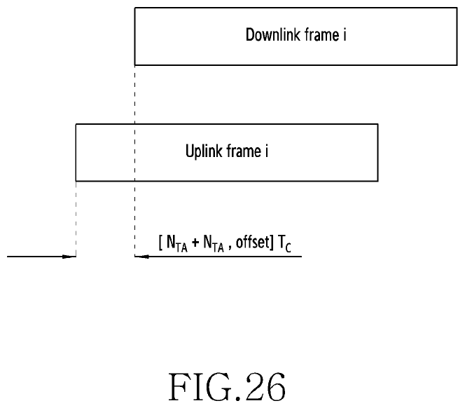

FIG. 26 is a diagram illustrating an example of downlink frame and uplink frame timings for a UE according to an embodiment of the disclosure. A UE may advance an uplink frame by T_{TA}=(N_{TA}+N_{TA,offset}) T_{C}, based on a downlink frame time point, so as to perform uplink transmission. Here, a value of N_{TA} may be delivered via an RAR or may be determined based on a MAC CE, and N_{TA,offset} may be a value configured for the UE or determined based on a predetermined value.

An RAR of the 5G NR system may indicate TA, in which case, TA may indicate one value among 0, 1, 2, . . . , 3846. In this case, when a subcarrier spacing (SCS) of the RAR is 24*15 kHz, N_{TA} may be determined as N_{TA}=TA*16*64/2^{μ}. After the UE completes the random access, the UE may be indicated with a change value of TA from the base station, and the indication may be performed via a MAC CE or the like. T_{A} information indicated via the MAC CE may indicate one value among 0, 1, 2, . . . , 63, which may be used to calculate a new TA value via addition to or subtraction from the existing TA value, and a result TA value may be newly calculated as N_{TA_new}=T_{A_old}+(T_{A}−31)*16*64/2^{μ}. The indicated TA value may be applied to uplink transmission by the UE after a predetermined time.

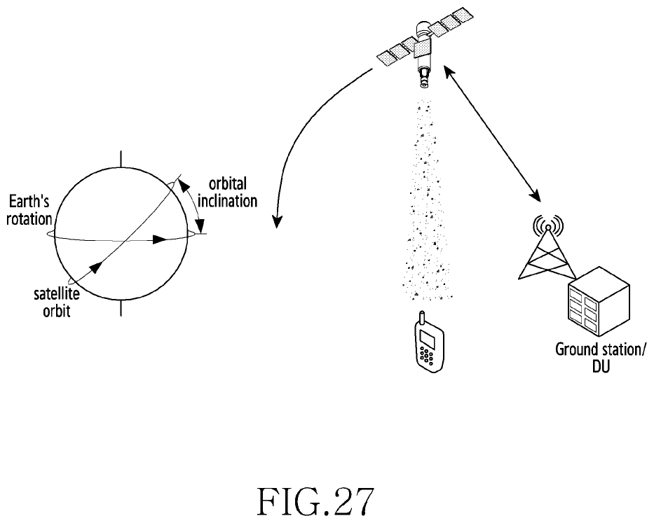

FIG. 27 is a diagram illustrating an example of continuous movement of a satellite with respect to a UE located on the ground or on the earth as the satellite revolves around the earth according to an embodiment of the disclosure. Because a distance between a UE and a satellite changes according to an elevation angle at which the UE faces the satellite, a propagation delay between the UE, the satellite, and a base station changes.

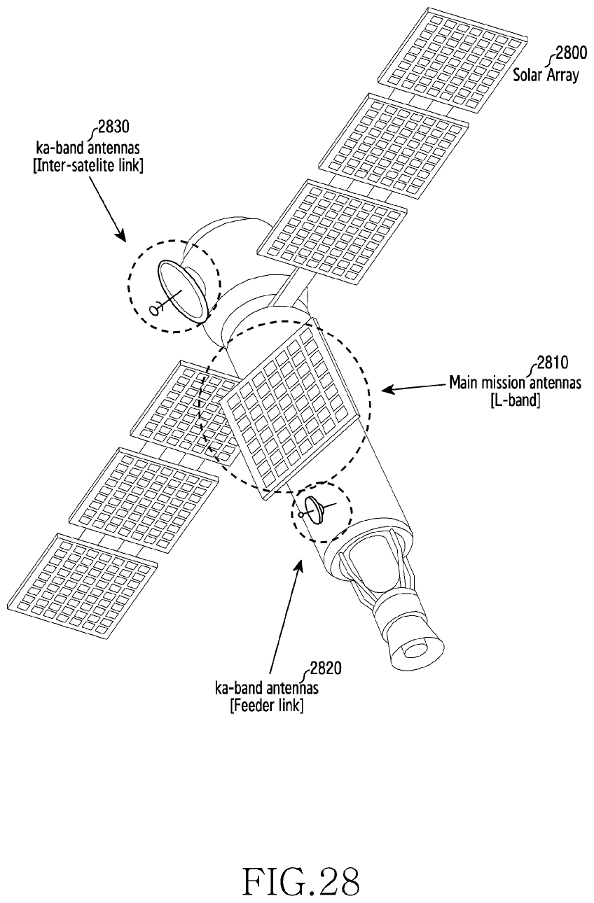

FIG. 28 is a diagram illustrating an example of a structure of a satellite according to an embodiment of the disclosure. A satellite may include a solar panel or a solar array 2800 for photovoltaic or solar power generation, a transmission and reception antenna (main mission antenna) 2810 for communication with a UE, a transmission and reception antenna (feeder link antenna) 2820 for communication with a ground station, a transmission and reception antenna (inter-satellite link) 2830 for communication between satellites, a processor for controlling transmission and reception and processing a signal, and the like. Of course, the disclosure is not limited to the description above, and the satellite may include more or fewer elements than the elements illustrated in FIG. 28. In addition, according to an embodiment of the disclosure, when communication between satellites is not supported depending on the satellite, the antenna for signal transmission and reception between satellites may not be placed. Although FIG. 28 illustrates that an L band of 1 to 2 GHz is used for communication with the UE, a K band (18 to 26.5 GHZ), a Ka band (26.5 to 40 GHz), and a Ku band (12 to 18 GHz) which correspond to high-frequency bands may be used.

In addition, in various embodiments of the disclosure, the term “base station (BS)” may refer to any component (or a set of components) configured to provide wireless access, such as a transmission point (TP), a transmission-reception point (TRP), an enhanced node B (eNodeB or eNB), a 5G base station (gNB), a macrocell, a femtocell, a Wi-Fi access point (AP), or other wireless-enabled devices, based on a type of the wireless communication system. Base stations may provide wireless access according to one or more radio protocols, for example, 5G 3GPP new radio interface/access (i.e., NR), LTE, LTE-A, high-speed packet access (HSPA), Wi-Fi 802.11a/b/g/n/ac, or the like.

In addition, in various embodiments of the disclosure, the term “user equipment (UE)” may refer to any component, such as “terminal,” “mobile station,” “subscriber station,” “remote terminal,” “wireless terminal,” “reception point,” or “user device”. For convenience, in the various embodiments of the disclosure, the term “UE” is used to refer to a device that accesses a base station regardless of whether a UE needs to be considered as a mobile device (such as a mobile phone or a smartphone) or a stationary device (such as a desktop computer or vending machine).

In addition, in various embodiments of the disclosure, the term “TA” may be used interchangeably with “TA information”, “TA value”, or “TA index”.

In various embodiments of the disclosure, data or control information that the base station transmits to the UE may be referred to as a first signal, and an uplink signal associated with the first signal may be referred to as a second signal. For example, the first signal may include DCI, a UL grant, a PDCCH, a PDSCH, an RAR, and the like, and the second signal associated with the first signal may include a PUCCH, a PUSCH, msg3, and the like.

In addition, there may be association between the first signal and the second signal. For example, when the first signal is a PDCCH including a UL grant for uplink data scheduling, the second signal corresponding to the first signal may be a PUSCH including uplink data. A difference (gap) between time points at which the first signal and the second signal are transmitted and received may be a predetermined value between the UE and the base station. Alternatively, a gap between time points at which the first signal and the second signal are transmitted and received may be determined by an indication of the base station or determined by a value delivered via higher-layer signaling.

In UE-satellite direct communication, a distance between a UE and a satellite and a distance between the satellite and a base station are long, and the satellite continuously moves, so that, when the UE or the base station receives a signal transmitted by the base station or the UE, a time offset may be generated due to a delay, etc. Therefore, the disclosure provides a method and a device in which, in order to compensate for a time offset, the base station indicates time offset information and the UE compensates for the time offset according to the time offset information. In the following embodiment, descriptions are provided by assuming communication between the UE, the satellite, and the ground station, but a case where the satellite base station and the UE communicate with each other is not excluded. In the disclosure, the time offset may be used interchangeably with timing advance. The method and device provided in various embodiments of the disclosure are applicable not only to satellite communication systems but also to terrestrial communication systems. In addition, the embodiments below may be operated in combination with each other.

### First Embodiment

The first embodiment of the disclosure describes a method and a device in which, when a UE transmits an uplink signal to a satellite or a base station, the UE directly determines (e.g., calculates) a TA value and applies the determined TA value. In addition, the first embodiment of the disclosure describes a method and a device in which, when the UE transmits an uplink signal to the satellite or the base station, the base station or the satellite indicates, to the UE, a TA value to be applied, and the UE applies the indicated TA value to transmit the uplink signal. In addition, the first embodiment of the disclosure describes a method and a device in which, when the UE transmits an uplink signal to the satellite or the base station, the UE adaptively determines a TA value to be applied. More specifically, the first embodiment of the disclosure describes a method by which the UE determines a TA value by itself, and a method and a device in which the base station or the satellite indicates a TA value to the UE as described above and the UE adaptively selects one of the methods of applying the indicated TA value, so as to determine the TA value.

First, the UE may compare an uplink transmission time point with a downlink reception time point for uplink synchronization, and advance the uplink transmission time point by TTA from the downlink reception time point, based on a comparison result. TTA calculated for TA for satellite communication may be expressed as shown in Equation 5 below.

$${T}_{TA} = ( {N}_{TA} + {N}_{TA , UE - specific} + {N}_{TA , common} + {N}_{TA , offset} ) * {T}_{c} \qquad [ Equation 5 ]$$

In Equation 5, T_{c} may be given as T_{c}=1/(Δfₘₐₓ*N_{f}), where Δfₘₐₓ=480*10³ Hz and N_{f}=4096. In Equation 5, N_{TA} may be a value determined based on a TA value, etc. included in an RAR or a MAC CE received from the base station, and N_{TA,offset} may be a pre-fixed or pre-agreed value. In Equation 5, N_{TA,UE-specific} may be a TA compensation value measured by the UE, based on positions of the UE itself and the satellite (or reference position), and N_{TA,common} may be a TA compensation value configured or indicated using higher signaling or a physical layer signal.

Equation 5 may be an equation to which parameters N_{TA,UE-specific} and N_{TA,common} are added compared to Equation 6 below that is a conventional TA application method.

$${T}_{TA} = ( {N}_{TA} + {N}_{TA , offset} ) * {T}_{c} \qquad [ Equation 6 ]$$

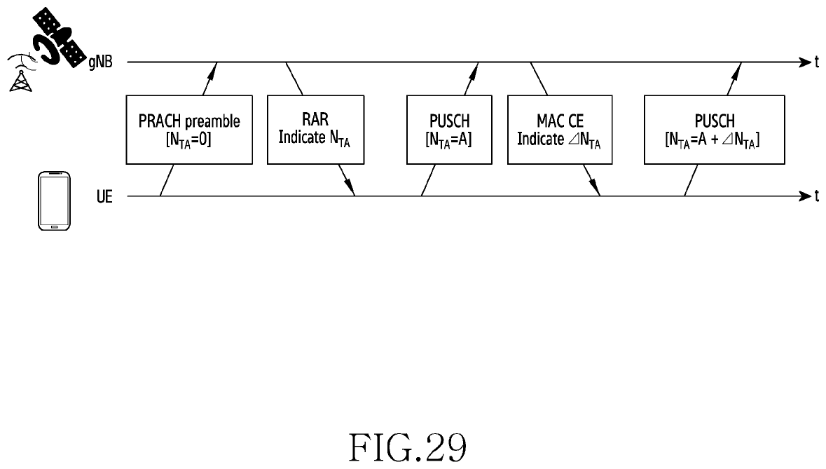

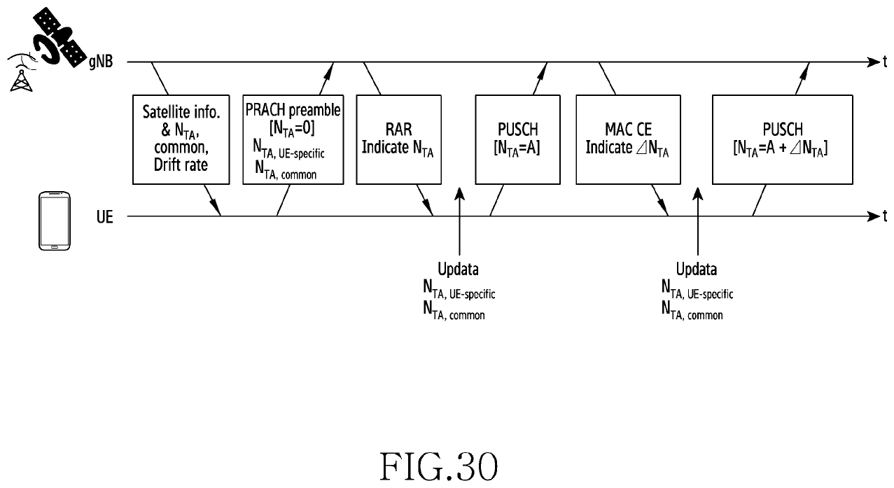

FIG. 29 is a diagram illustrating an example of a procedure in which a UE determines N_{TA} from initial access according to an embodiment of the disclosure. FIG. 30 is a diagram illustrating an example of a procedure in which a UE determines N_{TA}, N_{TA,UE-specific}, and N_{TA,common} from initial access according to an embodiment of the disclosure. Referring to FIG. 29, a UE transmits a PRACH preamble to a base station by applying N_{TA}=0, and the base station transmits an RAR indicating N_{TA} to the UE. Then, the UE transmits a PUSCH by applying N_{TA}=A, and the base station transmits a MAC CE indicating ΔN_{TA} to the UE. After that, the UE may transmit the PUSCH by applying N_{TA}=A+ΔN_{TA}.

Referring to FIG. 30, the base station transmits configuration information including a drift rate, N_{TA,common}, and satellite information to the UE. Then, the UE assumes N_{TA}=0 and transmits the PRACH preamble to the base station by applying N_{TA,UE-specific} measured by the UE itself and configured N_{TA,common}. Then, the base station may transmit the RAR indicating N_{TA} to the UE, and N_{TA,UE-specific} and N_{TA,common} may be updated. Then, the UE assumes N_{TA}=A and transmits the PUSCH according to T_{TA} calculated based on Equation 5, and the base station may transmit, to the UE, the MAC CE indicating ΔN_{TA}. Then, N_{TA}. UE-specific and N_{TA,common} may be updated, and the UE may apply N_{TA}=A+ΔN_{TA} and transmit the PUSCH according to T_{TA} calculated based on Equation 5 by applying updated N_{TA}. UE-specific and N_{TA, common}.

T_{TA} may be determined as N_{TA}=T_{A}*16*64/2^{μ}, based on T_{A}=0, 1, 2, . . . , 3846, which is transmitted on the RAR or msgB. In addition, T_{A}=0, 1, 2, . . . , 63 may be delivered via the MAC CE and may be updated to N_{TA_new}=T_{A_old}+(T_{A}−31)*16*64/2^{μ}. In addition, Δfₘₐₓ*N_{f}, T_{A} transmitted via the RAR or msgB, the T_{A} value transmitted via the MAC CE, and the like may be changed according to a communication system. In addition, when the UE performs TA updating like N_{TA_new}=T_{A_old}+(TA−M)*16*64/2^{μ}, based on T_{A} transmitted from the MAC CE, an M value may be a value larger than or equal to 31 if a maximum value of T_{A} is larger than 63, and the M value may be a value equal to or smaller than 31 if the maximum value of T_{A} is smaller than 63, and based on this, the UE may determine N_{TA_new} that is an updated N_{TA} value.

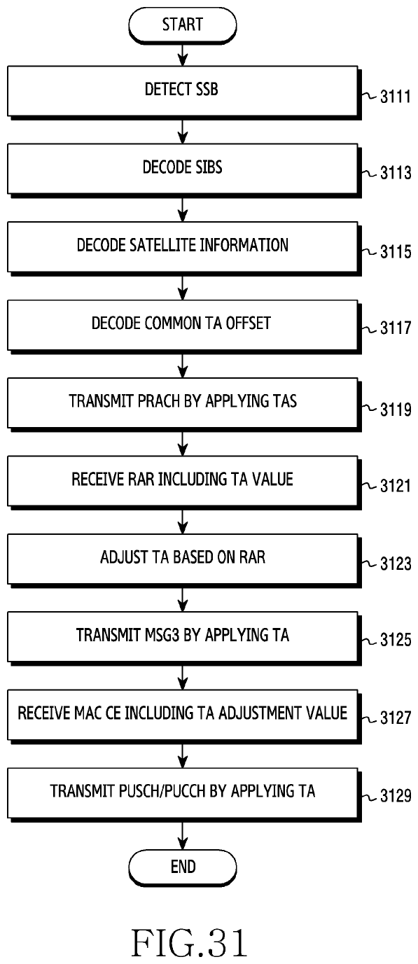

FIG. 31 is a diagram schematically illustrating another example of a UE operation procedure in the communication system according to an embodiment of the disclosure.

A UE may, according to a procedure to be described with reference to FIG. 31, perform initial access and determine TA after performing the initial access, and this will be described in detail below.

First, in operation 3111, a UE may detect a synchronization signal and PBCH block (SSB) received from a base station. In operation 3113, the UE may decode system information blocks (SIBs), based on the detected SSB. The UE may detect information on random-access channel (RACH) resources by decoding the SIBs.

In operation 3115, the UE may acquire (or decode) satellite information by decoding the SIBs. According to an embodiment of the disclosure, the satellite information may include at least one of various parameters, such as position information of a satellite. In operation 3115, the UE may acquire a UE-specific TA compensation value, for example, N_{TA,UE-specific}, based on the positions (or reference position) of the UE and the satellite, based on the acquired position information. In operation 3117, the UE may acquire (or decode) a common TA offset, for example, N_{TA,common}, by decoding the SIBs.

In operation 3119, the UE may calculate TAs based on N_{TA,UE-specific} and N_{TA,common} and transmit a PRACH to the base station by applying the calculated TAs. In operation 3121, the UE may receive an RAR including a TA value in response to transmission of the PRACH. In operation 3123, the UE may adjust TA, based on the received RAR.

In operation 3125, the UE transmits msg3 to the base station by applying TA. msg3 is a part of a random-access procedure, and may indicate a message which includes a C-RNTI MAC CE or a common control channel (CCCH) SDU and is transmitted in an uplink shared channel (UL-SCH), and may be first scheduled transmission of the random-access procedure. In operation 3127, the UE may receive a MAC CE including an TA adjustment value from the base station. In operation 3129, the UE may apply TA, based on the TA adjustment value included in the MAC CE, and transmit a PUSCH/PUCCH.

When compared with an operation procedure of a UE in another embodiment of the disclosure, the operation procedure of the UE as described with reference to FIG. 31, that is, a procedure of performing initial access and determining TA after performing the initial access, may be summarized as shown in Table 24 below.

TABLE 24

| | UE operation procedure |
|---|---|
| UE operation procedure | based on FIG. 31 |
| 1. Detect SSB2. Decode SIBs | 1. Detect SSB |
| (RACH resource information | 2. Decode SIBs (RACH resource |
| detection) | information detection) |
| 3. Transmit PRACH | 3. Decode satellite information |
| 4. Receive RAR including | (position information, etc.), and |
| TA value | acquire N_{TA, UE-specific} |
| 5. Adjust TA based on RAR | 4. Decode common TA offset, and |
| 6. Transmit msg3 by applying TA | acquire N_{TA, common} |
| 7. Receive MAC CE including | 5. Transmit PRACH by applying TAs |
| TA adjustment value | 6. Receive RAR including TA value |
| 8. Based on TA adjustment | 7. Adjust TA based on RAR |
| value, transmit PUSCH/PUCCH | 8. Transmit msg3 by applying TA |
| by applying TA | 9. Receive MAC CE including TA |
| | adjustment value |
| | 10. Transmit PUSCH/PUCCH by |
| | applying TA |

In addition, the order of some operations in the operation procedure of the UE described with reference to FIG. 31 may be changed, and for example, the order of decoding the satellite information and decoding the common TA offset may be changed.

Although the operation procedure of the UE in the communication system according to various embodiments of the disclosure has been described with reference to FIG. 31, various modifications may also be made with respect to FIG. 31. For example, consecutive operations are illustrated in FIG. 31, but the operations described in FIG. 31 may overlap each other and may occur in parallel or occur in a different order, or one or more operations may occur multiple times.

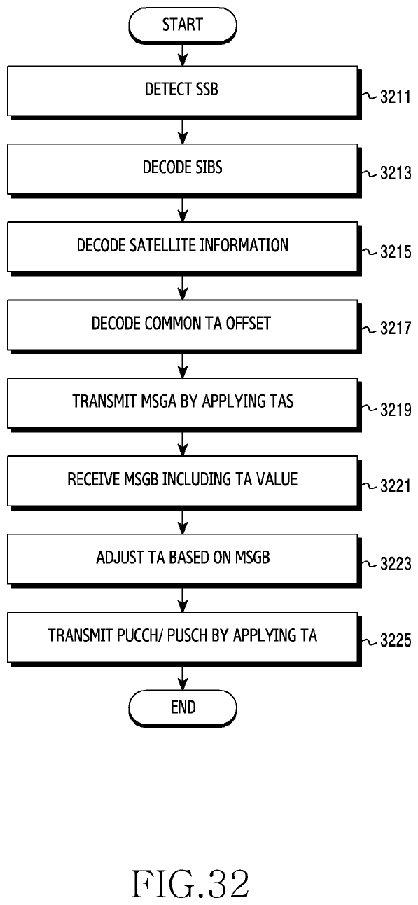

FIG. 32 is a diagram schematically illustrating another example of a UE operation procedure in the communication system according to an embodiment of the disclosure.

A UE may, according to a procedure to be described with reference to FIG. 32, perform initial access and determine TA after performing the initial access, and this will be described in detail below. Particularly, FIG. 31 illustrates the UE operation procedure based on random access for a 4-operation (4-step) random-access (RA) type, and a UE operation procedure to be illustrated in FIG. 32 may be a UE operation procedure based on random access for a 2-operation (2-step) RA type.

First, in operation 3211, a UE detects an SSB received from a base station. In operation 3213, the UE decodes SIBs, based on the detected SSB. Here, the UE may acquire information on RACH resources by decoding the SIBs.

In operation 3215, the UE may acquire (or decode) satellite information by decoding the SIBs. According to an embodiment of the disclosure, the satellite information may include at least one of various parameters, such as position information of a satellite. In operation 3215, the UE may acquire a UE-specific TA compensation value, for example, N_{TA,UE-specific}, based on the positions (or reference position) of the UE and the satellite, based on the decoded position information. In operation 3217, the UE may acquire (or decode) a common TA offset, for example, N_{TA,common}, by decoding the SIBs. In operation 3219, the UE may calculate TAs, based on N_{TA,UE-specific} and N_{TA,common} and transmit msgA to the base station by applying the calculated TAs. According to an embodiment of the disclosure, msgA may corresponds to preamble and payload transmissions in random access for the 2-step random-access (RA) type. In operation 3221, the UE receives msgB including TA values from the base station. According to an embodiment of the disclosure, msgB is a response to msgA in random access for the 2-step RA type, and may include response(s) to contention resolution, fallback indication(s), and backoff indication. In operation 3223, the UE may adjust TAs, based on the TA adjustment values included in msgB. In operation 3225, the UE may transmit a PUSCH and/or a PUCCH by applying the adjusted TAs.

When compared with an operation procedure of a UE in another embodiment of the disclosure, the operation procedure of the UE as described with reference to FIG. 32, that is, a procedure of performing initial access and determining TA after performing the initial access, may be summarized as shown in Table 25 below.

TABLE 25

| | UE operation procedure based |
|---|---|
| UE operation procedure | on FIG. 32 |
| 1. Detect SSB2. Decode SIBs | 1. Detect SSB |
| (RACH resource information | 2. Decode SIBs (RACH resource |
| detection) | information detection) |
| 3. Transmit MsgA (PRACH + | 3. Decode satellite information |
| Msg3) | decode (position information, etc.), |
| 4. Receive MsgB including TA | and N_{TA, UE-specific} |
| value | 4. Decode common TA offset, and |
| 5. Adjust TA based on MsgB | acquire N_{TA, common} |
| 6. Transmit PUCCH/PUSCH | 5. Transmit MsgA by applying TAs |
| by applying TA | 6. Receive MsgB including TA value |
| | 7. Adjust TA based on MsgB |
| | 8. Transmit PUCCH/PUSCH by |
| | applying TA |

In addition, the order of some operations in the operation procedure of the UE described with reference to FIG. 32 may be changed, and for example, the order of decoding the satellite information and decoding the common TA offset may be changed.

Although the operation procedure of the UE in the communication system according to various embodiments of the disclosure has been described with reference to FIG. 32, various modifications may also be made with respect to FIG. 32. For example, consecutive operations are illustrated in FIG. 32, but the operations described in FIG. 32 may overlap each other and may occur in parallel or occur in a different order, or one or more operations may occur multiple times.

N_{TA,UE-specific} used in embodiments of the disclosure is a value calculated and applied by the UE. Accordingly, the base station may not know a value of N_{TA,UE-specific} calculated by the UE. In addition, the value of N_{TA,UE-specific} calculated by the UE may change over time due to movement of the UE or the satellite.

Therefore, in embodiments of the disclosure, the base station may need to control TA of the UE in consideration of the value of N_{TA,UE-specific} which may change over time, and thus the UE may need to configure a time point to update the value of N_{TA,UE-specific}. Therefore, the UE may update the value of N_{TA,UE-specific}, based on one of the following methods, for example, method 1-1 to method 1-6 or a method of combining at least two of method 1-1 to method 1-6.
Method 1-1: The UE always updates N_{TA,UE-specific} at each time point when the SIB including the satellite information (e.g., including satellite information, etc.) is received. Method 1-1 may be applied to a case in which the UE determines that the SIB is received from the base station or a case in which a paging signal indicating SIB updating is received from the base station.
Method 1-2: The base station may separately indicate a TA change rate, for example, N_{TA,UE-specific}, and may configure a period and an offset for calculating the TA value again according to the TA change rate, for example, updating the TA value. In this case, the UE may update TA, for example, N_{TA,UE-specific}, at a time point determined according to the update period and offset, and an amount of the TA updated by the UE may be determined according to the TA change rate. In various embodiments of the disclosure, the base station may indicate the TA change rate, based on an explicit method or an implicit method.
Method 1-3: The base station may configure an update period and offset for updating N_{TA,UE-specific} by the UE, based on the position of the satellite and the position of the UE. In this case, the UE may update the TA at a corresponding time point determined according to the update period and offset configured by the base station. In various embodiments of the disclosure, the base station may indicate the update period and offset, based on an explicit method or an implicit method.
Method 1-4: The UE may always update and apply N_{TA,UE-specific} at a corresponding time point (all the cases where uplink transmission is performed every time, performed at regular intervals, and performed at irregular intervals are possible), for example, at a corresponding slot time point, in at least every some cases where uplink transmission (e.g., PUCCH/PUSCH, PRACH, SRS transmission, etc.) is performed.
Method 1-5: The UE updates N_{TA,UE-specific}, based on a time point at which a TA command transmitted by the base station via a MAC CE expires. For example, the UE updates N_{TA,UE-specific} at the time point when TA expires. The expiration of the TA command may indicate that a timer value for the TA command has reached a certain point in time. A timer for the TA command may be configured as timeAlignmentTimer and may be a parameter relating to a duration in which uplink time synchronization is aligned. When a new TA command is received, the UE may start or restart timeAlignmentTimer. When timeAlignmentTimer expires, the UE may empty an HARQ buffer and renew an RRC configuration, etc.
Method 1-6: New timer timeAlignmentTimer_UEspecific related to N_{TA,UE-specific} has been introduced, and the UE may update N_{TA,UE-specific}, based on the new timer timeAlignmentTimer_UEspecific. timeAlignmentTimer_UEspecific may start or restart when the UE newly calculates N_{TA,UE-specific} or information on N_{TA,UE-specific} is transmitted to the base station. When timeAlignmentTimer_UEspecific expires, the UE may newly calculate and update N_{TA,UE-specific}, configure N_{TA,UE-specific} to be 0, or perform PRACH transmission.

### Second Embodiment

The second embodiment provides a method and a device, by which a UE delivers (reports), to a base station or a satellite, a TA value that the UE is applying or has applied. In the disclosure, the satellite may be an object located high above the ground, and may include a concept, such as an airplane or an airship.

The UE may perform an operation of delivering, to the base station, the TA value that the UE is applying. This is to inform the base station of the applied TA value when the UE applies the TA value without any separate indication from the base station or to identify or determine how the UE applies the TA value indicated by the base station. For example, the operation may be performed to identify, when the satellite connected to the UE is changed, the TA value of the UE by the satellite newly connected to the UE. For example, the UE may apply, by itself, the TA calculated based on the positions of the UE and the satellite.

The UE may use one or a combination of at least two of the following methods in order to report the TA value to the base station.
Method 2-1: The base station may trigger TA value reporting of the UE via DCI. The base station may trigger TA value reporting via some bit field values of the DCI or a combination of bit field values. When a field that indicates triggering of TA value reporting is included in the DCI and the field of the received DCI is configured to be a specific value, the UE may understand that TA value reporting has been triggered. Alternatively, when values of one or more fields (e.g., for another purpose) included in the DCI are configured to be predetermined values, the UE may understand that TA value reporting has been triggered. The UE may deliver, to the base station, a TA value at a specific time point based on the time point at which the DCI has been received.
Method 2-2: The base station may trigger TA value reporting of the UE via a MAC CE. The base station may trigger TA value reporting by using a bit field value or some bit values of the MAC CE, and the UE may deliver, to the base station, a TA value at a time point when the MAC CE has been received or a time point after a predetermined time from the time point when the MAC CE has been received.
Method 2-3: The base station may indicate, via an RRC configuration, a TA value that the UE needs to report. For example, the base station may configure, via higher signaling, a period and an offset value for TA reporting and/or a specific condition for the UE to perform TA value reporting, so as to determine a time point at which the UE reports the TA value, in which case, a TA value application time that is a reference (i.e., a time at which the TA value to be reported is applied, which may be referred to as a TA value reference time point) may also be designated. The specific condition for the UE to perform TA value reporting may be, for example, a case where the TA value is larger than or equal to a predetermined value or a case where a distance between the UE and the satellite is longer than or equal to a predetermined value, and the predetermined values may be fixed values or information configured via higher signaling or transmitted via the SIB, etc.
Method 2-4: The UE may report the TA value without a separate trigger from the base station. For example, method 4 may include transmitting, by the UE to the base station, information indicating the TA value according to the specific condition, and the specific condition (without signaling, such as DCI, MAC CE, or RRC, for triggering from the base station) may be conditions, such as a time to perform TA value reporting or a result of comparing a specific threshold value with the TA value applied by the UE, etc., and may be pre-determined.

According to an embodiment of the disclosure, when the TA value is transmitted, the UE may transmit the TA value via a physical channel, such as a PUCCH or a PUSCH, or may deliver TA value information to the base station via higher signaling. When the UE delivers the TA value information by using the physical channel, resources to be used for reporting the TA value information may be configured via higher signaling.

According to an embodiment of the disclosure, TA value reporting may refer to reporting a value of T_{TA} or a value of N_{TA,UE-specific} in Equation 5 above. Alternatively, which one of T_{TA} and N_{TA,UE-specific} will be reported by the UE may be configured for the UE by the base station via the SIB or higher signaling.

The reference time point at which the TA value reported by the UE is determined and the time point at which the TA value is reported may be determined based on a time point at which the UE performs TA value reporting and a time point at which TA value reporting is triggered. For example, when TA value reporting is triggered in slot n via DCI, the UE may report a TA value applied or calculated in slot n−K, and the UE is able to report the TA value to the base station in slot n+N. K and N may be values determined according to subcarrier spacing or UE capability, a DL/UL configuration of the slot, a PUCCH resource configuration, etc.

According to an embodiment of the disclosure, K may be 0. K=0 may indicate that the UE reports the TA value based on a time point at which a TA value reporting triggering signal is received. In addition, K may be a value smaller than 0, and in this case, for example, the UE may generate reporting information by pre-calculating a TA value corresponding to the time of TA value reporting, and report the TA value. In addition, K may be an integer larger than 0. This may indicate that the UE reports the TA value at a time point earlier than the time point (for example, slot n+N) at which the UE reports the TA value, and the TA value may reported at the earlier time point because the UE needs time to encode information to be reported and prepare for transmission.

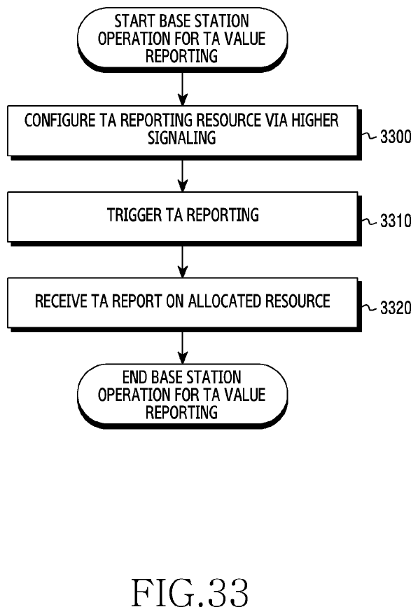

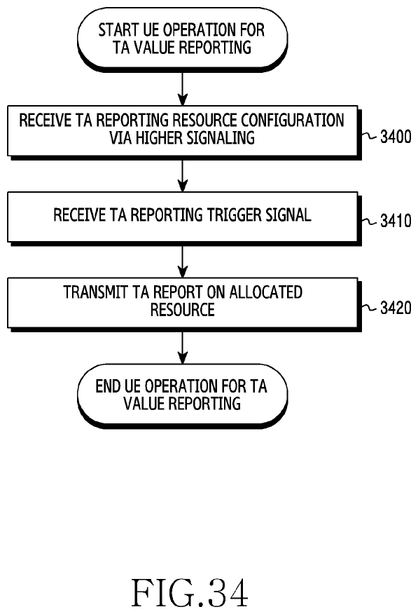

FIG. 33 and FIG. 34 are diagrams illustrating examples of base station and UE operations for reporting a TA value of a UE according to an embodiment of the disclosure. During reporting of a TA value in the disclosure, the TA value applied by a UE may be indicated in units of msecs, slots, symbols, or the like, and may be provided as information including a value with decimal places other than an integer. Reporting of the TA value in the disclosure may include an absolute value of TA, and may also include a TA value previously indicated by the base station, a relative TA value except for a predetermined TA value, or a variation of the TA value (this may be, for example, a TA variation over a certain period of time).

FIG. 33 is a diagram illustrating an operation of a base station. A base station may transmit configuration information related to TA reporting via higher signaling (operation 3300). The configuration information related to TA reporting may include, for example, at least one piece of information for configuring the TA reporting, such as a period and offset for performing of the TA reporting, a TA reporting trigger condition, TA value reference time point information, a type of TA information to be reported, or resource configuration information for performing of the TA reporting. The base station may trigger the UE to perform TA reporting (operation 3310). The trigger may be performed via, for example, the higher signaling or DCI with specific content described above, but can also be omitted. The base station may receive the TA reporting transmitted by the UE according to the transmitted configuration information (operation 3320).

FIG. 34 is a diagram illustrating an operation of a UE. A UE may receive configuration information related to TA reporting, which is transmitted by a base station via higher signaling (operation 3430). The configuration information may include, for example, at least one piece of information for configuring the TA reporting, such as a period and offset for performing of the TA reporting, a TA reporting trigger condition, TA value reference time point information, a type of TA information to be reported, or resource configuration information for performing of the TA reporting. The UE may receive a signal for triggering TA reporting, which is transmitted by the base station (operation 3440). The trigger may be performed via, for example, the higher signaling or DCI with specific content described above, but can also be omitted. The UE may transmit TA reporting according to the received configuration information (operation 3420). For example, when TA reporting resource information is received, the UE transmits the TA reporting in a configured resource. The order of respective operations disclosed in FIG. 33 and FIG. 34 may be changed and applied, or another operation may be added or omitted.

### Third Embodiment

The third embodiment provides the method, by which a UE calculates, determines, and reports N_{TA,UE-specific}, described via the first embodiment and the second embodiment. A value of N_{TA,UE-specific} may be calculated based on a distance between a UE and a non-terrestrial network (NTN) satellite. The UE may calculate its own position by receiving signals from navigation satellites in a satellite navigation system, and a navigation satellite may be different from a NTN satellite. Of course, the UE calculating its own position is not limited to the method above, and the position of the UE may be received from another entity.

According to an embodiment of the disclosure, the UE may estimate a delay between the satellite and the UE, based on the position of the UE and the position of the satellite, and perform uplink transmission by correcting an estimated delay time value by itself. For example, the satellite may transmit information on the position of the satellite via broadcast information, and the UE may receive the information on the position of the satellite, which is transmitted by the satellite, and compare the received information with its own position. The position of the UE may be identified in an independent or combined manner by using information from a base station or information from one of several types of global positioning systems (GPSs). The UE may calculate an uplink transmission time by estimating, via the comparison, a time taken for a radio wave to be delivered to the satellite.

For example, when it is assumed that the UE receives a signal in slot n via a downlink at a specific time point and needs to perform uplink transmission corresponding to the signal in slot n+k, the uplink transmission may be performed earlier than the time point of slot n+k by 2*Td. According to an embodiment of the disclosure, a delay of Td may be a delay from the UE to the satellite, which is calculated based on position information of the satellite and the UE, or may be a value corresponding thereto. The delay Td may be a value obtained by dividing the distance between the UE and the satellite or a value corresponding thereto by a speed of light or may be a value corresponding thereto. For example, the position of the satellite may be a value calculated based on slot n+k in which the UE performs uplink transmission. This is because the position of the satellite in slot n and the position of the satellite in slot n+k may be different depending on movement of the satellite.

In a terrestrial network, a propagation delay equal to or less than 1 ms may occur in consideration of a distance to a base station, which is a maximum of about 100 km, but in a satellite network, a distance to a satellite may be thousands of km, and a distance between the satellite and the base station may also be thousands of km, so that a delay in the satellite network may be significantly longer than that of the terrestrial network.

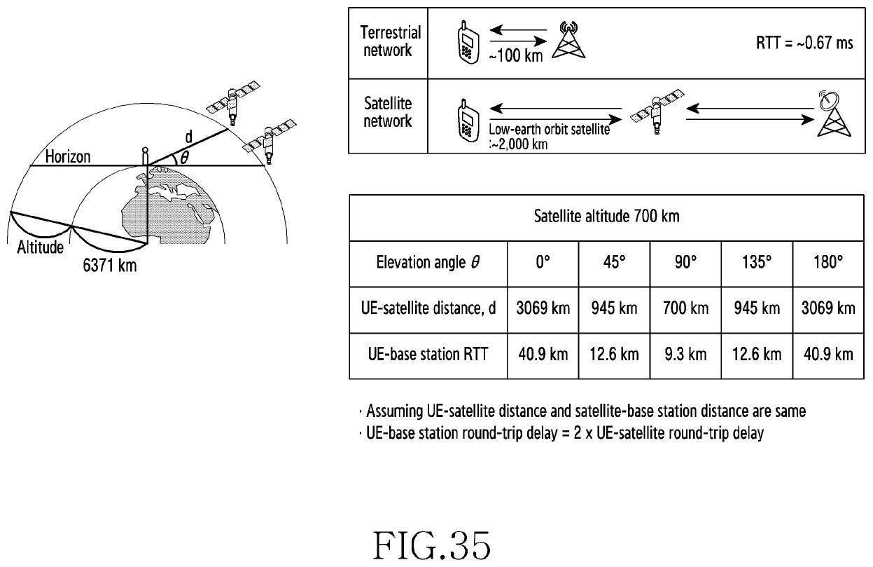

FIG. 35 is a diagram illustrating an example of a propagation delay difference between a terrestrial network and a satellite network according to an embodiment of the disclosure. In satellite network communication, a delay varies depending on an altitude and an elevation angle of a satellite. In FIG. 35, a distance between a UE and a satellite and a time it takes for a radio wave to make a round trip are illustrated according to an elevation angle when an altitude of the satellite is 700 km. For the satellite network, a low-earth orbit satellite is assumed, and it is illustrated that a radio round-trip time (RTT which may include a round-trip time for transmitting a signal between a transmitter and receiver, and a processing time at a counterpart node) from 40.9 ms to 9.3 ms may occur when an elevation angle is 0° to 180°. According to an embodiment of the disclosure, a delay is merely an example and may vary depending on the altitude and orbit of the satellite, and, for example, a delay may further increase on average at higher altitudes.

In the terrestrial network, since a maximum delay is within 1 or 2 ms, timing advance provided by LTE and 5G NR systems may be used to ensure, from the perspective of the base station, that slot timing for downlink transmission and slot timing for uplink reception are matched (i.e., the indexes of a DL slot and an UL slot may be matched). That is, when the UE advances uplink transmission by a value of timing advance indicated by the base station from the downlink time point, a time point at which an uplink signal transmitted by the UE is received by the base station may match the downlink time point of the base station. On the other hand, in the satellite network, it may be difficult, from the perspective of the base station, to enable matching between slot timing for downlink transmission and slot timing for uplink reception via timing advance provided by conventional LTE and 5G NR systems. This is because a propagation delay occurring in the satellite network is as large as tens of msecs, so that this propagation delay is larger than a maximum value of timing advance provided in conventional LTE and 5G NR systems.

A satellite navigation system may also be referred to as a global navigation satellite system (GNSS), and the GNSS may include, for example, a GPS in the US, a GLONASS in Russia, Galileo in EU, Beidou in China, and the like. Of course, the satellite navigation system is not limited to the example above. The GNSS may include a regional navigation satellite system (RNSS), and the RNSS may include, for example, IRNSS in India, QZSS in Japan, KPS in Korea, and the like. A signal transmitted in the GNSS may include at least one of assistance navigation information, a normal operation state of a satellite, a satellite time, satellite orbital power, a satellite altitude, a reference time, and information on various compensation materials.

In various embodiments of the disclosure, the NTN satellite may be a communication satellite serving to deliver a signal for a connection between the UE and the base station. In addition, in various embodiments of the disclosure, the GNSS satellite may be a satellite that transmits a signal of the satellite navigation system. The UE may receive a signal from each of one or more GNSS satellites, calculate a position of the UE itself, based on the signal received from each of the one or more GNSS satellites, and identify a reference time in each of the one or more GNSS satellites. If the UE is able to calculate multiple positions of the UE itself, based on the signals received from the multiple GNSS satellites, the UE may calculate an actual position of the UE, based on a position corresponding to a reception signal having a highest intensity among the multiple positions or an average value (e.g., a method of applying a weight to a position corresponding to a signal with a strong signal intensity) of the multiple positions based on signal intensities. Here, a scheme by which the UE calculates the position of the UE, based on the signals received from the multiple GNSS satellites may be implemented in various forms, and a detailed description thereof will be omitted.

In various embodiments of the disclosure, the time obtained from the GNSS or the time of the base station delivered by the base station may be based on coordinated universal time (UTC), and this may be based on the time from 00:00:00 on Jan. 1, 1900 of the Gregorian calendar. This may vary depending on a GNSS system type, and a reference time zone as shown in Table 26 below may be used.

```
TABLE 26
  gnss-DayNumber
  This field specifies the sequential number of days (with day count starting at 0)
from the origin of the GNSS System Time as follows:
    GPS, QZSS, SBAS - Days from January 6^{th} 1980 00:00:00 UTC (USNO);
    Galileo - Days from Galileo System Time (GST) start epoch, defined as 13
seconds before midnight between 21^{st}  August and 22^{nd}
August 1999; i.e., GST was equal to 13 seconds at August 22^{nd} 1999. 00:00:00 UTC;
    GLONASS - Days from December 31^{st} 1995 21:00:00 UTC (SU), which is
local UTC Moscow
      January 1^{st} 1996 00:00:00, defined as UTC(SU)
+ 3 hours in [9];
    BDS - Days from January 1^{st} 2006 00:00:00 UTC (NTSC)
    NavIC - Days from NavIC System Time start epoch, defined as 13
seconds before midnight between 21st
    August and 22nd August 1999; i.e., NavIC System Time was equal to
00:00:00 at August 21^{st} 1999
    23:55:47 UTC (BIPM).
```

In Table 26 above, NavIC may refer to NAVigation with Indian Constellation, QZS may refer to Quasi Zenith Satellite, QZSS may refer to Quasi-Zenith Satellite System, QZST may refer to Quasi-Zenith System Time, SBAS may refer to Space Based Augmentation System, and BDS may refer to BeiDou Navigation Satellite System.

In addition, the base station may indicate, via a satellite, a type of a GNSS system that is used as a reference for position or time information used by the base station itself, where indicators as shown in Table 27 below may be used.

TABLE 27

| Value of gnss-TO-ID | Indication |
|---|---|
| 1 | GPS |
| 2 | Galileo |
| 3 | QZSS |
| 4 | GLONASS |
| 5 | BDS |
| 6 | NavIC |
| 7-15 | reserved |

As described above, the UE may calculate the time required for a signal to be delivered from an NTN satellite to the UE, based on a position of the UE calculated by the UE itself and a position of the NTN satellite received from the NTN satellite, and may determine a TA value based on the required time. If a distance from the NTN satellite to the base station on the ground, or a corresponding signal is delivered to the base station on the ground via another NTN satellite, when the UE determines the TA value, the UE may also consider a distance from the NTN satellite to another NTN satellite.

Unlike this, the UE may acquire reference time information from information transmitted by the GNSS satellite, compare time information transmitted by the NTN satellite with the reference time information acquired from the GNSS satellite, and calculate a time (propagation delay) required from the NTN satellite to the UE, based on a comparison result.

The position and time information of the NTN satellite may be transmitted by the base station to the UE via an SIB. The position and time information may be directly transmitted by the NTN satellite.

When it is assumed that the distance between the UE and the satellite or a value corresponding thereto is d_{UE,sat} (in km unit) and a speed of light is v_{c} (in km/sec unit), N_{TA,UE-specific} may be determined based on d_{UE,sat}/v_{c} (in sec unit). For example,

$${N}_{TA , UE - specific} = ⌊ \frac{{d}_{UE , sat}}{{v}_{c}} \cdot \frac{1}{{T}_{c}} ⌋$$

may be determined and applied, which is a method capable of determining N_{TA,UE-specific} by making a value of

$$\frac{{d}_{UE , sat}}{{v}_{c}} \cdot \frac{1}{{T}_{c}}$$

into an integer. Alternatively/additionally, the UE may use a method, such as a combination of at least one of the three methods below, to determine N_{TA,UE-specific} and report information of N_{TA,UE-specific} to the base station.
Method 3-1: The UE may determine N_{TA,UE-specific}=(D+a)/T_{C}. D is an integer, and a is a decimal that is larger than or equal to 0 and is smaller than 1. Here,

$$D = ⌊ \frac{{d}_{UE , sat}}{{v}_{c}} ⌋ and a = \frac{{d}_{UE , sat}}{{v}_{c}} - ⌊ \frac{{d}_{UE , sat}}{{v}_{c}} ⌋ .$$

Method 3-1 may be a method of dividing a propagation delay between the UE and the satellite into an integer part and a decimal part and reporting only the integer or a value corresponding thereto or separately reporting the integer or the decimal or values corresponding thereto. By using this method, the number of bits used to report the propagation delay may be reduced. Here, although it has been described that the decimal part is an integer multiple of T_{c}, the decimal part may be determined to be a multiple of 16*64/2^{μ}. Here, u may be a current carrier, a BWP, or SCS of a relevant CORESET. Alternatively, u may be a value used for a transmission/reception signal, such as a PDSCH or PUSCH to be transmitted/received. Here, μ=0, 1, 2, 3, 4, 5 may be values corresponding to subcarrier spacings of 15 kHz, 30 kHz, 60 kHz, 120 kHz, 240 kHz, and 480 kHz, respectively. Alternatively, u may be configured by the based station via higher signaling so as to determine N_{TA,UE-specific}. Alternatively, a fixed value may be used for μ, and for example, μ may be used as one of the values 0, 1, 2, 3, 4, 5, such as μ=5.
Method 3-2: The UE may determine N_{TA,UE-specific} to be a multiple of 16*64/2^{μ}. This may be determined as

$${N}_{TA , UE - specific} = ⌊ \frac{{d}_{UE , sat}}{{v}_{c}} \cdot \frac{1}{16 \cdot 64 \cdot {T}_{c} / {2}^{μ}} ⌋ \cdot 16 \cdot 64 / {2}^{μ} .$$

In the disclosure, └X┘ may denote a maximum integer that is not larger than x, and may round the number down at the integer unit, that is, discarding a decimal value. Of course, └X┘ is not limited to the example above, and in the disclosure, rounding up or rounding off at a decimal place may be used instead of rounding down using └X┘. Here, μ may denote a current carrier, a BWP, an SIB, or SCS of a relevant CORESET. Alternatively, μ may be a value used for a transmission/reception signal, such as a PDSCH or PUSCH to be transmitted/received. Here, μ=0, 1, 2, 3, 4, 5 may be values corresponding to subcarrier spacings of 15 kHz, 30 kHz, 60 kHz, 120 kHz, 240 kHz, and 480 kHz, respectively. Alternatively, μ may be configured by the based station via higher signaling so as to determine N_{TA,UE-specific}. Alternatively, a fixed value may be used for μ, and for example, μ=5 may be fixedly used. Alternatively, μ to be used for calculating N_{TA,UE-specific} may be separately configured by the base station via an SIB or higher signaling.
Method 3-3: N_{TA,UE-specific}=N_{A,UE-specific}*16*64/2^{μ} may be determined, where N_{A,UE-specific} may be determined to be an integer which makes N_{A,UE-specific} closest to d_{UE,sat}/(v_{c}*T_{c}). Alternatively, N_{A,UE-specific} may be determined to be a minimum integer satisfying

$${N}_{TA , UE - specific} \geq \frac{{d}_{UE , sat}}{{v}_{c} \cdot {T}_{c}} ,$$

or may be determined to be a maximum integer satisfying

$${N}_{TA , UE - specific} \leq \frac{{d}_{UE , sat}}{{v}_{c} \cdot {T}_{c}} .$$

Method 3-4: The UE may determine N_{TA,UE-specific}=0 according to a base station configuration. This may be because UEs within coverage in a specific beam of the satellite have almost no difference in propagation delays occurring in a link (which may be referred to as a service link) between the UEs and the satellite, so that uplink time synchronization may be achieved using a conventional TA mechanism and N_{TA,common}. The base station may configure, via the SIB, whether the UE configures the value of N_{TA,UE-specific} as N_{TA,UE-specific}=0 or whether the UE uses the value of N_{TA,UE-specific} calculated based on the positions of the satellite and the UE and the speed of light according to a GNSS signal. For another example, the base station may configure, via the SIB or separate RRC signaling, whether the UE continuously uses a value of N_{TA,UE-specific} calculated based on a time point at which a PRACH preamble is transmitted based on the positions of the satellite and the UE and the speed of light according to the GNSS signal until there is a separate indication or configuration, or whether the UE uses a newly calculated value of N_{TA,UE-specific} at each uplink transmission time point. That is, in Equation 5 above, a value of N_{TA,UE-specific} may be determined as described below.

[N_{TA,UE-specific} is UE self-estimated TA to pre-compensate for the service link delay if configured, and N_{TA,UE-specific} is 0 otherwise.]

Method 3-1 to method 3-4 are merely examples of methods of determining N_{TA,UE-specific}, based on the distance between the UE and the satellite (or a value corresponding thereto) and the speed of light, and there may be more various methods. For example, in general, when a value of N_{TA,UE-specific} is defined as an integer or an expression based on an integer value is defined,

$$⌊ \frac{{h}_{sat}}{{v}_{c}} \cdot \frac{1}{{T}_{c}} \cdot \frac{1}{K} ⌋ \cdot K , D = ⌊ \frac{{d}_{UE , sat}}{{v}_{c}} \cdot \frac{1}{K} ⌋ .$$

K, or the like may be expressed to indicate a multiple of a specific integer or rational number value of K. Here, K may be a predetermined value or a value determined by signaling parameters. Method 2 indicates a case where K=16*64/2^{μ}, and K may be determined according to at least one of system parameters, such as u or T_{c}. The method has an advantage of being able to express more various values with the same bit signaling, instead of having a somewhat sparse granularity feature for N_{TA,UE-specific} values. In addition, instead of a rounding down operation, such as └X┘, used in each of the methods, the values may be determined based on operations, such as rounding up (┌X┐) or rounding off (Round(x)) at a decimal place.

### Fourth Embodiment

The fourth embodiment provides the method, by which a base station delivers N_{TA,common} to a UE and the UE performs calculation and application, described via the first embodiment and the second embodiment.

Hereinafter, methods by which the base station delivers N_{TA,common} information to the UE via configuration and indication are described, and one or more of the methods may be combined and applied.
Method 4-1: The base station may configure one offset value for the UE via RRC signaling. The value configured via RRC signaling is referred to as N_{A,common}, and N_{TA,common} may be determined based on N_{A,common}.
Method 4-2: The base station may indicate one offset value for the UE via a MAC CE. The value configured via the MAC CE is referred to as N_{A,common}, and N_{TA,common} may be determined based on N_{A,common}. This method, when compared to method 4-1, has an advantage that the base station and the UE may clearly define a time point at which the base station and the UE apply N_{TA,common}. For example, N_{TA,common} may be applied after a predetermined time based on a time point at which the MAC CE is received or a time point at which ACK is transmitted in response to reception of the MAC CE. For example, the base station may deliver N_{A,common} in units of msecs via an 8-bit MAC CE and indicate 0 ms to 255 ms. In this case, N_{TA,common} is determined as N_{TA,common}=T_{A,common}/(1000*T_{c}).
Method 4-3: The base station may configure one or more offset values for the UE via higher-layer signaling. Alternatively, these values may be pre-configured. These configured values may become candidate values of T_{A,common}, and the base station may indicate one of these values via a MAC CE.
Method 4-4: The base station may configure one offset value for the UE via an SIB. The value configured via the SIB is referred to as T_{A,common}, and N_{TA,common} may be determined based on T_{A,common}. The UE uses a value of N_{TA,common} to calculate and apply TA when transmitting a PRACH preamble during initial access. Thereafter, ΔT_{A,common} may be indicated to the UE via a MAC CE, and the UE may calculate a variation in N_{TA,common} by using ΔT_{A,common}, thereby calculating N_{TA,common} (new)=N_{TA,common} (old)+(ΔT_{A,common}−x)*y. Here, x and y may be determined according to the number of bits and unit for delivering of ΔN_{A,common}. For example, N_{TA,common} (new)=N_{TA,common} (old)+(ΔT_{A,common}-M)*16*64/2^{μ} may be determined. Here, a value of M may be 31, or may be a value larger than or equal to 31 when a maximum value of ΔT_{A,common} which may be indicated via the MAC CE is larger than 63, and may be a value equal to or smaller than 31 when the maximum value of ΔT_{A,common} is smaller than 63.
Method 4-5: The base station may indicate one offset value for the UE via a MAC CE. This configured value is referred to as T_{A,common}, and N_{TA,common} may be determined based on T_{A,common}. This method, when compared to method 4-1, has an advantage that time points at which the base and the UE apply N_{TA,common} may be clearly defined. For example, N_{TA,common} may be applied after a predetermined time based on a time point at which the MAC CE is received or a time point at which ACK is transmitted in response to reception of the MAC CE. For example, the base station may deliver T_{A,common} in units of 16*64*T_{c}/2^{μ} secs via a MAC CE of about 19 bits or 24 bits. In this case, N_{TA,common} is determined as N_{TA,common}=T_{A,common}*16*64/2^{μ}. The number of bits of the MAC CE is merely an example, and another value may be applied.
Method 4-6: The base station may indicate one offset value for the UE via a MAC CE. This configured value is referred to as T_{A,common}, and N_{TA,common} may be determined based on an altitude of the satellite and T_{A,common}. This method, when compared to method 4-5, has an advantage that the number of bits to be delivered may be reduced. For example, the base station may transmit T_{A,common} in units of 16*64*T_{c}/2^{μ} secs via a MAC CE of about 16 bits. In this case, N_{TA,common} is determined as

$${N}_{TA , common} = \frac{{h}_{sat}}{{v}_{c}} \cdot \frac{1}{{T}_{c}} + {T}_{A , common} \cdot 16 \cdot 64 / {2}^{μ} .$$

Here, hₛₐₜ may denote an altitude of the satellite. This may indicate that when the satellite is at a specific altitude, a minimum distance between the UE and the satellite is the specific altitude, and thus the base station signals only the remaining additional distance via T_{A,common}. The number of bits of the MAC CE is merely an example, and another value may be applied.

In the equation, a value of

$$\frac{{h}_{sat}}{{v}_{c}} \cdot \frac{1}{{T}_{c}}$$

may be defined by integer conversion or rational number conversion via a method similar to the third embodiment. For example, various integer conversion or rational number conversion schemes are applicable based on a value of hₛₐₜ instead of a value of d_{UE,sat} in the third embodiment as well as integer conversion or rational number conversion using a rounding down operation such as

$$⌊ \frac{{h}_{sat}}{{v}_{c}} \cdot \frac{1}{{T}_{c}} ⌋ or ⌊ \frac{{h}_{sat}}{{v}_{c}} \cdot \frac{1}{{T}_{c}} \cdot \frac{1}{K} ⌋ \cdot K .$$

Of course, integer conversion or rational number conversion similar to the description above may be applied to a total value of

$$\frac{{h}_{sat}}{{v}_{c}} \cdot \frac{1}{{T}_{c}} + {T}_{A , common} \cdot 16 \cdot 64 / {2}^{μ} .$$

For example,

$${N}_{TA , common} = \{ ⌊ \frac{{h}_{sat}}{{v}_{c}} \cdot \frac{1}{{T}_{c} 16 \cdot 64 / {2}^{μ}} ⌋ + {T}_{A , common} \} \cdot 16 \cdot 64 / {2}^{μ}$$

may be defined, and this case may have the same scheme as a case of considering K=16*64/2^{μ} in

$$⌊ \frac{{h}_{sat}}{{v}_{c}} \cdot \frac{1}{{T}_{c}} \cdot \frac{1}{K} ⌋ \cdot K .$$

In addition, for the operation used for integer conversion or rational number conversion, various other operations, such as rounding up and rounding off as well as rounding down, may be applied.
Method 4-7: The base station may deliver information on a change rate of N_{TA,common} and a value of N_{TA,common} at a time point of reception via an SIB. The information on the change rate of N_{TA,common} and the value of N_{TA,common} may be delivered to a specific UE via RRC signaling instead of the SIB, and a deliver method may vary depending on a state of the UE (RRC_idle, RRC_inactive, or RRC_connected).

The information on the change rate of N_{TA,common} may be delivered via one, two, or three parameters by using the SIB. For example, if the information on the change rate is delivered via one parameter A, when a time point at which N_{TA,common} is delivered via the SIB referred to as t1, and a time point at which uplink transmission is performed is referred to as t2, N_{TA,common(t2)} which is N_{TA,common} to be applied by the UE at t2 may be calculated as N_{TA,common(t2)}=N_{TA,common(t1)}+(t2−t1)*A. In this case, the units of t1 and t2 may be msec, and the unit of A may be T_{c}/msec. That is, A may indicate changes in the value of N_{TA,common} per 1 msec, which correspond to the number of T_{c}s. For another example, if the information on the change rate is delivered via two parameters of A and B, when a time point at which N_{TA,common} is delivered via the SIB referred to as t1, and a time point at which uplink transmission is performed is referred to as t2, N_{TA,common(2)} which is N_{TA,common} to be applied by the UE at t2 may be calculated as N_{TA,common(t2)}=N_{TA,common(t1)}+(t2−t1)²*B+(t2−t1)*A. (When the information on the change rate is delivered via n parameters, it is also possible to express a difference (t2−t1) between the two time points in the form of an n-th order polynomial.) In this case, the units of t1 and t2 may be msec, the unit of A may be Tc/msec, and the unit of B may be Tc/msec\hat{ }2. That is, A may indicate changes in the value of N_{TA,common} per 1 msec, which correspond to the number of T_{c}s, and B may indicate changes in the change rate of the value of N_{TA,common} per 1 msec, which correspond to the number of T_{c}s.

### Fifth Embodiment

The fifth embodiment provides a method and a device in which a base station delivers, to a UE, K_{offset} which is a parameter for determining timing at which the UE transmits a second signal in response to a first signal transmitted by the base station.

While transmitting the first signal, the base station may indicates, via higher signaling and DCI, a time point at which the UE transmits the second signal corresponding to the first signal. For example, while a PDSCH is being transmitted, HARQ-ACK feedback to the PDSCH may be indicated by an HARQ-ACK timing-related indicator of a bit field in the DCI for scheduling of the PDSCH. However, in the satellite communication, a delay between the UE and the base station is very large, and thus an offset value indicated in conventional DCI may not be able to indicate correct timing. Therefore, the base station may deliver K_{offset} which is an additional timing offset to the UE via the SIB, and the UE may determine transmission timing of the second signal (uplink transmission) by adding the offset K_{offset}.

After initial access of the UE, in an RRC_connected state, the base station may update the K_{offset} value to the UE via RRC signaling. However, when updating is performed only via RRC signaling, the base station and the UE may have different K_{offset} during a time interval in which RRC reconfiguration is performed. In this case, transmission and reception of the second signal may not be correctly performed. In order to eliminate such an ambiguity in the time interval, the base station may configure multiple K_{offset} values for the UE, and indicate one of the configured K_{offset} values via a MAC CE. Accordingly, the UE may apply the updated K_{offset} value from a determined time point after receiving the MAC CE.

For example, candidate values of K_{offset} values may be configured according to indexes shown in Table 28 below via RRC signaling.

TABLE 28

| Index | K_offset |
|---|---|
| 0 | 100 |
| 1 | 120 |
| 2 | 140 |
| 3 | 160 |
| 4 | 180 |
| 5 | 200 |
| 6 | 220 |
| 7 | 240 |

Table 28 shows an example of configuring K_{offset} at regular intervals via 8 indexes, and various other configurations are also possible. If index i values include 2^{M} (M is an integer such as, 2, 3, 4, . . . ), such as 0, 1, 2, . . . , 2^{M}−1, and when a K_{offset} value for index i is K_{offset}(i), it may be defined to have values at uniform intervals, such as K_{offset}(i)=K_{offset}(0)+(i−1)*A (A corresponding to a positive constant) for i>0. Of course, a value of M may be variable according to a system configuration, and a value of A may also be variably configured according to the value of M. In addition, some of the indexes may be defined as a reserved field. When a maximum value of K_{offset} except for the reserved field is K_{offset}(iₘₐₓ), there may be a relationship of A=(K_{offset}(iₘₐₓ)−K_{offset}(0))/iₘₐₓ.

Of course, this is merely an example of being configured to values of uniform difference, and in general, values of uniform difference may not be configured overall. For example, values having different differences may be configured according to an index range. (an iₘ value may be simply configured as 2^{M-1} or generally configured as another integer value.)

$$1 \leq i < {i}_{m} , \\ {K}_{offset} ( i ) = {K}_{offset} ( 0 ) + ( i - 1 ) * A 1 \\ {i}_{m} \leq i \leq {i}_{ma x} , \\ {K}_{offset} ( i ) = {K}_{offset} ( {i}_{m} ) + ( i - {i}_{m} ) * A 2$$

A1 and A2 are different positive constants, wherein A1=(K_{offset}(iₘ)−K_{offset}(0))/iₘ, and A2=(K_{offset}(iₘₐₓ)−K_{offset}(iₘ))/(iₘₐₓ−iₘ).

Thereafter, the base station may deliver an index to the UE in slot n via a MAC CE, and the UE may transmit the second signal by applying K_{offset} indicated in slot n+k. According to an embodiment of the disclosure, a k value may be configured, or may be determined according to subcarrier spacing.

### Sixth Embodiment

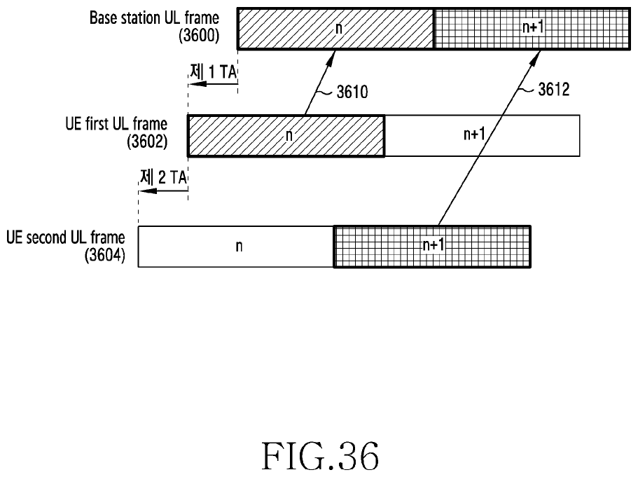

The sixth embodiment describes a solution method for a UE when an overlap occurs in some time intervals of a specific uplink slot due to application of TA. FIG. 36 is a diagram illustrating a method of aligning uplink transmission timing of a UE and a base station when a time interval overlap occurs in a part of a specific uplink slot. In the sixth embodiment, a physical channel included in uplink transmission may be at least one of PUSCH, PUCCH, and SRS. Of course, the physical channel is not limited to the example above. In order to match a base station uplink (UL) frame 3600, a UE may transmit a UE first UL frame 3602 as early as first TA. For example, when the UE transmits data in slot n of the UE first UL frame 3602, a base station may receive the data in slot n of the base station UL frame 3600.

The first TA may be a TA value applied by the UE immediately after initial access, information for TA compensation, which is received from the base station, or information (e.g., satellite position information, information on a time when the information has been generated, a validity time of the information, etc.) for TA calculation by the UE itself, may be at least one value of the TA described in the disclosure, or may be a combination of at least some thereof.

Then, there may be a case in which the UE applies second TA from slot n+1 to perform uplink transmission in accordance with a UE second UL frame 3604. For example, this may be a case where a distance between a satellite and a UE becomes farther.

The second TA may be information for TA compensation, which is received from the base station, or information (e.g., satellite position information, information on a time when the information has been generated, a validity time of the information, etc.) for TA calculation by the UE itself, may be at least one value of the TA described in the disclosure, or may be a combination of at least some thereof. During uplink transmission in slot n, the UE may apply the TA (first TA) of the UE first UL frame 3602, and during uplink transmission in slot n+1, the UE may apply the TA (second TA) of the UE second UL frame 3604. Since different TA values are applied to the UE first UL frame 3602 and the UE second UL frame 3604, some intervals of slot n and slot n+1 may overlap in terms of time resources, as illustrated in FIG. 36. Therefore, since the UE is unable to transmit all transmission resources included in slot n or slot n+1 in the overlapping interval, only one resource should be selected for transmission. For an overlapping resource area size, when a base station radius is up to 300 m in a terrestrial network (TN), an overlap up to about 1 us may occur, and since a length of one symbol is about 71 us based on 15 kHz, a very small part is occupied. However, in an NTN, since a distance between a satellite and a UE is very large, there is a possibility that an overlapping part of several hundred us or longer may occur, which may correspond to several symbols based on a 15 kHz slot. The overlap may indicate an overlap between slots or may indicate an overlap between transmission resources within each slot. Therefore, the UE may be able to operate in at least one of the following methods or a combination some thereof.
Method 6-1: The UE does not transmit an overlapping part of slot n+1. That is, when two adjacent slots overlap due to application of different TA values, a length of the latter slot is a length remaining after excluding an overlap length when compared to the former slot. For example, when transmitting a PUSCH in slot n+1, the UE transmits, in slot n+1, the PUSCH remaining after excluding a PUSCH area overlapping with slot n in terms of time resources.
Method 6-2: The UE does not transmit an overlapping part of slot n. That is, when two adjacent slots overlap due to application of different TA values, a length of the former slot is a length remaining after excluding an overlap length when compared to the latter slot. For example, when transmitting a PUSCH in slot n, the UE transmits, in slot n, the PUSCH remaining after excluding a PUSCH area overlapping with slot n+1 in terms of time resources.
Method 6-3: The UE may be able to operate in a combination of method 6-1 and method 6-2 depending on whether a connected network is a TN or an NTN. When connected to a TN network, the UE may operate in method 6-1, and when connected to an NTN network, the UE may operate in method 6-2. The UE may determine whether the connected network is the TN or the NTN, by higher-signal configuration information (e.g., SIB or RRC), or may be able to determine the same by UE position information (e.g., GPS).
Method 6-4: The UE may be able to operate in a combination of method 6-1 and method 6-2 by an indication of the base station (RRC or MAC CE or DCI). When indicated via RRC, one of method 6-1 or method 6-2 indicated by RRC can be selected immediately after RRC configuration information is applied or from a subsequent specific slot (a first slot in SFN or a slot indicated by RRC). When indicated via a MAC CE, the UE receives a PDSCH including the MAC CE with information for selecting one of method 6-1 or method 6-2, and then, after slot (k) at which HARQ-ACK information for the PDSCH has been transmitted, the UE follows the information indicated in the MAC CE from a specific time point (e.g., k+3). According to an embodiment of the disclosure, 3 in k+3 is merely an example, and another value may be applied or a value may be separately configured by a higher-level signal. When indicated by DCI, the UE may be able to select one of method 6-1 or method 6-2 by the DCI for scheduling of uplink information, and the UE applies one of method 6-1 or method 6-2 when applying the uplink transmission scheduled in the DCI.
Method 6-5: The UE may be able to select method 6-1 or method 6-2 according to a type of a transmission channel transmitted in the latter slot. For example, when the UE transmits a PUCCH including HARQ-ACK information or transmits a PUSCH including UCI information in the overlapping resource of the latter slot, the UE applies method 6-2. Otherwise, the UE applies method 6-1. The PUCCH including the HARQ-ACK information is merely an example, and other information (e.g., CSI or SR) that may be included in the PUCCH may also be possible. In the PUSCH including the UCI information, UCI may be at least one of HARQ-ACK, SR, and CSI, or may indicate a case where at least HARQ-ACK information is included. The purpose of method 6-5 may be considered as a method for reducing control information loss at least.
Method 6-6: The UE may be able to select method 6-1 or method 6-2 according to a type of a transmission channel transmitted in the former slot. For example, when the UE transmits an SRS in the overlapping resource of the former slot, the UE selects method 6-1. Otherwise, the UE selects method 6-2.
Method 6-7: In the NTN environment, the UE may be able to operate in a combination of method 6-1 and method 6-2 by considering the aforementioned methods via UE implementations or in other ways. That is, it may be possible to select at least one of method 6-1 or method 6-2 according to a UE capability report or implementation of the UE itself.

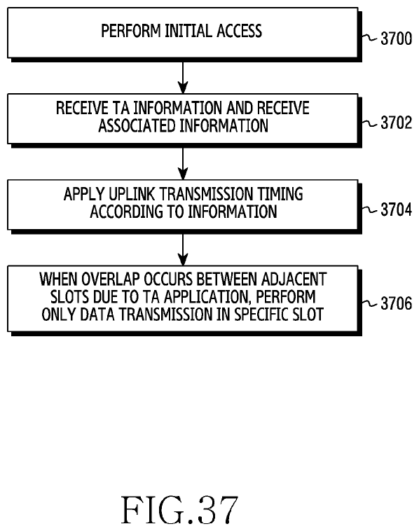

FIG. 37 is a diagram illustrating an operation flow of a UE when a time interval overlap occurs in a part of a specific uplink slot. After a UE performs initial access (operation 3700) to access a cell, the UE may receive (operation 3702) TA information or associated information for TA calculation from a base station in order to configure uplink reception timing. The UE may then apply (operation 3704) uplink transmission timing according to the TA information or the associated information for TA calculation. In this case, overlapping may occur between adjacent slots in terms of time resources due to an applied TA value. In this case, the UE may be able to select and transmit (operation 3706) data to be transmitted in a specific slot, by considering at least one of or some combination of aforementioned methods 6-1 to 6-7.

### Seventh Embodiment

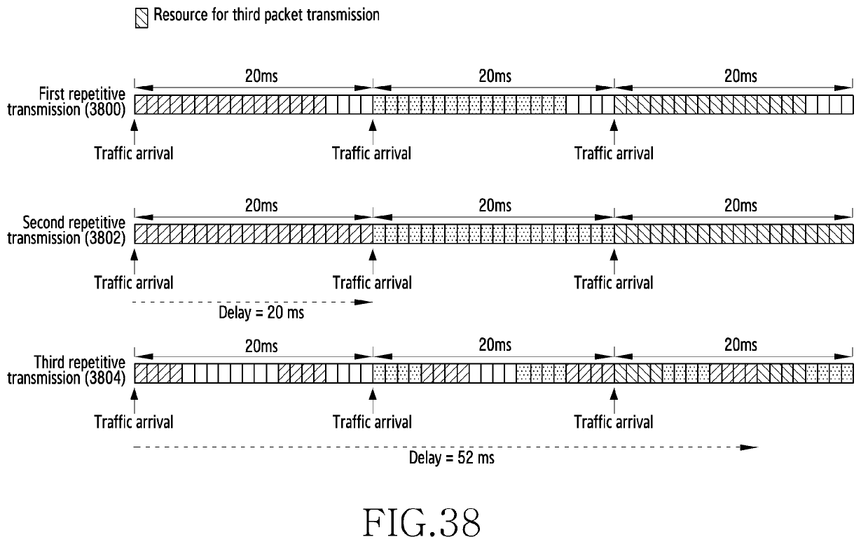

Repetitive PUSCH transmission considering voice over Internet protocol (VoIP) is important not only in the TN but also in the NTN, and for the NTN, a delay between a UE and a base station is much larger than that of the TN, so that repetitive PUSCH transmission reflecting this characteristic may be necessary. FIG. 38 is a diagram illustrating an example of repetitive PUSCH transmission considering a VoIP according to an embodiment of the disclosure. Since VOIP corresponds to a voice call, the VoIP has a feature of periodically generating traffic, and a corresponding period is approximately 20 ms. In addition, a conventional scheduling-based PUSCH retransmission scheme supports highly reliable transmission with fewer resources, but a delay between a base station and a UE is large, so that the scheduling scheme is inefficient in an NTN network situation. Therefore, rather than the scheduling scheme, configured repetitive PUSCH transmission with periodically allocated repetitive PUSCH transmission resources may be efficient. In addition, in the NTN environment, since a distance between a satellite and a UE is far, it may be necessary to guarantee VOIP performance via a large number of repetitive transmissions. To this end, it may be possible to apply at least one of the following methods.
Method 7-1: a method of configuring a maximum number of repetitive transmission resources according to a VOIP transmission period. For example, if a transmission period of VOIP is 20 ms, the maximum number of repetitive transmission resources of a PUSCH including VOIP information may be 20 based on 15 kHz. The maximum number is 40 (=20×2) based on 30 kHz, and is 80 (=20×2) based on 60 KHz. Of course, 20 ms is merely an example, and other values can be applied. For example, a first repetitive transmission 3800 in FIG. 38 is a method of performing transmission using 16 transmission resources before a subsequent packet is generated in order to process a first packet, a second packet, and a third packet generated in each 20 ms transmission period. That is, a repetitive transmission resource (k) value is 16. For example, in FIG. 38, a second repetitive transmission 3802 is similar to the first repetitive transmission, but it is possible to configure the repetitive transmission resource (k) value to be 20 in consideration of the transmission period of 20 ms.
Method 7-2: a method of configuring a maximum number of repetitive transmission resources in consideration of a maximum delay of VoIP. For example, if a maximum transmission delay is 20 ms, a UE configures the number of transmission resources for a PUSCH to be 20 based on 15 kHz. For example, in FIG. 38, the second repetitive transmission 3802 is similar to the first repetitive transmission, but the repetitive transmission resource (k) value is 20, which is applicable when an allowable transmission processing delay of a VoIP-specific packet is 20 ms. As described above, 20 ms is merely an example, and other values are applicable. Methods 7-1 and 7-2 may be considered as the same method when a delay and an occurrence period of VOIP are the same.
Method 7-3: a method for configuring repetitive transmission resources of a certain interval in units of PUSCH bundles including M slot units. For example, in FIG. 38, if a VoIP packet generation period is 20 ms and a maximum allowable transmission delay of each VoIP packet is 52 ms, the UE may be able to transmit the first packet, the second packet, and the third packet as a third repetitive transmission 3804. A case of repetitive transmission in units of slots in an FDD situation has been assumed for the first repetitive transmission 3800 and the second repetitive transmission 3802 or the repetitive transmissions of methods 7-1 and 7-2, but method 7-3 or the third repetitive transmission 3804 has a main feature of performing repetitive transmission by configuring a unit of M slots. The advantage of method 7-3 is that although the number of repetitively transmitted resources is the same, the resources are far apart from each other in terms of time resources, so that diversity gain may be highly likely obtained in terms of time resources. Specifically, when a channel environment is flat, although repetitive transmission is performed, if a channel between the repetitively transmitted resources is the same, a probability of obtaining diversity gain at a receiver end may decrease. On the other hand, if a time difference between the repetitively transmitted resources is large, even if the channel environment is flat, a channel characteristic is highly likely to be changed, so that the probability of obtaining diversity gain at the receiver end increases. In order to support a unit of M slots, the UE needs to consider several parameters which may include, broadly speaking, k1, k2, and k_offset values. k1 denotes the number of bundled repetitively transmitted PUSCHs, and k1 may be 4 (k1=4) in the third repetitive transmission 3804 of FIG. 38. when the bundled PUSCHs are considered as one group, k2 denotes the number of repetitive transmissions of the group, and k2=5 in the third repetitive transmission 3804 of FIG. 38. Finally, k_offset denotes a slot offset between the bundled repetitively transmitted PUSCHs, and k_offset=12 (slots) in the third repetitive transmission 3804 of FIG. 38. The values of {k1, k2, k_offset} can be indicated by a higher signal (RRC or MAC CE) or an L1 signal (DCI). Alternatively, it may be possible that some information of the values of {k1, k2, k_offset} is indicated by a higher signal, and the remaining information is indicated by an L1 signal. The aforementioned delay and packet generation period are merely examples, and other values may be easily applicable. In addition, these values may be indicated by higher information, and accordingly, information of the values of {k1, k2, k_offset} may be implicitly or explicitly changeable. An example of an implicit change indicates that a first {k1, k2, k_offset} set is determined according to a first delay and packet generation period, and a second {k1, k2, k_offset} set is determined according to a second delay and packet generation period. Each mapping relationship is configured in advance. An example of an explicit change may indicate that {k1, k2, k_offset} is configured via separate high information according to a delay and a packet generation period.

### Eighth Embodiment

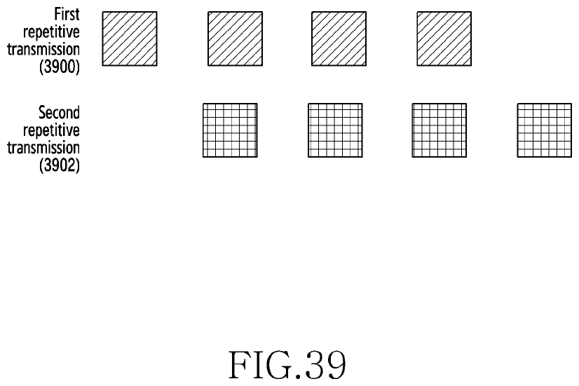

When repetitive transmission for transmitting different data or control information is scheduled, and scheduled resource areas overlap at least partially in terms of time resources, a UE operation needs to be defined when multiple pieces of data or control information cannot be transmitted simultaneously. FIG. 39 is a diagram illustrating a situation in which an overlap occurs between repetitive transmissions according to an embodiment of the disclosure. A first repetitive transmission 3900 includes a total of 4 repetitive transmissions, and the first repetitive transmission 3900 may correspond to at least one of a PUSCH, a PUCCH, or a SRS. A second repetitive transmission 3902 includes a total of 4 repetitive transmissions, and the second repetitive transmission 3902 may correspond to at least one of a PUSCH, a PUCCH, or a SRS. In FIG. 39, it has been assumed that both the first repetitive transmission 3900 and the second repetitive transmission 3902 perform 4 repetitive transmissions, but it is possible to have different values.

In FIG. 39, it is possible that the first repetitive transmission 3900 and the second repetitive transmission 3902 are transmitted in units of slots, repetitively, transmitted in units of sub-slots smaller than slots, or transmitted in a unit of M slots obtained by combining multiple slots, and different repetitive transmission forms may be possible. In FIG. 39, when second, third, and fourth repetitive transmissions in the first repetitive transmission 3900 and first, second, and third repetitive transmissions in the second repetitive transmission 3902 overlap in terms of time resources, it may be possible that a UE transmits a repetitive transmission having a higher priority, and that the UE drops a repetitive transmission having a lower priority. For example, the priority may be determined in the order of PUCCH>PUSCH>SRS. Alternatively, when URLLC information has a high priority (HP) and eMBB information has a low priority (LP), the priority may be determined in the order of HP PUCCH>HP PUSCH>HP SRS>LP PUCCH>LP PUSCH>LP SRS.

For example, if the first repetitive transmission corresponds to a PUCCH, and the second repetitive transmission corresponds to a PUSCH, the UE may drop, in the second repetitive transmission, the first, second, and third repetitive transmissions that overlap with the first repetitive transmission. In the case of NTN, since a link quality between a UE and a satellite is significantly degraded, a method of transmitting UCI of a PUCCH by multiplexing the same on a PUSCH may be possible even if an overlap occurs between PUCCH and PUSCH repetitive transmissions in the situation as shown in FIG. 39. That is, the UE may perform only the first PUCCH transmission in the first repetitive transmission, and UCI resources included in the remaining second, third, and fourth PUCCHs may be multiplexed on the first, second, and third PUSCHs of the second repetitive transmission so as to be transmitted, respectively. In this case, since the same UCI is transmitted via the PUCCH and PUSCH, complexity during combining and recovering of the UCI from a perspective of a receiver end may increase. Therefore, in consideration of at least one of the following methods, it may be possible to limit multiplexing of the PUCCH and the PUSCH when each of the PUCCH and PUSCH are repetitively transmitted.
Method 8-1: Multiplexing of the PUCCH and the PUSCH is applied only when the PUCCH and the PUSCH start from the same slot and have the same number of repetitive slots. For example, when both the PUCCH and the PUSCH start from slot n and are repetitively transmitted 4 times, and the respective repetitive transmissions overlap in terms of time resources, the UE may be able to transmit the UCI included in the PUCCH by including the UCI in each overlapping PUSCH.
Method 8-2: Multiplexing of the PUCCH and the PUSCH is applied only when the PUCCH and the PUSCH start from the same slot, but the PUCCH has more repetitive slots. For example, this is a case where both the PUCCH and the PUSCH start from slot n, but the PUCCH is repetitively transmitted 8 times, and the PUSCH is repetitively transmitted 4 times. In this case, the UE multiplexes the UCI of the PUCCH on the PUSCH with respect to PUCCH and PUSCH resources where each repetitive transmission overlaps. In addition, for the PUCCH that does not overlap with the PUSCH, the UCI is included in the PUCCH and repetitively transmitted. Therefore, in the example above, first 4 repetitive transmissions correspond to the PUSCH including UCI, and subsequent 4 repetitive transmissions correspond to the PUCCH.
Method 8-3: Multiplexing of the PUCCH and the PUSCH is applied only when the PUCCH and the PUSCH start from the same slot, but the PUCCH has fewer repetitive slots. For example, this is a case where both the PUCCH and the PUSCH start from slot n, but the PUCCH is repetitively transmitted 4 times, and the PUSCH is repetitively transmitted 8 times. In this case, the UE multiplexes the UCI of the PUCCH on the PUSCH with respect to PUCCH and PUSCH resources where each repetitive transmission overlaps. In addition, for the PUSCH that does not overlap with the PUCCH, only the PUSCH is included in repetitive transmission without UCI multiplexing. Therefore, in the example above, first 4 repetitive transmissions correspond to the PUSCH including UCI, and subsequent 4 repetitive transmissions correspond to the PUSCH including no UCI.
Method 8-4: Multiplexing of the PUCCH and the PUSCH is applied only when the PUCCH and the PUSCH start from different slots, but have the same number of repetitive slots. For example, this is a case where both the PUCCH and the PUSCH perform repetitive transmission 4 times, but the PUCCH starts repetitive transmission from slot n, and the PUSCH performs repetitive transmission from slot n+2. In this case, the UE multiplexes the UCI of the PUCCH on the PUSCH and transmits the same in slots n+2 and n+3 where the PUCCH and the PUSCH overlap. Only the PUCCH performs repetitive transmission in slots n and n+1. Only the PUSCH is transmitted without UCI multiplexing in slots n+4 and n+5.
Method 8-5: A combination of methods 8-1 to 8-4 is included. That is, both the PUCCH and the PUSCH may have the same start slot or different start slots, or may have the same number or different numbers repetitive transmissions. In this case, the UCI of the PUCCH is multiplexed and transmitted on the PUSCH only for a resource area where the PUCCH and the PUSCH overlap. In other resources where only the PUCCH exists, only the PUCCH is transmitted, and in resources where only the PUSCH exists, only the PUSCH is transmitted.

The UE may be able to operate at least one of the methods or a combination of some or all of the methods. When multiple methods are applicable, it may be possible to be indicated with a specific method by the base station via a higher signal or an L1 signal. In addition, a method by which the UE reports one of the methods via a UE capability report may be possible. When multiple methods are reported, the base station may be able to indicate a specific method to the UE via a higher signal or an L1 signal.

For convenience of description, the first to eighth embodiments of the disclosure have been described separately, but since the respective embodiments include operations associated with each other, it is also possible to combine and configure at least two embodiments. In addition, the methods of the respective embodiments are not mutually exclusive, and it is also possible to perform one or more methods in combination.

Transmission and reception methods of a base station, a satellite, and a UE, a transmitter end, or a receiver end for performing the embodiments of the disclosure are illustrated, and in order to perform the methods, receivers, processors, and transmitters of the base station, the satellite, and the UE need to operate according to the embodiments, respectively.

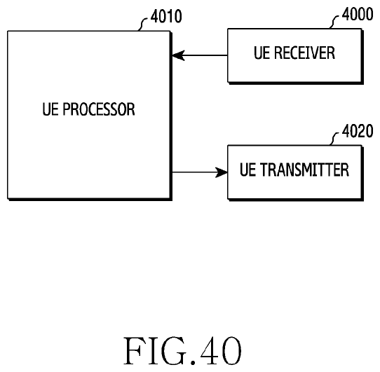

Specifically, FIG. 40 is a block diagram illustrating an internal structure of a UE according to an embodiment of the disclosure. As illustrated in FIG. 40, a UE of the disclosure may include a UE receiver 4000, a UE transmitter 4020, and a UE processor 4010. Of course, the disclosure is not limited to the example above, and the UE may include more or fewer elements. In addition, the UE receiver 4000, the UE transmitter 4020, and the UE processor 4010 may be configured as a single chip.

The UE receiver 4000 and the UE transmitter 4020 may be collectively referred to as a transceiver in an embodiment of the disclosure. The transceiver may transmit signals to and receive signals from a base station or a satellite. The signals transmitted and received by the UE may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. Of course, the elements of the transceiver are not limited to the RF transmitter and the RF receiver. In addition, the transceiver may receive a signal via a wireless channel and output the signal to the UE processor 4010, and may transmit, via a wireless channel, a signal output from the UE processor 4010.

The UE processor 4010 may control a series of procedures so that the UE may operate according to the aforementioned embodiment of the disclosure. For example, the UE receiver 4000 may receive a signal from a satellite or a ground base station and receive a signal from a GNSS, and the UE processor 4010 may transmit and receive a signal to and from a base station according to the method described in the disclosure. Then, the UE transmitter 4020 may transmit a signal by using a determined time point. In the disclosure, the UE processor 4010 may be defined as a circuit, an application-specific integrated circuit, or at least one processor. Of course, the UE processor is not limited to the example above.

According to an embodiment of the disclosure, the UE may include a memory (not illustrated). The memory may store a program and data necessary for operation of the UE. In addition, the memory may store control information or data included in a signal acquired by the UE. The memory may include a storage medium, such as a ROM, a RAM, a hard disk, a CD-ROM, and a DVD, or a combination of storage media.

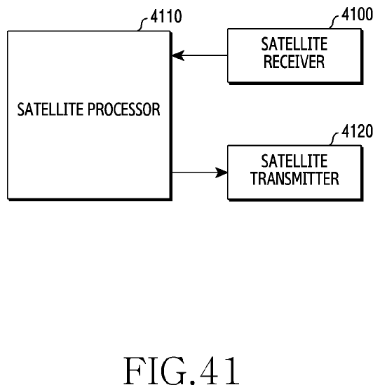

FIG. 41 is a block diagram illustrating an internal structure of a satellite according to an embodiment of the disclosure. As illustrated in FIG. 41, a satellite of the disclosure may include a satellite receiver 4100, a satellite transmitter 4120, and a satellite processor 4110. In the above, there may be multiple receivers, transmitters, and processors. That is, a receiver and a transmitter for transmitting and receiving a signal to and from a UE, and a receiver and a transmitter for transmitting and receiving a signal to and from a base station (and a receiver and a transmitter for transmitting and receiving a signal to and from another satellite) may be configured respectively. Of course, the disclosure is not limited to the example above, and the satellite may include more or fewer elements. In addition, the satellite receiver 4100, the satellite transmitter 4120, and the satellite processor 4110 may be configured as a single chip.

The satellite receiver 4100 and the satellite transmitter 4120 may be collectively referred to as a transceiver. The transceiver may transmit signals to and receive signals from a UE and a base station. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. Of course, the elements of the transceiver are not limited to the RF transmitter and the RF receiver. In addition, the transceiver may receive a signal via a wireless channel and output the signal to the satellite processor 4110, and may transmit, via a wireless channel, a signal output from the satellite processor 4110. The satellite processor 4110 may include a compensator or a pre-compensator for compensating for a frequency offset or a Doppler shift, and may include a device capable of tracking a position from a GPS, etc. In addition, the satellite processor 4110 may include a frequency shift function that enables shifting of a center frequency of a reception signal. The satellite processor 4110 may control a series of procedures so that the satellite, the base station, and the UE may operate according to the aforementioned embodiment of the disclosure. For example, the satellite receiver 4100 may receive a PRACH preamble from the UE, transmit a corresponding RAR back to the UE, and determine to transmit TA information to the base station. Then, the satellite transmitter 4120 may transmit corresponding signals at determined time points. In the disclosure, the specific processor 4110 may be defined as a circuit, an application-specific integrated circuit, or at least one processor. Of course, the satellite processor is not limited to the example above.

According to an embodiment of the disclosure, the satellite may include a memory (not illustrated). The memory may store a program and data necessary for operation of the satellite. In addition, the memory may store control information or data included in a signal acquired by the satellite. The memory may include a storage medium, such as a ROM, a RAM, a hard disk, a CD-ROM, and a DVD, or a combination of storage media.

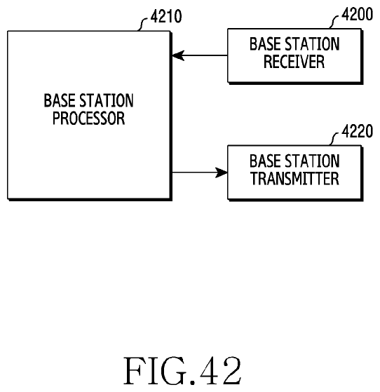

FIG. 42 is a block diagram illustrating an internal structure of a base station according to an embodiment of the disclosure. As illustrated in FIG. 42, a base station of the disclosure may include a base station receiver 4200, a base station transmitter 4220, and a base station processor 4210. The base station may be a ground base station or a part of a satellite. The base station receiver 4200 and the base station transmitter 4220 may be collectively referred to as a transceiver. The transceiver may transmit signals to or receive signals from a UE. Signals transmitted to or received from a UE, another base station, or a satellite may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. Of course, the elements of the transceiver are not limited to the RF transmitter and the RF receiver. In addition, the transceiver may receive a signal via a wireless channel and output the signal to the base station processor 4210, and may transmit, via a wireless channel, a signal output from the base station processor 4210. The base station processor 4210 may control a series of procedures so that the base station may operate according to the aforementioned embodiment of the disclosure. For example, the base station processor 4210 may transmit an RAR including TA information. In the disclosure, the base station processor 4210 may be defined as a circuit, an application-specific integrated circuit, or at least one processor. Of course, the base station processor is not limited to the example above.

According to an embodiment of the disclosure, the base station may include a memory (not illustrated). The memory may store a program and data necessary for operation of the base station. In addition, the memory may store control information or data included in a signal acquired by the base station. The memory may include a storage medium, such as a ROM, a RAM, a hard disk, a CD-ROM, and a DVD, or a combination of storage media.

The embodiments of the disclosure described and shown in the specification and the drawings are merely particular examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. In addition, other variants based on the technical idea of the embodiments of the disclosure may be implemented in LTE, 5G, and other systems.

1. A method performed by a terminal in a satellite communication system, the method comprising:
determining a timing advance (TA) value for transmission of an uplink signal;
determining whether an overlap occurs between a first slot before applying the TA value and a second slot after applying the TA value; and
based on a priority of an interval in which the overlap has occurred, transmitting the uplink signal to a base station according to the TA value.

2. The method of claim 1, wherein the TA value is different from a TA command received from the base station.

3. The method of claim 1, wherein the priority prioritizes one of a signal of the first slot and a signal of the second slot, or prioritizes one of an uplink data channel, an uplink control channel, and an uplink reference signal.

4. The method of claim 1, wherein the uplink signal is transmitted to the base station via a non-terrestrial network (NTN) satellite.

5. The method of claim 4, wherein the TA value is determined based on at least one of a position of the NTN satellite, movement of the NTN satellite, or a distance between the terminal and the NTN satellite.

6. The method of claim 1, wherein the priority is indicated by radio resource control (RRC) signaling, a medium access control (MAC) control element (CE), or downlink control information (DCI), which is received from the base station.

7. A terminal in a satellite communication system, the terminal comprising:
a transceiver; and
a controller connected to the transceiver,
wherein the controller is configured to:
determine a timing advance (TA) value for transmission of an uplink signal;
determine whether an overlap occurs between a first slot before applying the TA value and a second slot after applying the TA value; and
based on a priority of an interval in which the overlap has occurred, transmit the uplink signal to a base station according to the TA value.

8. The terminal of claim 7, wherein the TA value is different from a TA command received from the base station.

9. The terminal of claim 7, wherein the priority prioritizes one of a signal of the first slot and a signal of the second slot, or prioritizes one of an uplink data channel, an uplink control channel, and an uplink reference signal.

10. The terminal of claim 7, wherein the uplink signal is transmitted to the base station via a non-terrestrial network (NTN) satellite.

11. The terminal of claim 10, wherein the TA value is determined based on at least one of a position of the NTN satellite, movement of the NTN satellite, or a distance between the terminal and the NTN satellite.

12. The terminal of claim 7, wherein the priority is indicated by radio resource control (RRC) signaling, a medium access control (MAC) control element (CE), or downlink control information (DCI), which is received from the base station.

13. A method performed by a base station in a satellite communication system, the method comprising:
receiving an uplink signal from a terminal,
wherein the uplink signal is received based on a timing advance (TA) value, and
wherein the uplink signal is received based on a priority of an interval in which an overlap occurs between a first slot before applying the TA value and a second slot after applying the TA value.

14. A base station in a satellite communication system, the base station comprising:
a transceiver; and
a controller connected to the transceiver,
wherein the controller is configured to receive an uplink signal from a terminal,
wherein the uplink signal is received based on a timing advance (TA) value, and
wherein the uplink signal is received based on a priority of an interval in which an overlap occurs between a first slot before applying the TA value and a second slot after applying the TA value.

15. The base station of claim 14, wherein the TA value is different from a TA command transmitted to the terminal by the base station, and
wherein the uplink signal is received from the terminal via a non-terrestrial network (NTN) satellite.
